(19) United States
(12) Patent Application Publication
(10) Pub. No.: US 2025/0114753 A1
(43) Pub. Date: Apr. 10, 2025

(54) NANOCRYSTAL SUPERPARTICLES THROUGH A SOURCE-SINK EMULSION SYSTEM

(71) Applicants: THE TRUSTEES OF THE UNIVERSITY OF PENNSYLVANIA, Philadelphia, PA (US); WAGENINGEN UNIVERSITEIT, Wageningen (NL)

(72) Inventors: Emanuele MARINO, Palermo (IT); Sjoerd Willem VAN DONGEN, Diemen (NL); Thomas Edward KODGER, Wageningen (NL); Christopher B. MURRAY, Bala Cynwyd, PA (US); Cherie R. KAGAN, Bala Cynwyd, PA (US)

(21) Appl. No.: 18/832,203

(22) PCT Filed: Jan. 25, 2023
(86) PCT No.: PCT/US2023/061282

§ 371 Date: Jul. 23, 2024

Related U.S. Application Data
(60) Provisional application No. 63/302,716, filed on Jan. 25, 2022.

(51) Int. Cl. B01F 23/41; B01F 23/40; B01F 101/40; B82Y 20/00; B82Y 40/00

(52) U.S. Cl. CPC B01F 23/4105; B01F 23/4146; B01F 23/483; B82Y 20/00; B82Y 40/00; B01F 2101/40; B01F 2215/0431

(57) ABSTRACT

A method for forming superparticles, comprising: contacting a source dispersed phase, a sink dispersed phase, and a continuous phase, the source dispersed phase comprising a solvent and a plurality of particles dispersed within the solvent, the sink dispersed phase comprising a solvent, the solvent of the sink dispersed phase having a solubility in the continuous phase at a given temperature that is less than a solubility of the solvent of the source dispersed phase in the continuous phase at that given temperature, and the contacting being performed such that at least some solvent of the source dispersed phase migrates to the sink dispersed phase so as to give rise to a plurality of superparticles that comprise assembled particles of the source dispersed phase.

### CROSS-REFERENCE TO RELATED APPLICATIONS

The present application claims priority to and the benefit of U.S. patent application No. 63/302,716, “Nanocrystal Superparticles Through A Source-Sink Emulsion System” (filed Jan. 25, 2022). All foregoing applications are incorporated herein by reference in their entireties for any and all purposes.

### GOVERNMENT RIGHTS

This invention was made with government support under N00014-18-1-2497 awarded by the Navy. The government has certain rights in the invention.

### TECHNICAL FIELD

The present disclosure relates the field of superparticles and to the field of emulsions.

### BACKGROUND

Throughout history, the emergence of complex patterns from the organization of smaller components has captivated humankind. This interest stems from the search for the mechanism driving the assembly process: Through multiple forces,^{1, 2} self-assembly leads to the formation of hierarchical superstructures.³ Frequently, these superstructures perform a higher, collective function than their constituent building blocks.⁴ Gaining control over self-assembly, therefore, represents a successful strategy to build materials with new properties.

Over the last three decades, scientists have learned to control the crystallization of atoms into nanoscale structures known as nanocrystals (NCs).⁵ Depending on their morphology, dimension, and chemical composition, NCs can manipulate electromagnetic radiation over a broad spectral range. Upon assembly into 3D mesoscale superstructures,^{2, 6-9} the properties of NCs hybridize through excitonic,¹⁰⁻¹² electronic,¹³⁻¹⁶ magnetic,¹⁷⁻¹⁹ plasmonic,²⁰⁻²² phononic,^{23, 24} and photonic²⁵⁻²⁷ coupling mechanisms. While the coupling strength is generally controlled by the distance between NCs,²⁸ the morphology of the superstructure plays an important role in mediating the interaction with external stimuli.

In the case of optical stimuli, Maxwell's equations predict the confinement of intense electromagnetic fields within a dielectric structure of dimensions comparable to the wavelength,²⁹ increasing the probability of absorption and scattering of light.^{27, 30} Additionally, when the structure possesses rotational symmetry, light can become trapped at the surface through whispering gallery modes,^{26, 31, 32} resulting in a 3D resonator. Since these processes crucially depend on the morphology and refractive index of the structure,³³ there is a strong motivation to fabricate optical structures with well-defined size, shape, and composition.

Top-down microfabrication processes have succeeded in producing mesostructures with increasingly complex morphologies and high optical quality³⁴ to optimize and exploit the trapping of light for various applications. For instance, microfabricated ring resonators are regularly used as lasers²⁵ and second-harmonic generators,³⁵ as well as environmental^{36, 37} and mechanical³⁸ sensors. However, the fabrication of these optical structures relies on slow, complex, and expensive processes. Moreover, after fabrication these structures are usually bound to a substrate, limiting their deployment for in situ sensing. For these reasons, there are significant opportunities to develop more direct and cheaper experimental procedures to fabricate new classes of portable resonators by exploiting a recently developed, versatile,^{39, 40} scalable,⁴¹ and inexpensive technique known as emulsion-templated assembly.⁴²

The simple act of shaking a mixture of oil and water in the presence of a surfactant can generate a polydisperse emulsion. Drying emulsion droplets that contain a dispersion of NCs leads to the formation of dense NC superstructures.^{39, 40, 43-46} These superstructures, known in the literature as superparticles,⁴⁷ supraparticles,⁴⁸ or supercrystals,⁴³ generally assume a spherical shape imposed by surface tension, although specific processing conditions can yield more complex morphologies, like cubic^{49, 50} and toroidal⁴² shapes. These NC superparticles interact strongly with light through Mie²⁷ and whispering gallery modes,²⁶ and promise the introduction of more efficient, cheaper, and portable micro lasers,³³ upconversion media,⁵¹ and stimuli-responsive dielectric metasurfaces⁵² for structural color applications.⁵³⁻⁵⁵ However, since the optical properties of the superparticles strongly depend on their dimensions, all applicative efforts are currently encumbered by the need for a reliable and general method to produce monodisperse NC superparticles.

A monodisperse emulsion is a good starting point to fabricate monodisperse superparticles. Recently, droplet microfluidics has emerged as the technique of choice to generate emulsions with a polydispersity lower than 5%,⁵⁶⁻⁵⁸ Yet, the generated emulsions are sensitive to shear forces, and the mixing usually required to densify the droplets into superparticles results in significant size defocusing, as shown in FIG. 7, thus jeopardizing the benefits of the microfluidic approach. Polymerizing the surface of the droplets can improve their stability by minimizing mass transport across the liquid/liquid interface.^{57, 59, 60} However, this strategy inherently impedes densification and is therefore unsuitable to form dense NC superparticles. Fluorosurfactants have shown excellent results in stabilizing water⁶¹⁻⁶⁴ or oil⁴⁰ droplets in fluorinated oil; yet, the use of fluorochemicals is environmentally unsustainable due to their resilience against degradation.⁶⁵ Accordingly, there is a long-felt need in the field for improved methods of forming superparticles. There are also long-felt needs for improved superparticles as well as devices that include such superparticles.

### SUMMARY

In meeting the described long-felt needs, the present disclosure provides a method for forming superparticles, comprising: contacting a source dispersed phase, a sink dispersed phase, and a continuous phase, the source dispersed phase comprising a solvent and a plurality of particles dispersed within the solvent, the sink dispersed phase comprising a solvent, the solvent of the sink dispersed phase having a solubility in the continuous phase at a given temperature that is less than a solubility of the solvent of the source dispersed phase in the continuous phase at that given temperature, and the contacting being performed such that at least some solvent of the source dispersed phase migrates to the sink dispersed phase so as to give rise to a plurality of superparticles that comprise assembled particles of the source dispersed phase.

Also provided are a population of superparticles, the population of superparticles being formed according to the present disclosure, e.g., according to any one of Aspects 1-28.

Further disclosed is an optical resonator, the optical resonator comprising a substrate having one or more of superparticles disposed thereon, the one or more superparticles optionally being characterized as monodisperse.

Also provided is a sensor, sensor, comprising: at least one superparticle; and

at least one receiver configured to collect a signal related to contact between the at least one superparticle and an analyte.

Additionally provided is a system, comprising: a first inlet for introducing a source emulsion having a source dispersed phase that comprises a solvent; a second inlet for introducing a sink emulsion having a second dispersed phase that comprises a solvent; and a mixing area configured to contact the first emulsion and the second emulsion to give rise to a combined continuous phase, the solvent of the second dispersed phase having a solubility in the combined continuous phase at a given temperature that is less than a solubility of the solvent of the source dispersed phase in the continuous phase at that given temperature.

Further provided is a method, comprising: with a superparticle comprising a first ligand thereon, exchanging the first ligand for a second ligand smaller than the first ligand, the exchange effecting (a) a change in the cavity length, (b) a change in the refractive index of the superparticle, or both (a) and (b).

Also provided is a method, comprising: illuminating a superparticle with an illumination so as to reduce the refractive index of the superparticle and effect a persistent blue-shift in the superparticle's spectrum.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1: Schematic of the fabrication of monodisperse NC superparticles. Step 1: Generation of a monodisperse toluene-in-water “source” emulsion using droplet microfluidics. Each droplet contains a dispersion of NCs with initial volume fraction di. Step 2: Introduction of a secondary hexadecane-in-water “sink” emulsion. The hexadecane droplets are three orders of magnitude smaller than the toluene droplets. Step 3: The sink emulsion swells with toluene from the source emulsion, shrinking the source droplets and ultimately forming NC superparticles. Step 4: After washing away the swollen sink emulsion, the NC superparticles appear highly monodisperse and spherical.

FIG. 2: Exposure to a sink emulsion drives the formation of monodisperse NC superparticles. (a) Evolution of the “sink” hexadecane emulsion at room temperature when not exposed to toluene. The droplet volume is calculated from the average hydrodynamic radius extracted through dynamic light scattering. The photographs in the inset highlight the increase in turbidity of the hexadecane emulsion with time. (b) Evolution of the “sink” hexadecane emulsion as a function of temperature immediately prior to (open symbols) and after (closed symbols) exposure to the “source” toluene emulsion. The exposure time is 4 minutes. (c) (Top) Photographs of the collection vials showing the hexadecane emulsion after exposure to the toluene emulsion at different temperatures. The increase in turbidity with temperature correlates with the results of panel (b). (Bottom-left) Photograph of the 70° C. vial during sample collection. The difference in turbidity between the bottom and the top of the vial is due to the increased buoyancy of the hexadecane emulsion after exposure to toluene. (Bottom-right) The NC superparticles sediment within a few minutes after sample collection. (d) SEM micrograph of the NC superparticles deposited on a silicon substrate. (e) Cross-sectional SEM micrograph of a single NC superparticle prepared by FIB milling.

FIG. 3: Fabrication of NC superparticles of different sizes and morphologies. (Bottom to top) Increasing the initial NC volume fraction, ϕᵢ, results in overall larger superparticles. (Left to right) Increasing the temperature of the aqueous phase results in overall more monodisperse and spherical superparticles. These changes have been quantified in the graph, indicating the average superparticle size (symbol) and standard deviation (error bars).

FIG. 4: Lasing from NC superparticles produced through the source-sink emulsion approach. (a) SEM micrograph of a spherical superparticle of anisotropic CdSe/CdS NCs with unity PL quantum yield. (b) Dark-field optical micrograph of the monodisperse superparticles. (c) PL spectrum of a superparticle excited at 500 nm as a function of the excitation fluence. The inset shows the integrated intensity of the lasing peaks as a function of excitation fluence. (d) Dark-field optical micrographs of various clusters of NC superparticles and (e) their PL spectra when exciting above lasing threshold.

FIG. 5: Core/shell NC superparticles. SEM micrographs of (a,b) monodisperse core/shell NC superparticles from spherical PbS/CdS and discoidal NaGdF₄ NC, and (c) their cross-sections prepared by FIB milling, revealing that the spherical NCs mostly reside in the core of the superparticles while the disks are in the shell. (d-f) SEM micrographs of the surface of the superparticles reveal that the disks tend to stack rather than to tile at the surface of the superparticles. Streaking features are due to charging.

FIG. 6: In-line production of NC superparticles without the use of droplet microfluidics. (a) A herringbone mixer can be used to facilitate mass transport between the toluene and hexadecane emulsions. (b-c) By starting with a toluene shake-emulsion, large amounts of polydisperse NC superparticles can be readily produced.

FIG. 7: Shear processing of toluene droplets leads to polydisperse superparticles. (Top) TEM micrographs of polydisperse CdSe NC superparticles resulting from stirring a monodisperse emulsion generated through microfluidics. When not using the source-sink emulsion approach, stirring is necessary to drive the toluene drying process, and results in size-defocusing. (Bottom) TEM micrographs of polydisperse CdSe NC superparticles resulting from stirring a polydisperse emulsion generated through vortex mixing. The superparticles are polydisperse as they result from drying a polydisperse emulsion.

FIG. 8: Microfluidic setup used to fabricate monodisperse NC superparticles. (a) Schematic of the microfluidic droplet generator with three inlets (circles, 1-3), one outlet (circle, 4), and two cross junctions (rectangles). The colors of the channels indicate the three different phases used: Phase 1, the NC phase (brown); phase 2, the aqueous solution of SDS (light blue); phase 3, the sink emulsion (grey). A micrograph of the first junction is shown in (b), illustrating the generation of toluene droplets in water, forming the source emulsion. A micrograph of the second junction is shown in (c), illustrating the introduction of the sink emulsion phase. This phase can be distinguished by the darker contrast due to scattering. The outlet is connected to a PFA tubing which is wrapped around a temperature-controlled copper rod. A picture of the rod is shown in (d), illustrating the milled-in spiral described in the main text. The sample is eventually collected in a scintillation vial. (e) Shows the arrangement of a 1.85 mL vial containing the NC phase inserted inside a 22 mL vial described in the supplementary text. We found this arrangement useful when working with small volumes of about 0.5-1.0 mL. (f) Shows the overall setup: The reservoirs are located on the left, the microfluidic droplet generator is visible on the right mounted on the stage of an optical microscope, and the temperature-controlled copper rod is also visible on the top right of the image. The whole setup is mounted on an optical table.

FIG. 9: Characterization of the CdSe NCs used in this work. (a) TEM micrograph, (b) SAXS pattern and fitting to a spherical form factor, (c) absorption spectrum.

FIG. 10: Characterization of the CdSe/CdS NCs used in this work. (a) TEM micrograph, (b) SAXS pattern fit to a spherical form factor, (c) absorption and photoluminescence spectra of CdSe/CdS NCs synthesized according to Hanifi et al. The ratio between the number of emitted photons and the number of absorbed photons corresponds to a photoluminescence quantum yield.

FIG. 11: Characterization of the PbS and PbS/CdS NCs used in this work. (a) TEM micrograph of PbS NCs, absorption and photoluminescence spectra of PbS (b) and PbS/CdS (c) NCs synthesized according to Voznyy et al. and Kovalenko et al., respectively. The ratio between the number of emitted photons and the number of absorbed photons corresponds to a photoluminescence quantum yield.

FIG. 12: Characterization of the NaGdF₄ NCs used in this work. (a) TEM and (b-c) SEM micrographs of NaGdF₄ NCs with hexagonal plate morphology.

FIG. 13 illustrates generation of porous, monodisperse magneto-fluorescent superparticles from nanocrystal building blocks. TEM micrographs of (left) superparamagnetic Fe₃O₄ and (center) semiconductor CdSe/CdS nanocrystals. Insite show high-resolution micrographs of a single nanocrystal. (Right) Scanning electron micrograph of magneto-fluorescent superparticles generated using the source-sink emulsion approach.

FIG. 14 illustrates composition-dependent morphology of the composite superparticles. Scanning electron micrographs of composite NC superparticles with different compositions ranging from Fe₃O₄ to CdSe/CdS. At intermediate compositions, the surface of the superparticles begins to deviate from smooth to reveal circular depressions.

FIGS. 15a1-d provide an investigation of the inner volume of the superparticles at the intermediate composition of ϕ_{CdSe/CdS}=0.5. (a1-a4) Focused ion beam milling series of a single NC superparticle, and relative schematic (b1-b4). Statistical analysis of the area of the voids (c) and total void area fraction (d) as a function of distance from the surface of the superparticle. Markers indicate the mean value, while error bars indicate the standard deviation.

FIGS. 16a-16f provide illustrative data.

FIG. 17a-17e provide optical properties of magneto-fluorescent, composite nanocrystal superparticles. (a) Photoluminescence spectra of individual superparticles prepared with different compositions of NCs. Fe₃O₄ superparticles are non-emissive, therefore their spectra is not shown. The inset shows photoluminescence micrographs of two superparticles with ϕ_{CdSe/CdS}=0.5. (b) Integrated photoluminescence and (c) position of the photoluminescence peak of individual superparticles as a function of superparticle composition. Photoluminescence spectra with increasing excitation fluence for ϕ_{CdSe/CdS}=1 (d) and ϕ_{CdSe/CdS}=0.5. The inset shows photoluminescence micrographs of the superparticles. Excitation wavelengths: 420 nm (a-c), 488 nm (d-e).

FIG. 18 provides a schematic of the production of monodisperse CdSe NC superparticles through a source-sink emulsion approach. A monodisperse toluene-in-water emulsion, or source emulsion, is prepared by using a microfluidic cross-junction between a dispersed and a continuous phase. The dispersed phase consists of a dispersion of CdSe NCs in toluene, while the continuous phase is an aqueous solution of sodium dodecyl sulfate. Using a second microfluidic cross-junction, the source emulsion is mixed with a hexadecane-in-water emulsion, or sink emulsion. During their coresidence time, this results in the swelling of the sink emulsion with toluene and the shrinking of the source emulsion with a rate controlled by the temperature of the mixture. The final product consists in monodisperse, spherical CdSe NC superparticles.

FIG. 19a-19e provide optical properties of a single superparticle of CdSe NCs before and after ligand-exchange with 1-butanethiol. (a) PL (full line), scattering (dashed line) spectra, and (b) dark-field optical micrograph of a superparticle of CdSe NCs capped with oleate ligands. (c) FDTD simulation of the superparticle. The thin ring near the surface of the superparticle is due to the whispering-gallery modes, while the intensity nodes result from the coupling of whispering gallery-nodes with bulk modes of the sphere. (d) PL (full lines), scattering (dashed lines) spectra, and (e) dark-field optical micrograph of the same superparticle after ligand-exchange with 1-butanethiol.

FIG. 20 provides SEM micrographs of CdSe NC superparticles before and after ligand-exchange with alkanethiols.

FIGS. 21a-21f illustrate the effect of ligand-exchange with alkane thiols of different chain lengths on the morphology and optical properties of CdSe NC superparticles. (a) Diameters of CdSe NC superparticles before and after ligand-exchange. The position of the marker indicates the mean, and the error bars indicate the standard deviation. (b) Fraction of cracked CdSe NC superparticles before and after ligand-exchange. Average sample size: 34 superparticles. (c) PL spectra of individual CdSe NC superparticles after exchange with ligands with different chain lengths. The superparticles ligand-exchanged with the shortest ligand are non-emissive, therefore their spectra are not shown. (d) Integrated intensity values of WGM resonances before and after ligand-exchange. (e) Value of the effective refractive index, neff, of individual CdSe NC superparticles before and after ligand-exchange. (f) Blue-shift of the WGM resonance λ1,45 in units of the free spectral range of the superparticle after ligand-exchange.

FIGS. 22a-22c provide Optical properties of a single CdSe NC superparticle during continuous-wave illumination with ultraviolet light. (a) PL spectrum of a single CdSe NC superparticle ligand-exchanged with 1-butanethiol as a function of illumination time (red to black). The inset shows the change in effective refractive index, n_{eff}, as a function of illumination time. The error bars correspond to the size of the markers. (b) Integrated intensity of band-edge (circles) and surface (squares) PL as a function of illumination time. (c) Schematic of the proposed mechanism behind the change in PL spectrum with illumination time.

FIG. 23: Comparison of WGM peak positions expected from theoretical predictions using Equation 2 and experimental observations for the samples described in the main text. The best fit values for neff, and the values of the radii of the superparticles extracted via SEM imaging, are shown in the legend.

FIG. 24. FDTD simulations of the samples described in the main text by using the best fit values for neff and the values of the radii of the superparticles extracted via SEM imaging. The map of the electric field intensity shown in the insets was calculated for the wavelength corresponding to the maximum value of electric field intensity. The colorbar is common to all the maps of electric field intensity.

FIG. 25. (Left) PL spectra of the same superparticle studied in FIG. 5 of the main text, measured after not being exposed to UV light for the specified amount of time. (Right) Corresponding PL optical micrographs.

Additional information can be found in Marino et al., Chem. Mater. 2022, 34, 6, 2779-2789; and Marino et al., Nano Lett. 2022, 22, 12, 4765-4773, both of which publications are incorporated herein in their entireties for any and all purposes.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Superparticles made from colloidal nanocrystals have shown great promise in bridging the nanoscale and mesoscale, building materials with properties designed from the bottom-up. As these properties depend on the dimension of the superparticle, there is a need for a general method to produce monodisperse nanocrystal superparticles. We demonstrate an approach that, in an example application, yields spherical nanocrystal superparticles with a polydispersity as low as 2%. This method uses controlled densification of a nanocrystal-containing “source” emulsion by the swelling of a secondary “sink” emulsion. This strategy is general and rapid, yielding monodisperse superparticles with controllable sizes and morphologies, including core/shell structures, within a few minutes. The superparticles can exhibit a high optical quality that results in lasing through the whispering gallery modes of the spherical structure, with an average quality factor of 1600. Assembling superparticles into small clusters selects the wavelength of the lasing modes, demonstrating collective photonic behavior using these artificial solids.

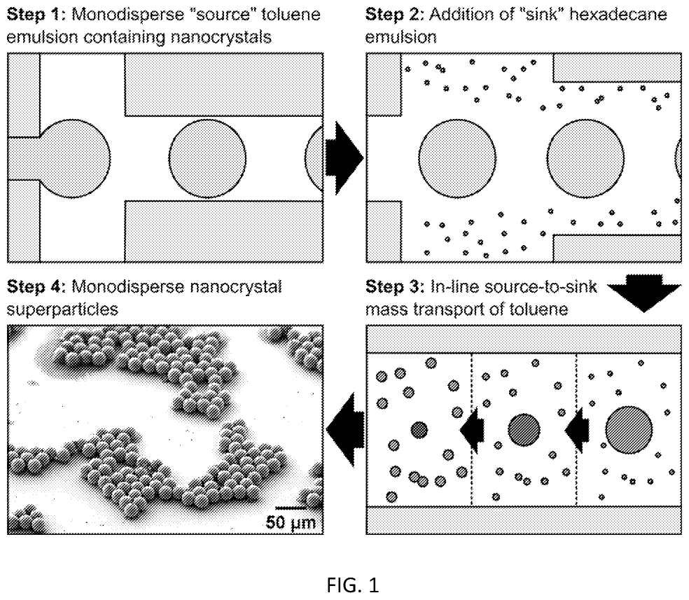

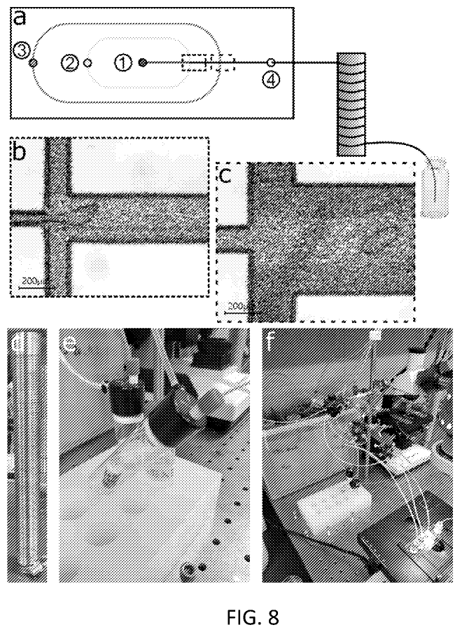

Here, we propose a general method to fabricate monodisperse, dense NC superparticles using a source-sink emulsion system. A schematic of this process is shown in FIG. 1, and photos of the experimental setup are shown in FIG. 8. We use droplet microfluidics to generate a monodisperse toluene-in-water “source” emulsion containing a dispersion of NCs, step 1. Then, we introduce a secondary “sink” emulsion consisting of much smaller droplets of an oil insoluble in water, such as hexadecane, step 2. The high internal pressure associated with the smaller emulsion drives the unidirectional mass transport of toluene from the source to the sink emulsion, progressively shrinking the toluene droplets and swelling the hexadecane droplets, step 3. Within minutes, this process yields NC superparticles with a polydispersity as low as 2%, step 4. This approach can be immediately extended to a wide range of hydrophobic NCs to produce monodisperse, dense NC superparticles with core-only or core/shell morphologies and with sizes tunable by varying the initial NC volume fraction within the source droplets. The NC superparticles function as optical resonators, featuring lasing modes modulated by their spontaneous assembly into colloidal clusters.⁶⁶ The proposed method represents a timely convergence of self-assembly over several length scales, paving the way to a more widespread use of NC superparticles as functional building blocks.

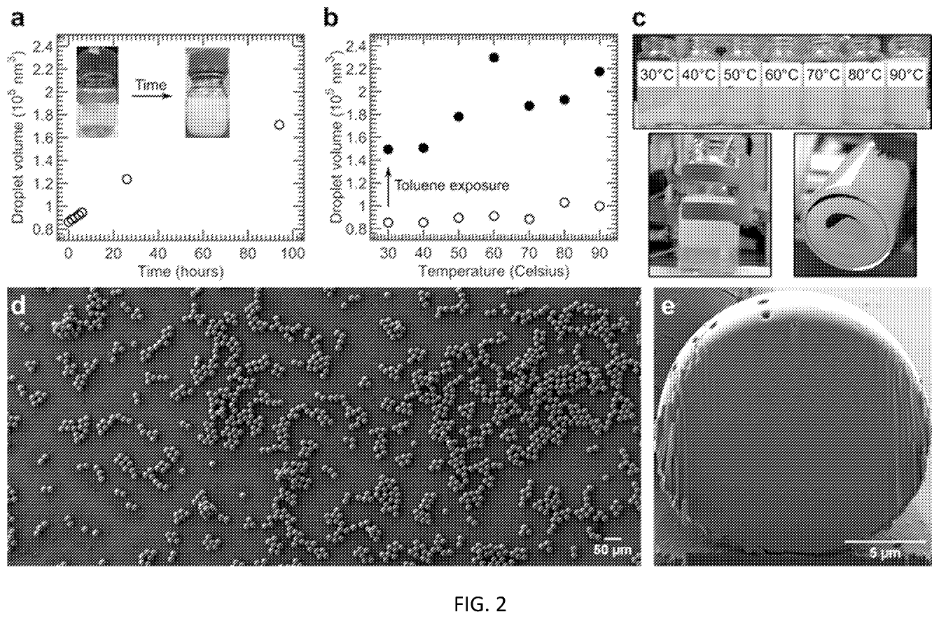

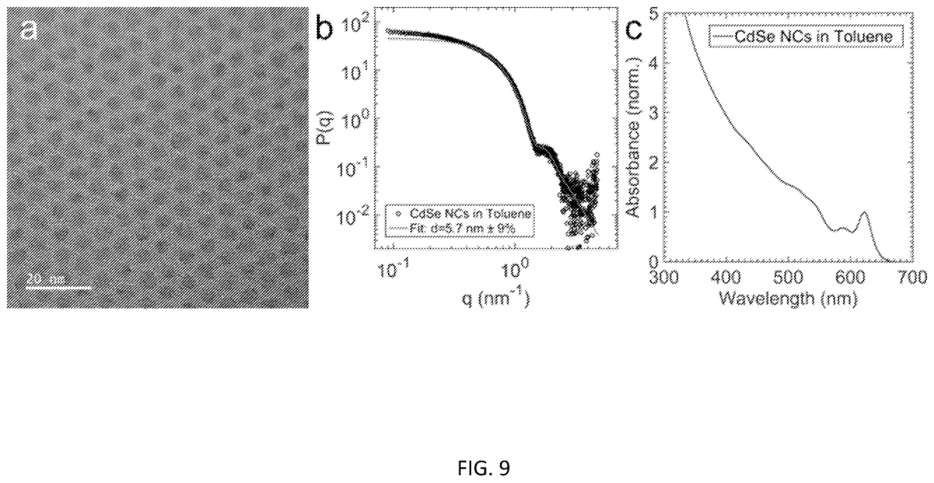

We use a microfluidic cross junction as a generator for 140 μm monodisperse toluene droplets loaded with 5.7 nm spherical CdSe NCs at an initial volume fraction ϕ₁; see FIG. 9 for NC characterization, and the Materials and Methods section for details on droplet generation. These droplets represent the source emulsion and are stabilized by sodium dodecyl sulfate (SDS), a common surfactant for oil-in-water emulsions. Downstream from the droplet generator, we use another cross junction to introduce an emulsion of hexadecane in water, 1% hexadecane by weight, representing the sink emulsion. The sink emulsion, 55 nm±38% in hydrodynamic diameter as measured by dynamic light scattering, is generated separately by extended ultra-sonication to reach an overall transparent appearance accompanied by a faint blue hue. A photograph of the sink emulsion is shown in the inset in FIG. 2a. When left undisturbed at room temperature, the sink emulsion is remarkably stable with each droplet eventually doubling in volume, from 0.86 to 1.71×10⁵ nm³, in 4 days due to Ostwald ripening;⁶⁷ see FIG. 2a. This microscopic change is accompanied by a macroscopic increase in turbidity, as demonstrated by the photograph in the inset. In contrast, exposing the sink emulsion to the NC-loaded source emulsion for only 4 minutes results in a comparable increase in the volume of the sink emulsion from 0.85 to 1.49 ×10⁵ nm³, as shown in FIG. 2b. This increase in volume of the sink emulsion is temperature-sensitive, with higher temperatures yielding a larger increase up to 2.14×10⁵ nm³ at 90° C. After exposure to the source emulsion, the sink emulsion shows a significant increase in turbidity, shown in FIG. 2c. Visually inspecting the bottom of the collection vial reveals a dark sediment. Imaging the sediment with a scanning electron microscope (SEM) reveals an ensemble of monodisperse, spherical NC superparticles that have formed in 4 minutes; see FIG. 2d. Milling a single superparticle using a focused ion beam (FIB) shows that the superparticles are densely packed with CdSe NCs, with no discernible voids, as shown in FIG. 2e.

This proceeds by the sink emulsion swelling progressively by depleting toluene from the source emulsion. The relatively high aqueous solubility of toluene, 5.8×10⁻³ M,⁶⁸ enables this mass transfer, while the much lower solubility of hexadecane, 2.6×10⁻¹¹ M,⁶⁹ prohibits the reverse process. We confirm the generality of the source-sink emulsion approach by replacing hexadecane for another solvent also characterized by a lower aqueous solubility than toluene, such as dodecane, resulting in the formation of NC superparticles. Instead, replacing toluene for a solvent with a lower aqueous solubility, such as hexane, 1.6×10⁻⁴ M,⁷⁰ inhibits mass transport and does not lead to monodisperse NC superparticles within the investigated residence times. Increasing either the residence time, the concentration of the sink emulsion, or the initial NC volume fraction can expand the use of source-sink emulsion approach to solvents with a lower aqueous solubility than toluene.

The initial NC volume fraction within the toluene droplets, ϕᵢ, determines the average size of the resulting superparticles, as shown in FIG. 3. Varying ϕᵢ from 0.01% to 0.09% increases the average diameter of the spherical superparticles, indicated by the symbols, from 7 to 23 μm. Using even higher ϕᵢ leads to larger superparticles which sediment in the residency channel before reaching the collection vial. Instead, using lower ϕᵢ leads to smaller superparticles that are still buoyant upon reaching the collection vial, creaming to the air/liquid interface. An example of this is shown in the bottom-left panel of FIG. 3, where the toluene droplets have reached the air/liquid interface while still buoyant, assembling to form a monolayer. The droplets have then deformed to maximize surface coverage of the interface,⁴⁰ creating a tiling pattern of anisotropic superparticles.

Adjusting the temperature of the aqueous phase during the co-residency time of source and sink emulsions affects the formation of the superparticles, as shown in FIG. 3. Specifically, increasing the temperature results in an increase in the average diameter of the superparticles while concurrently decreasing their polydispersity, indicated by the error bars. This is most likely due to the temperature-driven increase in solubility and diffusion rate of toluene in the aqueous phase,⁶⁸ which decreases the residency time required to form the NC superparticles and therefore decreases the probability of size defocusing.⁶⁷ When using a sufficiently high temperature for a given value of ϕᵢ, for instance, 50° C. for ϕᵢ=0.09%, this method yields NC superparticles with a polydispersity as low as 2%.

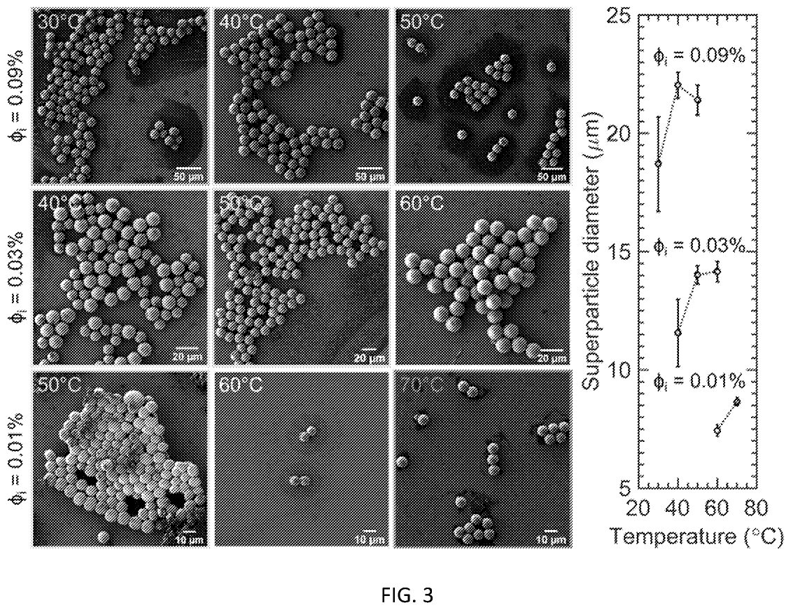

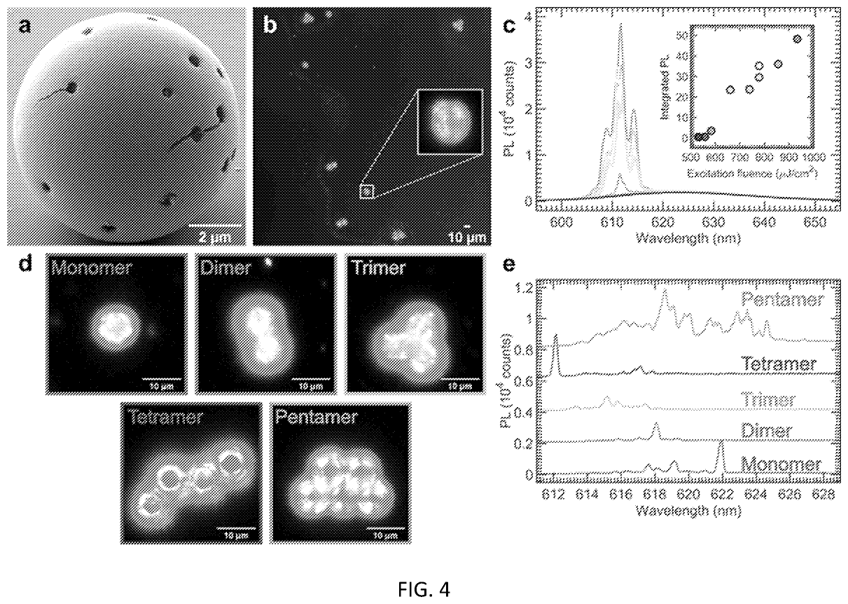

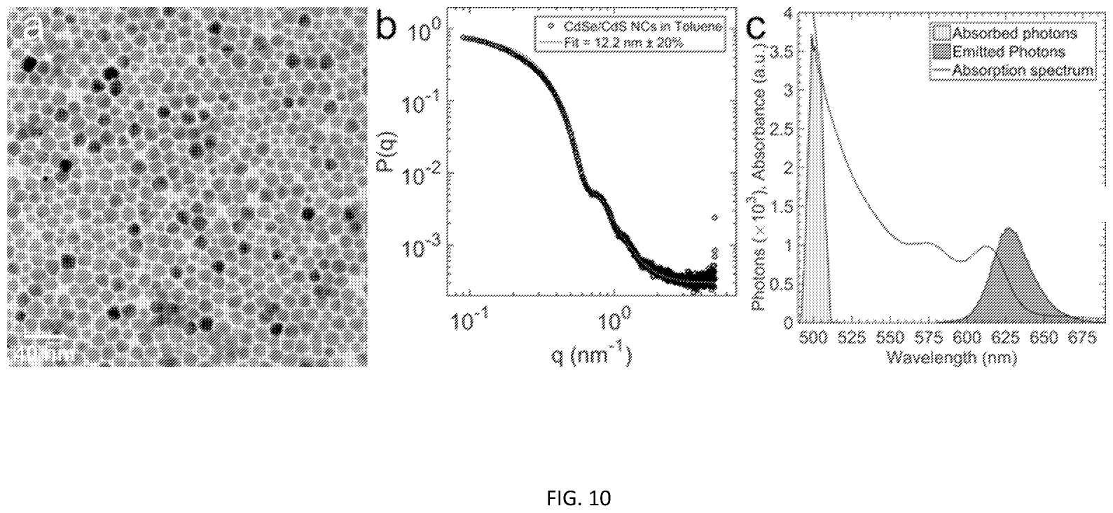

The source-sink emulsion method can be readily generalized to other NC systems. We synthesize 12.2 nm anisotropic core/shell CdSe/CdS NCs with unity photoluminescence (PL) quantum yield by following a recent report;⁷¹ see FIG. 10 for NC characterization. Also in this case, the source-sink emulsion method yields spherical superparticles, as shown in FIG. 4a. The 9.0 μm superparticles appear monodisperse, as illustrated by the dark-field micrograph in FIG. 4b. Upon excitation with 500 nm light, the superparticles show a photoluminescence (PL) spectrum centered around 625 nm; see FIG. 4c. When increasing the excitation fluence above a threshold of 550 μJ/cm², we observe the emergence of sharp peaks in PL that we attribute to lasing, as demonstrated by the super-linear increase in the integrated PL intensity with fluence shown in inset. We do not observe lasing when exciting with wavelengths below 490 nm, likely because of heating losses due to absorption of light by the thick CdS shell.²⁶

A closer inspection of the micrograph in FIG. 4b reveals that the superparticles spontaneously assemble into small clusters upon drop-casting. FIG. 4d shows dark-field images of a monomer, a dimer, a trimer, a tetramer, and a pentamer that we are able to locate on the silicon substrate.

When exciting above lasing threshold, each of these clusters lases at different wavelengths, as shown in FIG. 4e. Lasing of an isolated superparticle occurs via the confinement of light emitted by NCs to the surface of the superparticle through whispering gallery modes.²⁶ We argue that the assembly of superparticles into clusters likely leads to the hybridization of the whispering gallery modes of a single superparticle, determining the wavelength of the lasing modes of a superparticle cluster. We find that the quality factor of the superparticles, measured as Q=λ/Δλ=1600±18%, does not depend on the morphology of the cluster and corresponds to an average lifetime of the energy stored in the resonator of τ=Qλ/c=3.3 ps, where λ is the resonant wavelength, Δλ the full-width at half-maximum of the resonance, and c the speed of light. b

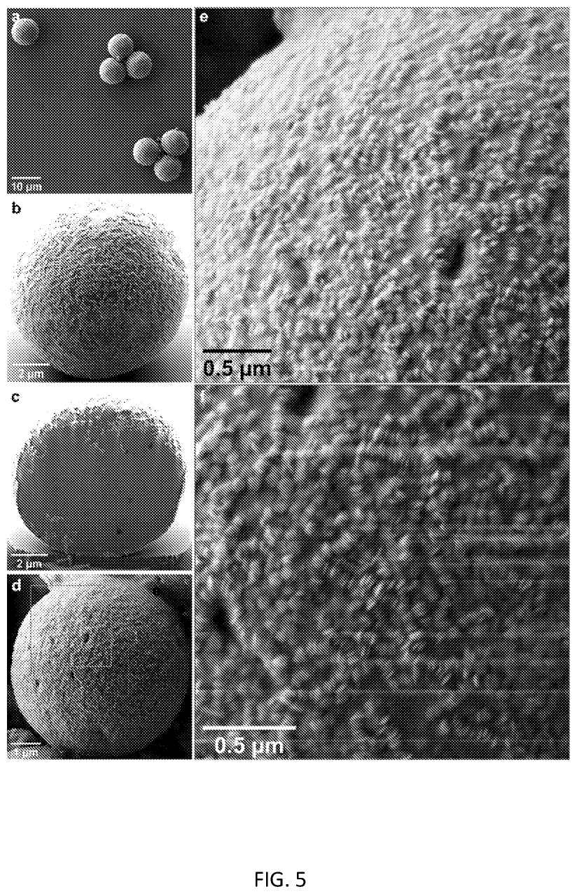

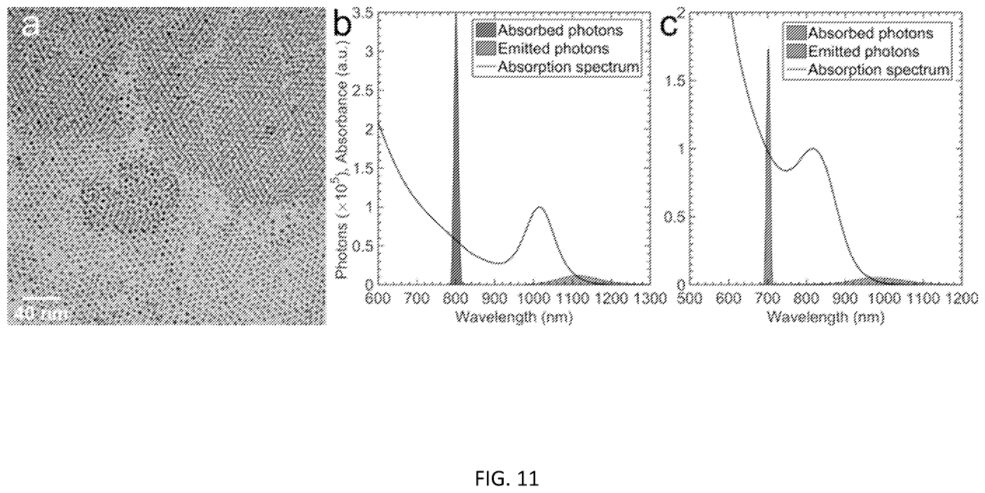

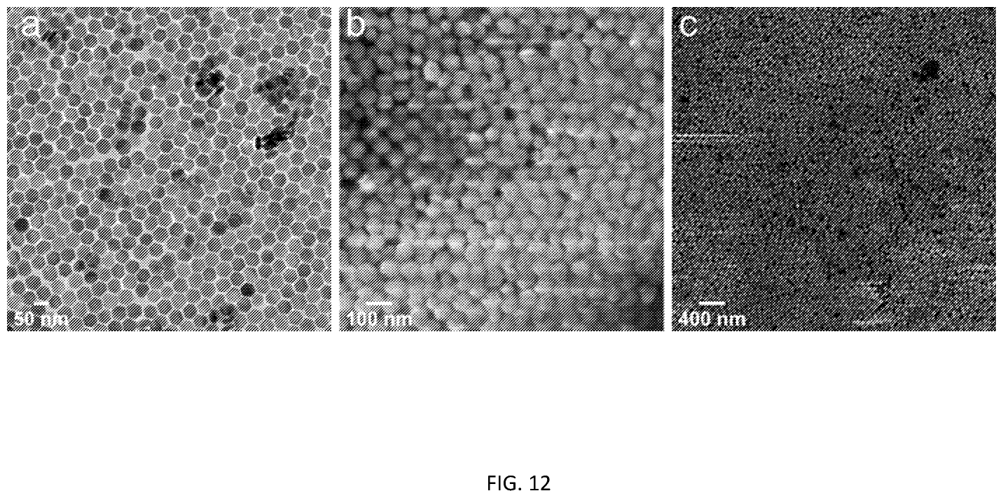

The source-sink emulsion approach can also be used to fabricate more complex superparticle architectures, as shown in FIG. 5. Loading the microfluidic toluene droplets with a mixture of NCs with different shapes readily results in monodisperse core/shell NC superparticles; see FIG. 5a. To achieve this morphology, we purposefully targeted a combination of NC shapes, disks and spheres,^{72, 73} that hinder the formation of binary phases, therefore triggering the spontaneous phase separation of NCs during the assembly process, see FIGS. 11 and 12 for NC characterization. Using a sphere-to-disk volume ratio of 4:1 results in superparticles with a dense core occupied by the 4.3 nm PbS/CdS NCs and a thin shell formed by the 57 nm NaGdF₄ disks, as shown in FIGS. 5b-5c. While the PbS/CdS NCs are too small to be distinguished in SEM, the NaGdF₄ disks are well within the resolution of the microscope and show a tendency to stack rather than to tile the surface of the superparticles, confirming a disk-to-disk affinity stronger than disk-to-sphere;^{72, 73} see FIGS. 5d-5f. FIB milling a single superparticle highlights the shape-driven phase separation of NCs, although a few disks are still present below the surface of the superparticle. Due to their higher volume fraction, the smaller spherical NCs likely reach the nucleation threshold first,^{39, 74, 75} achieving phase separation by segregating the disks to the outer volume of the droplet at the later stages of assembly. Therefore, the observation of a core/shell morphology represents indirect evidence for the homogeneous nucleation of NCs under spherical confinement.

### Discussion

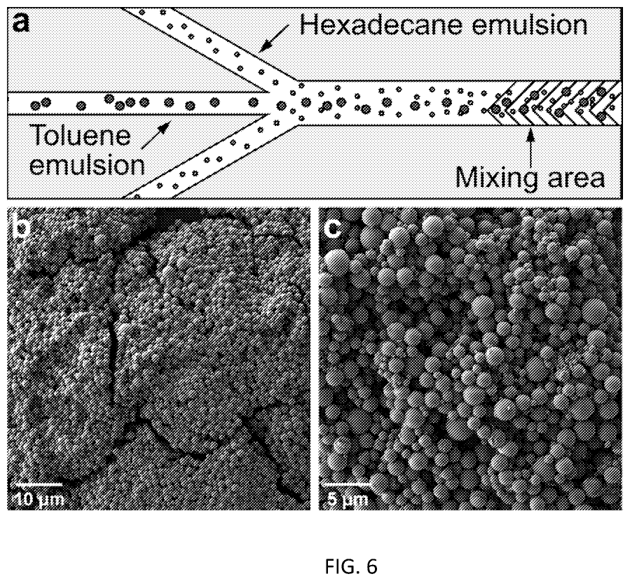

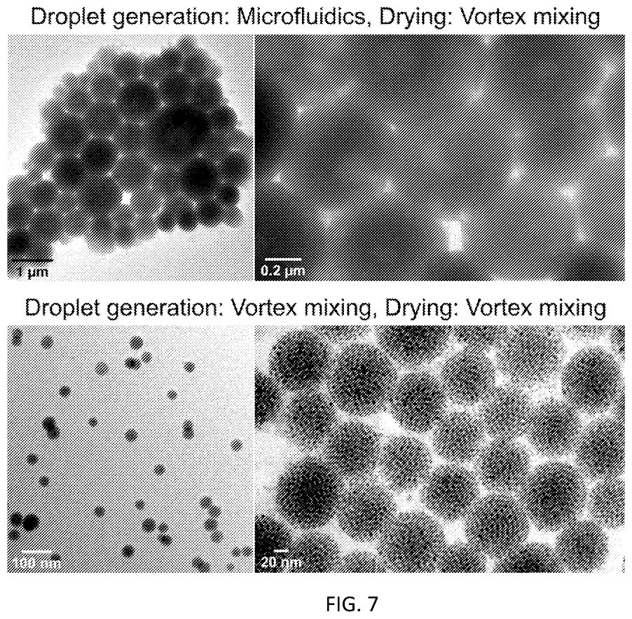

We demonstrate a general, rapid approach to consistently drive the formation of monodisperse NC superparticles. This approach relies on the interplay of two oil-in-water emulsions: a “source” emulsion of toluene loaded with NCs and a “sink” emulsion of an oil insoluble in water, like hexadecane. Mixing the two emulsions results in the temperature-controlled mass transport of toluene from the source to the sink emulsion, leading to the formation of spherical NC superparticles within minutes. Using monodisperse toluene droplets generated through droplet microfluidics results in monodisperse NC superparticles, independent of NC size, shape, composition, or polydispersity. However, the use of droplet microfluidics is not necessary for the source-sink emulsion approach to work. Exposing the sink emulsion to a polydisperse source emulsion prepared by vortex-mixing results in the generation of polydisperse NC superparticles, as shown in FIG. 6. Importantly, the source-sink emulsion approach provides the crucial benefit of accelerating the removal of the toluene from the source emulsion, achieving in minutes what would otherwise require several hours via evaporation.^{39, 43, 75}

We demonstrate the versatility of the source-sink emulsion approach by leveraging recent advances in NC synthesis. Using NCs with unity PL quantum yield leads to clusters of monodisperse superparticles that feature morphology-dependent lasing modes with an average quality factor of 1600. Instead, mixing two incompatible NC shapes yields monodisperse superparticles with a complex morphology characterized by the shape-driven phase separation of NCs in the core and the shell of the superparticle. The source-sink emulsion approach leads to the formation of functional NC superparticles of various sizes, shapes, and morphologies in just a few minutes, paving the way to a more extended use of these complex artificial solids towards applications in photonics,^{27, 51} magnetotherapy,¹⁹ energy storage,⁷⁶ and catalysis.⁷⁷

### Materials and Methods

### NC Synthesis

Detailed synthetic procedures are provided in the supporting information. CdSe,^{43, 78} CdSe/Cds,⁷¹ PbS,⁷⁹ PbS/Cds⁸⁰ are synthesized according to literature reports and dispersed in toluene after purification. NaGdF₄ NCs are synthesized by following a procedure described in the supporting information. The NC concentration for CdSe⁸¹ and PbS⁸² NCs is determined from spectrophotometry by following reported sizing curves. The concentration for the other NCs is determined by drying and weighing the pellet.

### Preparation of the Sink Emulsion

90 g of 200 mM SDS in Milli-Q water are added to a 100 mL media bottle (Fisher). 10 g of an oil insoluble in water, such as hexadecane or dodecane, are subsequently added. The media bottle is capped, and the contents are mixed by continuous inversion for a few seconds. The bottle is then sonicated for 90 minutes by using a bath sonicator (Branson 1510). The bottle is then removed from the sonicator, and the contents are mixed by continuous inversion for a few seconds. At this point, the emulsion appears milky, corresponding to an average hydrodynamic diameter for the droplets of 137 nm±35%, as determined by dynamic light scattering (Malvern Zetasizer). The bottle is then uncapped and placed in an ice bath. After placing the tip of the ultrasonicator (Misonix Sonicator 3000) in the emulsion, the contents of the media bottle are sonicated for 120 minutes (peak power 84 W, 50% duty cycle). Afterwards, the emulsion has a mostly clear appearance with a faint blue hue, corresponding to an average hydrodynamic diameter of 55 nm±37% as measured by DLS. The emulsion is then immediately diluted ten-fold with Milli-Q water to reach an oil concentration of 1% w/w in an aqueous solution of 20 mM SDS. The sink emulsion is used immediately or placed in the fridge and used within 24 hours.

### Microfluidic Droplet Generation

We generate monodisperse toluene droplets by using a commercial droplet generator glass chip (Darwin microfluidics, T-26) connected to a multi-channel pressure regulator (Elveflow, OB1 MK3+). The dispersed phase of the emulsion consists in a dispersion of NCs with a known volume fraction in toluene, filtered before use with a 0.22 μm PVDF or PTFE syringe filter. The continuous phase of the emulsion consists in a 20 mM solution of SDS in Milli-Q water filtered before use with a 0.22 μm PVDF syringe filter. The sink emulsion phase is prepared as described above and consists in a 1% w/w of hexadecane or dodecane in 20 mM SDS in Milli-Q water. The microfluidic chip is operated at pressures of 1 bar/1 bar/2 bar for dispersed/continuous/sink emulsion channels. Increasing the overall pressure while maintaining the same ratios results in smaller toluene droplets. Instead, the herringbone mixer chip is operated at 1 bar/1 bar pressures for source/sink emulsion phases. In all cases, the outlet of the chip is connected to a PFA tubing (ID 0.5 mm, OD 1.6 mm, Cole Parmer). The tubing has an overall length of 11.5 m and is wrapped around a cylindrical copper rod (OD 38 mm, length 0.33 m, McMaster Carr) engraved with a spiral of 0.8 mm radius and 3.2 mm pitch to improve thermal contact.83 The temperature of the rod is controlled by means of a temperature controller (J-KEM) by embedding a heating cartridge (Briskheat) and a thermocouple (J-KEM) within the rod. The samples are collected in 20 mL scintillation vials filled with 5 mL of the sink emulsion. After collection, the vials are left uncapped and undisturbed on a hot plate set at 50° C. for overnight. The samples are then washed three times by centrifuging at 100 g and replacing the supernatant with 20 mM SDS in Milli-Q water, and eventually concentrated to 1 mL.

### Electron Microscopy

The samples are prepared for SEM imaging by drop casting 40 μL of the superparticle dispersion on a clean piece of silicon wafer, followed by vacuum drying. The wafer is then dipped twice in a cleaning solution of water and isopropanol, 1:2 by volume, to remove the excess surfactant without redispersing the superparticles, followed by vacuum drying. The samples are imaged using a Tescan S8252X operated at 2 kV and 100 pA. FIB milling of the superparticles is performed with an ion voltage and current of 30 kV and 100 nA, respectively.

### Lasing Experiments

500 nm light from an optical parametric amplifier (Coherent OperaHP) pumped by an ultrafast laser (Coherent Monaco 1035, 0.272 ps pulsewidth) is coupled to a multimode optical fiber. The output of the fiber is collimated and directed through a 50×/NA 0.8 objective (Olympus MPlanFL N). The full-width at half-maximum of the spot size in the sample plane is 14.0 μm. Light emitted by the superparticles is collected through the same objective and focused to an optical fiber coupled to a spectrometer (Horiba iHR550 monochromator and Symphony II CCD). The excitation beam is filtered from the signal via appropriate long-pass filters placed before the collection fiber.

Monodisperse NC superparticles were fabricated through the controlled densification of monodisperse toluene droplets containing a NC dispersion. The toluene droplets were generated by using a commercial glass droplet generator (T-26, Darwin Microfluidics). The droplet generator featured 3 inlets and 1 outlet and was originally designed by the manufacturer to use only 2 inlets and 1 outlet at any given time to generate oil-in-water droplets at one of the 2 available cross junctions. We adapted the droplet generator (FIG. 8a) to use the first junction to generate the source emulsion (FIG. 8b), and the second junction to introduce the sink emulsion (FIG. 8c).

The inlets and the outlet of the droplet generator were connected to a 0.02″ ID× 1/16″ OD PFA tubing (IDEX HS) by using a flangeless PEEK fitting with a ¼-28 thread (IDEX HS).

Inlet 1 was connected to a 22 mL vial (Qorpak GLC01002, thread 20 mm-400) through a microfluidic adapter (Elveflow) originally designed for 15 mL centrifuge tubes. The 22 mL vial contained a smaller 1.85 mL vial (Qorpak GLC00978) which is sufficiently narrow to fit inside the 22 mL vial but wide enough to remain vertical (FIG. 8e). This smaller vial was filled with 1 mL of a dispersion of NCs in toluene, previously filtered by using a 0.22 μm PTFE syringe filter (phase 1), and the PFA tubing was collecting the NC phase from the bottom of this smaller vial.

Inlet 2 was connected through a microfluidic adapter (Elveflow) to a 1 L media bottle filled with 1 L of a 20 mM solution of SDS in water, previously filtered by using a 0.22 μm PVDF syringe filter (phase 2).

Inlet 3 was connected to a 0.5 L media bottle filled with 0.5 L of sink emulsion, a 1% w/w hexadecane or dodecane emulsion in 20 mM SDS in water, prepared as described in the main text (phase 3).

The headspace of the 22 mL vial, 1 L media bottle, and 0.5 L media bottle were initially pressurized to 2 bar by using a microfluidic flow controller (Elveflow, OB1 MK3+) connected to a pressurized nitrogen cylinder (Airgas).

The droplet generator was operated by first flooding the device through inlet 2 with phase 2 (FIG. 8a), while keeping the other two inlets plugged by using “L” valves (IDEX HS, FIG. 8f). Phase 3 was then introduced in the device through inlet 3 (FIG. 8a). Phase 1 was subsequently introduced to the device through inlet 1 (FIG. 8a), resulting in the generation of a continuous jet of phase 1 into phase 2 at the first cross junction. Using the flow controller, the pressure applied to phases 1 and 2 was decreased in steps of 0.25 bar over 60 seconds to reach 1 bar for both phases. Note: Using even lower pressures resulted in the backflow of phase 1. After a few seconds, this resulted in the generation of monodisperse droplets of phase 1 into phase 2 in dripping regime, (FIG. 8b), forming the source emulsion.¹ Downstream from the first junction, the source emulsion mixed with the sink emulsion at the second cross junction (FIG. 8c).

The outlet (4) of the droplet generator was connected to an 11.5 m long PFA tubing wrapped around a copper rod (FIG. 8d) as described in the main text. The rod was temperature-controlled by embedding a heating cartridge (Briskheat) and a thermocouple (J-KEM) and controlling the power applied to the cartridge through a temperature controller (J-KEM Apollo). The design for the rod was inspired by a recent report.

### NC Synthesis

CdSe NCs: CdSe NCs were synthesized according to a literature report.

Materials: All reagents are purchased from Sigma-Aldrich and are used as received. 1-Octadecene (ODE, technical grade, Acros Organics), oleic acid (OA, technical grade), CdO (≥99.99% trace metals basis), selenium (powder ˜100 mesh, 99.99% trace metals basis), trioctylphosphine (TOP, 97%), hexane (reagent grade), and ethanol (200 proof, reagent grade).

### Synthesis

A 1M TOP: Se solution was prepared by stirring 0.790 g (10 mmol) of Se powder in 10 mL of TOP in a nitrogen-filled glovebox for overnight. All the Se powder should be dissolved to form a transparent, yellow-tinted solution before use in the synthesis. Prior to synthesis, 3 mL of the 1M TOP: Se was mixed with 7 mL of ODE and loaded into a glass syringe placed in a syringe pump set for a rate of 10 mL/hour.

The cadmium oleate precursor solution was prepared by mixing 0.512 g of CdO, 6.28 g of OA, and 25 g of ODE (32 mL) in a 100 mL three-neck round-bottom flask. The flask was connected to the Schlenk line through the central neck, one of the side-necks was equipped with a thermocouple adapter and thermocouple, and the other side-neck was fitted with a rubber septum. While stirring, the reagents were degassed at 100° C. for one hour. Afterward, the flask atmosphere was switched to nitrogen and the temperature was raised to 260° C. The temperature was held constant until the color of the mixture changes from dark red to colorless, indicating the formation of cadmium oleate. Subsequently, the temperature was decreased to 100° C. by forced-air cooling and the flask was placed under vacuum for 30 minutes. This was done to remove the water produced during the reaction. After switching the atmosphere again to nitrogen, the temperature was raised to 260° C.

Meanwhile, 0.063 g (0.8 mmol) of Se powder is added to 5 mL of ODE and sonicated for 20 minutes. The Se/ODE mixture is injected at 260° C. through the free side-neck by using a 22 mL plastic syringe equipped with a 16 G needle. Immediately thereafter, the temperature controller is set to 240° C. After 60 seconds from the injection, the TOP: Se/ODE solution is added dropwise at a rate of 10 mL/hour. After 60 minutes, the reaction is rapidly quenched by removing the heating mantle and dropping the flask in a container full of water at room temperature.

The reaction mixture was split into enough 50 mL centrifuge tubes such that there are 5 mL of the mixture in each tube. Approximately 20 mL of hexane were added to each tube and each tube was then capped and vortexed. 25 mL of ethanol was added to each tube, and the tubes were centrifuged at 8000 g for 5 minutes. Often, this first precipitation results in a slightly colored supernatant, and it is discarded while keeping the precipitated QDs. The QD product was washed twice more by dispersing each QD precipitate in 10 mL of hexane and then precipitating with an equal volume of ethanol. After the final wash, the QD product was dispersed into toluene at 50 mg/mL and filtered by using a 0.22 μm PTFE or PVDF syringe filter.

CdSe/CdS NCs: CdSe/CdS NCs were synthesized by following a recent literature report.

### Materials

CdO (≥99.99% trace metals basis), selenium (powder ˜100 mesh, 99.99% trace metals basis, Sigma-Aldrich), oleic acid (OA, technical grade), 1-octadecene (ODE, technical grade, Acros Organics), 1-octanethiol (98.0%, TCI), trioctylphosphine (TOP, 97%, Sigma-Aldrich), trioctylphosphine oxide (TOPO, 99%, Sigma-Aldrich), n-octadecyl phosphonic acid (ODPA, PCI), hexane (reagent grade), and methanol (MeOH, certified ACS, Fisher), ethanol (EtOH, 190 proof, Decon Labs Inc.), isopropanol (IPA, certified ACS, Fisher), methyl acetate (MeOAc, 99%, Alfa Aesar).

### Synthesis of CdSe Cores

180 mg of CdO, 9 g of TOPO, and 840 mg of ODPA, and a 1-inch octagonal stir bar were added to a 50 mL three-neck round-bottom flask. The flask was connected to the Schlenk line through the central neck, one of the side-necks was equipped with a thermocouple adapter and thermocouple, and the other side-neck was fitted with a rubber septum. The flask was heated to 150° C. using a heating mantle under gentle stirring. When the mixture starts to melt, the flask was slowly placed under vacuum (0.1 Torr). The vacuum was held for 0.5 hours at 150° C. The atmosphere of the flask was then switched to nitrogen, and the temperature was increased to 320° C. The temperature was held at 320° C. until the mixture turns colorless, about 1 hour. The temperature was then decreased to 150° C. using forced air cooling, and the contents of the flask were degassed for 1.5 hours.

In the meanwhile, a 1.696 M TOP: Se solution was prepared in a nitrogen-filled glovebox by adding 58 mg of Se to 360 mg of TOP, and stirring until the mixture becomes clear.

The reaction temperature was then increased to 320° C. and 5.4 mL of TOP were injected into the flask. The reaction temperature was then increased to 365° C. At that point, 1.254 g of the TOP: Se mixture, loaded in a 6 mL syringe equipped with a 16 G needle, were injected to result in nucleation of the CdSe NCs. The reaction was maintained at temperature for 55 seconds.

The temperature of the flask was quickly decreased to 150° C. by using forced air cooling. At 150° C., 20 mL of toluene were added to the reaction mixture. At 90° C., the contents of the reaction were transferred to 2 50 mL centrifuge tubes, topped up with toluene so that each tube would contain 20 mL of the mixture. 10 mL of MeOH were then added to each tube. The contents of the 2 tubes were centrifuged at 8000 g for 3 minutes, to result in a colorful pellet. The supernatant was discarded, and the NCs were redispersed in 7.5 mL of hexanes and 0.1 mL of OA per tube by vigorous vortexing. 7.5-10 mL of EtOH were added to each tube until cloudy. The contents of the two tubes were centrifuged at 8000 g for 3 minutes. The supernatant was discarded, and the colorful pellet was redispersed in 7.5 mL of hexanes. 7.5-10 mL of IPA were added to each tube until cloudy. The contents of the two tubes were centrifuged at 8000 g for 3 minutes. The supernatant from the tubes was discarded, and the pellet was redispersed in a total of 5 mL of hexanes. The NC dispersion was centrifuged once more without any antisolvent, and the supernatant was filtered using a 0.22 μm PTFE or PVDF syringe filter and stored in the dark. The concentration of the NCs was determined using spectrophotometry.

### Synthesis of CdS Shell

0.2 M Cadmium oleate (1:10 Cd: OA molar ratio) in ODE was prepared according to the literature and stored in the glovebox.⁴ Specifically, 2.57 g of CdO, 63.1 mL of OA, and 36.6 mL of ODE were added to a 250 mL 3-neck round-bottom flask and degassed at 110° C. for 2 hours. The flask was connected to the Schlenk line through the central neck, one of the side-necks was equipped with a thermocouple adapter and thermocouple, and the other side-neck was fitted with a rubber septum. The atmosphere of the flask was then switched to nitrogen and the temperature was raised to 160° C. The temperature was maintained for 30 minutes, or until the mixture changed in color from dark red to colorless. The flask was then cooled using forced air to 110° C. and degassed for 2 hours. The mixture was then transferred via cannula to a second flask and moved to the glovebox. There, the Cadmium oleate was stored in a media bottle with a stir bar. Since Cadmium oleate solidifies at room temperature, prior to each use the bottle was placed on a hot plate at 100° C. while stirring to melt its contents.

6 mL of ODE and 100 nanomoles of CdSe NCs in hexane were added to a 50 mL 4-neck round-bottom flask and degassed at room temperature for 1 hour. The flask was connected to the Schlenk line through the central neck, one of the side-necks was equipped with a thermocouple adapter and thermocouple, and the other 2 side-necks were fitted with rubber septa. The temperature of the mixture was then increased to 120° C., and the mixture was degassed for additional 1.5 hours. The atmosphere of the flask was then switched to nitrogen and the temperature was increased to 240° C.

Meanwhile, in the glovebox, we prepared 1 syringe with 0.2 M Cadmium oleate, and 1 syringe with 0.2 M 1-octanethiol in ODE with equal volumes. The syringes were then loaded on a syringe pump and injected into the reaction mixture through the 2 free side-necks at an injection rate of 3 mL/hour. After starting the injection, the temperature of the flask was increased to 310° C. and maintained until 10 minutes after the end of the injection.

The reaction temperature was then decreased first through forced-air cooling (310 to 240 C), then by using a water bath (240 to 40 C). When the reaction mixture reached 100° C., 25 mL of MeOAc were injected into the flask. The contents of the flask were then transferred to a 50 mL centrifuge tube and centrifuged at 8000 g for 6 minutes. After discarding the supernatant, the colorful pellet was redispersed in 5 mL of hexanes. Then, the sample was centrifuged without any addition of anti-solvent. The supernatant was carefully transferred to a clean centrifuge tube, while the precipitate was discarded. 7.5 mL of MeOAc were added to the NC dispersion, and the mixture was centrifuged once again. The colorful pellet was redispersed in 5 mL of hexanes, and 7.5 mL of MeOAc were added, followed by centrifugation. Finally, the colorful pellet was redispersed in 5 mL of toluene and filtered by using a 0.22 μm PVDF syringe filter. The NC concentration was determined by drying part of the sample and weighing the pellet.

PbS NCs: PbS NCs were synthesized by following a recent literature report.

### Materials

1-Octadecene (ODE, technical grade, Acros Organics), oleic acid (OA, technical grade, Sigma Aldrich), oleylamine (OAm, technical grade, Sigma Aldrich), PbO (99.9+% trace metals basis, Acros Organics), PbCl₂ (99.999%, Alfa Aesar), hexamethyldisilathiane ((TMS)₂S, synthesis grade, Sigma Aldrich), hexanes (certified ACS, Fisher), acetone (certified ACS, Fisher), toluene (certified ACS, Fisher).

### NC Synthesis

In a 250 mL round-bottom flask, 9.0 g of PbO, 30 mL of OA, and 60 mL of ODE were stirred at 110° C. overnight under a vacuum of 0.1 Torr to prepare the lead oleate precursor. Meanwhile, in the glove box, 0.206 mL of (TMS)₂S were added to 9.6 mL of dried 1-octadecene. Separately, a 0.3 mM solution of PbCl₂ in OAm was prepared by stirring at 120° C. under vacuum.

17.5 mL of lead oleate precursor and 15 mL of ODE were added to a 100 mL three-neck round-bottom flask. The flask was connected to the Schlenk line through the central neck, while one of the side-necks was equipped with a thermocouple adapter and thermocouple and the other was sealed with a rubber stopper. The contents of the flask were degassed at 100° C. for 1 hour. After switching the atmosphere to nitrogen, the flask was allowed to cool to ˜50° C., followed by slow heating to 109° C. Once the target temperature was reached, the (TMS)₂S/ODE solution was swiftly injected into the flask through the side neck by using a 22 mL plastic syringe equipped with a 16 G needle. Immediately after injection, the heating mantle was turned off and the flask was allowed to cool naturally to 30° C. 1 mL of the PbCl₂/OAm solution was injected into the flask when the whole mixture cooled to 60° C. The synthetic mixture was split in 50 mL centrifuge tubes, and acetone was added to achieve a volume ratio of 1:1. The cloudy dispersion was centrifuged at 8000 g for 3 minutes and the supernatant was discarded. The nanocrystals were dissolved in toluene and the precipitation with acetone was repeated twice using a toluene: acetone volume ratio of 1:1.25. The nanocrystals were finally redispersed into 15 mL of toluene and filtered by using a 0.22 μm PVDF syringe filter. The nanocrystal concentration was determined by spectrophotometry using a sizing curve reported in the literature.

PbS/CdS NCs: PbS/CdS NCs were synthesized by following a literature report.

### Materials

CdO (≥99.99% trace metals basis), 1-octadecene (ODE, technical grade, Acros Organics), oleic acid (OA, technical grade, Sigma Aldrich), ethanol (EtOH, 190 proof, Decon Labs Inc.), toluene (certified ACS, Fisher).

### Cation Exchange Reaction

12 mL of PbS NCs in toluene synthesized as described above were bubbled with nitrogen at room temperature. Meanwhile, a 1 g of CdO, 6 mL of OA, and 20 mL of ODE were added to a 100 mL 3-neck round-bottom flask. The flask was connected to the Schlenk line through the central neck, one of the side necks was equipped with thermocouple adapter and thermocouple, and the other side neck was sealed with a rubber stopper. The contents of the flask were degassed for 20 minutes at 110° C. The atmosphere of the flask was then switched to nitrogen and the temperature increase to 260° C. The temperature was maintained until the mixture turned colorless. The temperature of the reaction was then decreased to 110° C. through forced-air cooling, and the contents were degassed for 1 hour. The temperature of the reaction was eventually decreased to 70° C. and the atmosphere switched to nitrogen. The PbS NCs in toluene were loaded in a 24 mL syringe equipped with a 16 G needle and injected into the cadmium oleate flask. The reaction was allowed to proceed for 0.5 hours, followed by cooling to 30° C. The NCs were washed 3 times using toluene and EtOH as solvent and antisolvent, at a volume ratio of 1:1. Finally, the NCs were redispersed in 6 mL of toluene and filtered by using a 0.22 μm PVDF syringe filter. The concentration was determined by assuming the conservation of the same NC molarity and size as prior to the cation exchange.

Undoped or Yb³⁺, Er³⁺-doped β-NaGdF₄ NCs with a hexagonal plate morphology

### Materials

Gadolinium (III) oxide (99.99%), 1-ODE (technical grade, 90%), Oleic Acid (OA, technical grade, 90%), and sodium fluoride (NaF, 99.5%) were purchased from Sigma Aldrich and used as received. Ytterbium (III) Oxide (99.99%) and Erbium (III) trifluoroacetate were purchased from GFS Chemicals. Trifluoroacetic acid (TFA, 99%) was purchased from Alfa Aesar.

### NC Synthesis

Gadolinium trifluoroacetate and ytterbium trifluoroacetate were synthesized as follows: 10 g rare earth oxide, 50 ml deionized water, and 50 ml TFA were brought to reflux (80 C) until complete dissolution of the solids. Then the mixture was placed in a vacuum oven at 80° C. overnight to remove the excess water and generate a white solid. 2 mmol gadolinium trifluoroacetate (for 10% Yb, 1% Er doped hexagonal plates, 10% and 1% of gadolinium precursor is replaced by ytterbium and erbium precursors, respectively), 2.6 mmol of NaF, 30 mL OA, 30 mL 1-ODE were added into a three-neck flask. The mixture was degassed at 125° C. for 1 hour. The mixture was further heated to 290° C. and kept at this temperature for 5 hours. The mixture was then cooled to stop the reaction. The reaction mixture was split into 50 mL centrifuge tubes with 20 ml of mixture per tube. 30 mL EtOH were added to each tube to precipitate the nanocrystals. The mixture was centrifuged at 8000 g for 3 minutes. The supernatant was discarded, and the white precipitate was dissolved in 10 mL hexanes and then washed with another 20 mL EtOH. The mixture was centrifuged at 8000 g for 1 minute. The supernatant was discarded, and the white precipitate was dissolved in hexanes. 0.1 mL OA was added into the dispersion, and then the mixture was sonicated and vortexed to disperse the nanocrystals. The NC dispersions were washed again with EtOH, and the white precipitate is redispersed in 10 mL hexanes, resulting in a concentration of ˜15 mg/mL determined by drying part of the sample and weighing the pellet.

### Sample Characterization

### TEM

For low-resolution TEM, a JEOL 1400 microscope was operated at 120 kV. For higher-resolution TEM, a JEOL F200 microscope was operated at 200 kV. During imaging, magnification, focus, and tilt angle were varied to yield information about the crystal structure and super structure of the particle systems. To prepare the dispersed nanocrystals for imaging, we drop cast 10 μL of a dilute (˜0.1 mg/mL) dispersion of nanocrystals in toluene on a carbon-coated TEM grid (EMS). The grid was dried under vacuum for 1 hour prior to imaging.

### SEM

The samples were imaged by using a Tescan S8252X operated at 2 kV and 100 pA. The samples were prepared for imaging by drop casting 40 μL of the superparticle dispersion on a clean piece of silicon wafer, followed by vacuum drying. The wafer was then dipped twice in a cleaning solution of water to isopropanol 1:2 by volume to remove the excess surfactant, followed by vacuum drying. FIB milling of the superparticles was performed with an ion voltage and current of 30 kV and 100 nA, respectively.

### SAXS

The static patterns were collected using a Pilatus 1M detector on a Xeuss 2.0 system (Xenocs). 25 μL of a 10 mg/mL dispersion of nanocrystals in toluene were loaded in a 1 mm capillary tube (Charles Supper). The capillary was then sealed by using a hot-glue gun. The integration time for each measurement was set to 30 minutes. The sample to detector distance was set to 1.2 m. The beam energy was set to 8 keV (copper anode). The two-dimensional patterns were azimuthally averaged, and background subtracted. The q-range was calibrated against a silver behenate standard. The scattering patterns were fitted to the form factor of a sphere:

$$F ( q ) = 3 \frac{sin qr - qr cos qr}{{( qr )}^{3}}$$

convoluted with a Gaussian distribution of sizes to account for polydispersity by using the open-source SASfit software.¹¹

### DLS

DLS characterization was performed using a Malvern Zetasizer instrument. The emulsion sample was diluted 10-fold in an aqueous solution of SDS just prior to the measurement. The reported hydrodynamic diameter represents the average of 3 60-second measurements performed at 22° C.

### Spectrophotometry

Absorption spectra of nanocrystal dispersions in toluene (CdSe) or tetrachloroethylene (PbS) were measured by using a Cary 5000 UV-Vis-NIR spectrophotometer.

### PLQY

PLQY measurements were performed by using the integrating sphere module of an Edinburgh FLS1000 Photoluminescence Spectrometer. The NCs were dispersed at a concentration corresponding to an absorbance of 0.1 at the excitation wavelength.

### REFERENCES

1. Bishop, K. J. M.; Wilmer, C. E.; Soh, S.; Grzybowski, B. A., Nanoscale Forces and Their Uses in Self-Assembly. Small 2009, 5 (14), 1600-1630.
2. Marino, E.; Vasilyev, O. A.; Kluft, B. B.; Stroink, M. J. B.; Kondrat, S.; Schall, P., Controlled deposition of nanoparticles with critical Casimir forces. Nanoscale Horizons 2021, 6 (9), 751-758.
3. Whitesides George, M.; Grzybowski, B., Self-Assembly at All Scales.

### Science 2002, 295 (5564), 2418-2421.

4. Teyssier, J.; Saenko, S. V.; van der Marel, D.; Milinkovitch, M. C., Photonic crystals cause active colour change in chameleons. Nature Communications 2015, 6 (1), 6368.
5. Murray, C. B.; Norris, D. J.; Bawendi, M. G., Synthesis and characterization of nearly monodisperse CdE (E=sulfur, selenium, tellurium) semiconductor nanocrystallites. Journal of the American Chemical Society 1993, 115 (19), 8706-8715.
6. Murray, C. B.; Kagan, C. R.; Bawendi, M. G., Self-Organization of CdSe Nanocrystallites into Three-Dimensional Quantum Dot Superlattices. Science 1995, 270 (5240), 1335-1338.
7. Wu, L.; Willis, J. J.; Mckay, I. S.; Diroll, B. T.; Qin, J.; Cargnello, M.; Tassone, C. J., High-temperature crystallization of nanocrystals into three-dimensional superlattices. Nature 2017, 548 (7666), 197-201.
8. Santos, P. J.; Gabrys, P. A.; Zornberg, L. Z.; Lee, M. S.; Macfarlane, R. J., Macroscopic materials assembled from nanoparticle superlattices. Nature 2021, 591 (7851), 586-591.
9. Shevchenko, E. V.; Podsiadlo, P.; Wu, X.; Lee, B.; Rajh, T.; Morin, R.; Pelton, M., Visualizing Heterogeneity of Monodisperse CdSe Nanocrystals by Their Assembly into Three-Dimensional Supercrystals. ACS Nano 2020, 14 (11), 14989-14998.
10. Schedelbeck, G.; Wegscheider, W.; Bichler, M.; Abstreiter, G., Coupled Quantum Dots Fabricated by Cleaved Edge Overgrowth: From Artificial Atoms to Molecules. Science 1997, 278 (5344), 1792-1795.
11. Bayer, M.; Hawrylak, P.; Hinzer, K.; Fafard, S.; Korkusinski, M.; Wasilewski, Z. R.; Stern, O.; Forchel, A., Coupling and Entangling of Quantum States in Quantum Dot Molecules. Science 2001, 291 (5503), 451-453.
12. Rowland, C. E.; Fedin, I.; Zhang, H.; Gray, S. K.; Govorov, A. O.; Talapin, D. V.; Schaller, R. D., Picosecond energy transfer and multiexciton transfer outpaces Auger recombination in binary CdSe nanoplatelet solids. Nature Materials 2015, 14 (5), 484-489.
13. Lan, X.; Chen, M.; Hudson, M. H.; Kamysbayev, V.; Wang, Y.; Guyot-Sionnest, P.; Talapin, D. V., Quantum dot solids showing state-resolved band-like transport. Nature Materials 2020, 19 (3), 323-329.
14. Choi, J.-H.; Fafarman, A. T.; Oh, S. J.; Ko, D.-K.; Kim, D. K.; Diroll, B. T.; Muramoto, S.; Gillen, J. G.; Murray, C. B.; Kagan, C. R., Bandlike Transport in Strongly Coupled and Doped Quantum Dot Solids: A Route to High-Performance Thin-Film Electronics. Nano Letters 2012, 12 (5), 2631-2638.
15. Talgorn, E.; Gao, Y.; Aerts, M.; Kunneman, L. T.; Schins, J. M.; Savenije, T. J.; van Huis, M. A.; van der Zant, H. S. J.; Houtepen, A. J.; Siebbeles, L. D. A., Unity quantum yield of photogenerated charges and band-like transport in quantum-dot solids. Nature Nanotechnology 2011, 6 (11), 733-739.
16. Lee, J.-S.; Kovalenko, M. V.; Huang, J.; Chung, D. S.; Talapin, D. V., Band-like transport, high electron mobility and high photoconductivity in all-inorganic nanocrystal arrays. Nature Nanotechnology 2011, 6 (6), 348-352.
17. Chen, J.; Dong, A.; Cai, J.; Ye, X.; Kang, Y.; Kikkawa, J. M.; Murray, C. B., Collective Dipolar Interactions in Self-Assembled Magnetic Binary Nanocrystal Superlattice Membranes. Nano Letters 2010, 10 (12), 5103-5108.
18. Chen, J.; Ye, X.; Oh, S. J.; Kikkawa, J. M.; Kagan, C. R.; Murray, C. B., Bistable Magnetoresistance Switching in Exchange-Coupled CoFe2O4-Fe3O4 Binary Nanocrystal Superlattices by Self-Assembly and Thermal Annealing. ACS Nano 2013, 7 (2), 1478-1486.
19. Yang, Y.; Wang, B.; Shen, X.; Yao, L.; Wang, L.; Chen, X.; Xie, S.; Li, T.; Hu, J.; Yang, D.; Dong, A., Scalable Assembly of Crystalline Binary Nanocrystal Superparticles and Their Enhanced Magnetic and Electrochemical Properties. Journal of the American Chemical Society 2018, 140 (44), 15038-15047.
20. Mueller, N. S.; Okamura, Y.; Vieira, B. G. M.; Juergensen, S.; Lange, H.; Barros, E. B.; Schulz, F.; Reich, S., Deep strong light-matter coupling in plasmonic nanoparticle crystals. Nature 2020, 583 (7818), 780-784.
21. Guo, J.; Kim, J.-Y.; Yang, S.; Xu, J.; Choi, Y. C.; Stein, A.; Murray, C. B.; Kotov, N. A.; Kagan, C. R., Broadband Circular Polarizers via Coupling in 3D Plasmonic Meta-Atom Arrays. ACS Photonics 2021, 8 (5), 1286-1292.
22. Ye, X.; Chen, J.; Diroll, B. T.; Murray, C. B., Tunable Plasmonic Coupling in Self-Assembled Binary Nanocrystal Superlattices Studied by Correlated Optical Microspectrophotometry and Electron Microscopy. Nano Letters 2013, 13 (3), 1291-1297.
23. Poyser, C. L.; Czerniuk, T.; Akimov, A.; Diroll, B. T.; Gaulding, E. A.; Salasyuk, A. S.; Kent, A. J.; Yakovlev, D. R.; Bayer, M.; Murray, C. B., Coherent Acoustic Phonons in Colloidal Semiconductor Nanocrystal Superlattices. ACS Nano 2016, 10 (1), 1163-1169.
24. Bozyigit, D.; Yazdani, N.; Yarema, M.; Yarema, O.; Lin, W. M. M.; Volk, S.; Vuttivorakulchai, K.; Luisier, M.; Juranyi, F.; Wood, V., Soft surfaces of nanomaterials enable strong phonon interactions. Nature 2016, 531 (7596), 618-622.
25. le Feber, B.; Prins, F.; De Leo, E.; Rabouw, F. T.; Norris, D. J., Colloidal-Quantum-Dot Ring Lasers with Active Color Control. Nano Letters 2018, 18 (2), 1028-1034.
26. Montanarella, F.; Urbonas, D.; Chadwick, L.; Moerman, P. G.; Baesjou, P. J.; Mahrt, R. F.; van Blaaderen, A.; Stöferle, T.; Vanmaekelbergh, D., Lasing Supraparticles Self-Assembled from Nanocrystals. ACS Nano 2018, 12 (12), 12788-12794.
27. Marino, E.; Sciortino, A.; Berkhout, A.; MacArthur, K. E.; Heggen, M.; Gregorkiewicz, T.; Kodger, T. E.; Capretti, A.; Murray, C. B.; Koenderink, A. F.; Messina, F.; Schall, P., Simultaneous Photonic and Excitonic Coupling in Spherical Quantum Dot Supercrystals. ACS Nano 2020, 14 (10), 13806-13815.
28. Kagan, C. R.; Murray, C. B., Charge transport in strongly coupled quantum dot solids. Nature Nanotechnology 2015, 10 (12), 1013-1026.
29. Kuznetsov Arseniy, I.; Miroshnichenko Andrey, E.; Brongersma Mark, L.; Kivshar Yuri, S.; Luk'yanchuk, B., Optically resonant dielectric nanostructures. Science 2016, 354 (6314), aag2472.
30. Bohren, C. F.; Huffman, D. R., Chapter 4: Absorption and Scattering by a Sphere. In Absorption and Scattering of Light by Small Particles, 1998; pp 82-129.
31. Jana, S.; Xu, X.; Klymchenko, A.; Reisch, A.; Pons, T., Microcavity-Enhanced Fluorescence Energy Transfer from Quantum Dot Excited Whispering Gallery Modes to Acceptor Dye Nanoparticles. ACS Nano 2021, 15 (1), 1445-1453.
32. Du, W.; Zhang, S.; Wu, Z.; Shang, Q.; Mi, Y.; Chen, J.; Qin, C.; Qiu, X.; Zhang, Q.; Liu, X., Unveiling lasing mechanism in CsPbBr3 microsphere cavities. Nanoscale 2019, 11 (7), 3145-3153.
33. Chang, H.; Zhong, Y.; Dong, H.; Wang, Z.; Xie, W.; Pan, A.; Zhang, L., Ultrastable low-cost colloidal quantum dot microlasers of operative temperature up to 450 K. Light: Science & Applications 2021, 10 (1), 60.
34. Armani, D. K.; Kippenberg, T. J.; Spillane, S. M.; Vahala, K. J., Ultra-high-Q toroid microcavity on a chip. Nature 2003, 421 (6926), 925-928.
35. Linden, S.; Niesler, F. B. P.; Förstner, J.; Grynko, Y.; Meier, T.; Wegener, M., Collective Effects in Second-Harmonic Generation from Split-Ring-Resonator Arrays. Physical Review Letters 2012, 109 (1), 015502.
36. Armani Andrea, M.; Kulkarni Rajan, P.; Fraser Scott, E.; Flagan Richard, C.; Vahala Kerry, J., Label-Free, Single-Molecule Detection with Optical Microcavities. Science 2007, 317 (5839), 783-787.
37. Zhu, J.; Ozdemir, S. K.; Xiao, Y.-F.; Li, L.; He, L.; Chen, D.-R.; Yang, L., On-chip single nanoparticle detection and sizing by mode splitting in an ultrahigh-Q microresonator. Nature Photonics 2010, 4 (1), 46-49.
38. Zhao, X.; Tsai, J. M.; Cai, H.; Ji, X. M.; Zhou, J.; Bao, M. H.; Huang, Y. P.; Kwong, D. L.; Liu, A. Q., A nano-opto-mechanical pressure sensor via ring resonator. Opt. Express 2012, 20 (8), 8535-8542.
39. Marino, E.; Keller, A. W.; An, D.; van Dongen, S.; Kodger, T. E.; MacArthur, K. E.; Heggen, M.; Kagan, C. R.; Murray, C. B.; Schall, P., Favoring the Growth of High-Quality, Three-Dimensional Supercrystals of Nanocrystals. The Journal of Physical Chemistry C 2020, 124 (20), 11256-11264.
40. Tang, Y.; Gomez, L.; Lesage, A.; Marino, E.; Kodger, T. E.; Meijer, J.-M.; Kolpakov, P.; Meng, J.; Zheng, K.; Gregorkiewicz, T.; Schall, P., Highly Stable Perovskite Supercrystals via Oil-in-Oil Templating. Nano Letters 2020, 20 (8), 5997-6004.
41. Yadavali, S.; Jeong, H.-H.; Lee, D.; Issadore, D., Silicon and glass very large scale microfluidic droplet integration for terascale generation of polymer microparticles. Nature Communications 2018, 9 (1), 1222.
42. Velev Orlin, D.; Lenhoff Abraham, M.; Kaler Eric, W., A Class of Microstructured Particles Through Colloidal Crystallization. Science 2000, 287 (5461), 2240-2243.
43. Marino, E.; Kodger, T. E.; Wegdam, G. H.; Schall, P., Revealing Driving Forces in Quantum Dot Supercrystal Assembly. Advanced Materials 2018, 30 (43), 1803433.
44. de Nijs, B.; Dussi, S.; Smallenburg, F.; Meeldijk, J. D.; Groenendijk, D. J.; Filion, L.; Imhof, A.; van Blaaderen, A.; Dijkstra, M., Entropy-driven formation of large icosahedral colloidal clusters by spherical confinement. Nature Materials 2015, 14 (1), 56-60.
45. Lacava, J.; Born, P.; Kraus, T., Nanoparticle Clusters with Lennard-Jones Geometries. Nano Letters 2012, 12 (6), 3279-3282.
46. Kister, T.; Mravlak, M.; Schilling, T.; Kraus, T., Pressure-controlled formation of crystalline, Janus, and core-shell supraparticles. Nanoscale 2016, 8 (27), 13377-13384.
47. Wang, T.; LaMontagne, D.; Lynch, J.; Zhuang, J.; Cao, Y. C., Colloidal superparticles from nanoparticle assembly. Chemical Society Reviews 2013, 42 (7), 2804-2823.
48. Wintzheimer, S.; Granath, T.; Oppmann, M.; Kister, T.; Thai, T.; Kraus, T.; Vogel, N.; Mandel, K., Supraparticles: Functionality from Uniform Structural Motifs. ACS Nano 2018, 12 (6), 5093-5120.
49. Wang, T.; Wang, X.; LaMontagne, D.; Wang, Z.; Wang, Z.; Cao, Y. C., Shape-Controlled Synthesis of Colloidal Superparticles from Nanocubes. Journal of the American Chemical Society 2012, 134 (44), 18225-18228.
50. Wang, D.; Hermes, M.; Kotni, R.; Wu, Y.; Tasios, N.; Liu, Y.; de Nijs, B.; van der Wee, E. B.; Murray, C. B.; Dijkstra, M.; van Blaaderen, A., Interplay between spherical confinement and particle shape on the self-assembly of rounded cubes. Nature Communications 2018, 9 (1), 2228.
51. Savo, R.; Morandi, A.; Müller, J. S.; Kaufmann, F.; Timpu, F.; Reig Escalé, M.; Zanini, M.; Isa, L.; Grange, R., Broadband Mie driven random quasi-phase-matching. Nature Photonics 2020, 14 (12), 740-747.
52. Spinelli, P.; Verschuuren, M. A.; Polman, A., Broadband omnidirectional antireflection coating based on subwavelength surface Mie resonators. Nature Communications 2012, 3 (1), 692.
53. Yang, W.; Xiao, S.; Song, Q.; Liu, Y.; Wu, Y.; Wang, S.; Yu, J.; Han, J.; Tsai, D.-P., All-dielectric metasurface for high-performance structural color. Nature Communications 2020, 11 (1), 1864.
54. Kim, C.; Jung, K.; Yu, J. W.; Park, S.; Kim, S.-H.; Lee, W. B.; Hwang, H.; Manoharan, V. N.; Moon, J. H., Controlled Assembly of Icosahedral Colloidal Clusters for Structural Coloration. Chemistry of Materials 2020, 32 (22), 9704-9712.
55. Liu, T.; VanSaders, B.; Glotzer, S. C.; Solomon, M. J., Effect of Defective Microstructure and Film Thickness on the Reflective Structural Color of Self-Assembled Colloidal Crystals. ACS Applied Materials & Interfaces 2020, 12 (8), 9842-9850.
56. Teh, S.-Y.; Lin, R.; Hung, L.-H.; Lee, A. P., Droplet microfluidics. Lab on a Chip 2008, 8 (2), 198-220.
57. Utada, A. S.; Lorenceau, E.; Link, D. R.; Kaplan, P. D.; Stone, H. A.; Weitz, D. A., Monodisperse Double Emulsions Generated from a Microcapillary Device. Science 2005, 308 (5721), 537-541.
58. Chu, L.-Y.; Utada, A. S.; Shah, R. K.; Kim, J.-W.; Weitz, D. A., Controllable Monodisperse Multiple Emulsions. Angewandte Chemie International Edition 2007, 46 (47), 8970-8974.
59. Zheng, Y.; Yu, Z.; Parker, R. M.; Wu, Y.; Abell, C.; Scherman, O. A., Interfacial assembly of dendritic microcapsules with host-guest chemistry. Nature Communications 2014, 5 (1), 5772.
60. Amstad, E.; Kim, S.-H.; Weitz, D. A., Photo- and Thermoresponsive Polymersomes for Triggered Release. Angewandte Chemie International Edition 2012, 51 (50), 12499-12503.
61. Wang, J.; Mbah, C. F.; Przybilla, T.; Apeleo Zubiri, B.; Spiecker, E.; Engel, M.; Vogel, N., Magic number colloidal clusters as minimum free energy structures. Nature Communications 2018, 9 (1), 5259.
62. Holtze, C.; Rowat, A. C.; Agresti, J. J.; Hutchison, J. B.; Angilè, F. E.; Schmitz, C. H. J.; Köster, S.; Duan, H.; Humphry, K. J.; Scanga, R. A.; Johnson, J. S.; Pisignano, D.; Weitz, D. A., Biocompatible surfactants for water-in-fluorocarbon emulsions. Lab on a Chip 2008, 8 (10), 1632-1639.
63. Vogel, N.; Utech, S.; England, G. T.; Shirman, T.; Phillips, K. R.; Koay, N.; Burgess, I. B.; Kolle, M.; Weitz, D. A.; Aizenberg, J., Color from hierarchy: Diverse optical properties of micron-sized spherical colloidal assemblies. Proceedings of the National Academy of Sciences 2015, 112 (35), 10845.
64. Chowdhury, M. S.; Zheng, W.; Kumari, S.; Heyman, J.; Zhang, X.; Dey, P.; Weitz, D. A.; Haag, R., Dendronized fluorosurfactant for highly stable water-in-fluorinated oil emulsions with minimal inter-droplet transfer of small molecules. Nature Communications 2019, 10 (1), 4546.
65. Lim, X., Tainted water: the scientists tracing thousands of fluorinated chemicals in our environment. Nature 2019, 566, 26+.
66. Manoharan Vinothan, N.; Elsesser Mark, T.; Pine David, J., Dense Packing and Symmetry in Small Clusters of Microspheres. Science 2003, 301 (5632), 483-487.
67. Weiss, J.; Herrmann, N.; McClements, D. J., Ostwald Ripening of Hydrocarbon Emulsion Droplets in Surfactant Solutions. Langmuir 1999, 15 (20), 6652-6657.
68. Yang, Y.; Miller, D. J.; Hawthorne, S. B., Toluene Solubility in Water and Organic Partitioning from Gasoline and Diesel Fuel into Water at Elevated Temperatures and Pressures. Journal of Chemical & Engineering Data 1997, 42 (5), 908-913.
69. Tolls, J.; van Dijk, J.; Verbruggen, E. J. M.; Hermens, J. L. M.; Loeprecht, B.; Schüürmann, G., Aqueous Solubility-Molecular Size Relationships: A Mechanistic Case Study Using C10- to C19-Alkanes. The Journal of Physical Chemistry A 2002, 106 (11), 2760-2765.
70. Demond, A. H.; Lindner, A. S., Estimation of interfacial tension between organic liquids and water. Environmental Science & Technology 1993, 27 (12), 2318-2331.
71. Hanifi David, A.; Bronstein Noah, D.; Koscher Brent, A.; Nett, Z.; Swabeck Joseph, K.; Takano, K.; Schwartzberg Adam, M.; Maserati, L.; Vandewal, K.; van de Burgt, Y.; Salleo, A.; Alivisatos, A. P., Redefining near-unity luminescence in quantum dots with photothermal threshold quantum yield. Science 2019, 363 (6432), 1199-1202.
72. Paik, T.; Diroll, B. T.; Kagan, C. R.; Murray, C. B., Binary and Ternary Superlattices Self-Assembled from Colloidal Nanodisks and Nanorods. Journal of the American Chemical Society 2015, 137 (20), 6662-6669.
73. Cherniukh, I.; Rainò, G.; Sekh, T. V.; Zhu, C.; Shynkarenko, Y.; John, R. A.; Kobiyama, E.; Mahrt, R. F.; Stöferle, T.; Erni, R.; Kovalenko, M. V.; Bodnarchuk, M. I., Shape-Directed Co-Assembly of Lead Halide Perovskite Nanocubes with Dielectric Nanodisks into Binary Nanocrystal Superlattices. ACS Nano 2021.
74. Marino, E.; Kodger, T. E.; Wegdam, G. H.; Schall, P., Revealing Driving Forces in Quantum Dot Supercrystal Assembly. 2018, 30 (43), 1803433.
75. Montanarella, F.; Geuchies, J. J.; Dasgupta, T.; Prins, P. T.; van Overbeek, C.; Dattani, R.; Baesjou, P.; Dijkstra, M.; Petukhov, A. V.; van Blaaderen, A.; Vanmaekelbergh, D., Crystallization of Nanocrystals in Spherical Confinement Probed by in Situ X-ray Scattering. Nano Letters 2018, 18 (6), 3675-3681.
76. Wang, J.; Liu, Y.; Cai, Q.; Dong, A.; Yang, D.; Zhao, D., Hierarchically Porous Silica Membrane as Separator for High-Performance Lithium-Ion Batteries. Advanced Materials 2021, n/a (n/a), 2107957.
77. Lu, X.; Li, M.; Peng, Y.; Xi, X.; Li, M.; Chen, Q.; Dong, A., Direct Probing of the Oxygen Evolution Reaction at Single NiFe204 Nanocrystal Superparticles with Tunable Structures. Journal of the American Chemical Society 2021.
78. Chernomordik, B. D.; Marshall, A. R.; Pach, G. F.; Luther, J. M.; Beard, M. C., Quantum Dot Solar Cell Fabrication Protocols. Chemistry of Materials 2017, 29 (1), 189-198.
79. Voznyy, O.; Levina, L.; Fan, J. Z.; Askerka, M.; Jain, A.; Choi, M.-J.; Ouellette, O.; Todorović, P.; Sagar, L. K.; Sargent, E. H., Machine Learning Accelerates Discovery of Optimal Colloidal Quantum Dot Synthesis. ACS Nano 2019, 13 (10), 11122-11128.
80. Kovalenko, M. V.; Schaller, R. D.; Jarzab, D.; Loi, M. A.; Talapin, D. V., Inorganically Functionalized PbS—CdS Colloidal Nanocrystals: Integration into Amorphous Chalcogenide Glass and Luminescent Properties. Journal of the American Chemical Society 2012, 134 (5), 2457-2460.
81. Jasieniak, J.; Smith, L.; van Embden, J.; Mulvaney, P.; Califano, M., Re-examination of the Size-Dependent Absorption Properties of CdSe Quantum Dots. The Journal of Physical Chemistry C 2009, 113 (45), 19468-19474.
82. Moreels, I.; Lambert, K.; Smeets, D.; De Muynck, D.; Nollet, T.; Martins, J. C.; Vanhaecke, F.; Vantomme, A.; Delerue, C.; Allan, G.; Hens, Z., Size-Dependent Optical Properties of Colloidal PbS Quantum Dots. ACS Nano 2009, 3 (10), 3023-3030.
83. Lignos, I.; Stavrakis, S.; Nedelcu, G.; Protesescu, L.; deMello, A. J.; Kovalenko, M. V., Synthesis of Cesium Lead Halide Perovskite Nanocrystals in a Droplet-Based Microfluidic Platform: Fast Parametric Space Mapping. Nano Letters 2016, 16 (3), 1869-1877.
84. Guerrero, J.; Chang, Y.-W.; Fragkopoulos, A. A.; Fernandez-Nieves, A., Capillary-Based Microfluidics—Coflow, Flow-Focusing, Electro-Coflow, Drops, Jets, and Instabilities. Small 2020, 16 (9), 1904344.
85. Lignos, I.; Stavrakis, S.; Nedelcu, G.; Protesescu, L.; deMello, A. J.; Kovalenko, M. V., Synthesis of Cesium Lead Halide Perovskite Nanocrystals in a Droplet-Based Microfluidic Platform: Fast Parametric Space Mapping. Nano Letters 2016, 16 (3), 1869-1877.
86. Chernomordik, B. D.; Marshall, A. R.; Pach, G. F.; Luther, J. M.; Beard, M. C., Quantum Dot Solar Cell Fabrication Protocols. Chemistry of Materials 2017, 29 (1), 189-198.
87. Hanifi David, A.; Bronstein Noah, D.; Koscher Brent, A.; Nett, Z.; Swabeck Joseph, K.; Takano, K.; Schwartzberg Adam, M.; Maserati, L.; Vandewal, K.; van de Burgt, Y.; Salleo, A.; Alivisatos, A. P., Redefining near-unity luminescence in quantum dots with photothermal threshold quantum yield. Science 2019, 363 (6432), 1199-1202.
88. Carbone, L.; Nobile, C.; De Giorgi, M.; Sala, F. D.; Morello, G.; Pompa, P.; Hytch, M.; Snoeck, E.; Fiore, A.; Franchini, I. R.; Nadasan, M.; Silvestre, A. F.; Chiodo, L.; Kudera, S.; Cingolani, R.; Krahne, R.; Manna, L., Synthesis and Micrometer-Scale Assembly of Colloidal CdSe/CdS Nanorods Prepared by a Seeded Growth Approach. Nano Letters 2007, 7 (10), 2942-2950.
89. Drijvers, E.; De Roo, J.; Geiregat, P.; Fehér, K.; Hens, Z.; Aubert, T., Revisited Wurtzite CdSe Synthesis: A Gateway for the Versatile Flash Synthesis of Multishell Quantum Dots and Rods. Chemistry of Materials 2016, 28 (20), 7311-7323.
90. Jasieniak, J.; Smith, L.; van Embden, J.; Mulvaney, P.; Califano, M., Re-examination of the Size-Dependent Absorption Properties of CdSe Quantum Dots. The Journal of Physical Chemistry (2009, 113 (45), 19468-19474.
91. Voznyy, O.; Levina, L.; Fan, J. Z.; Askerka, M.; Jain, A.; Choi, M.-J.; Ouellette, O.; Todorović, P.; Sagar, L. K.; Sargent, E. H., Machine Learning Accelerates Discovery of Optimal Colloidal Quantum Dot Synthesis. ACS Nano 2019, 13 (10), 11122-11128.
92. Moreels, I.; Lambert, K.; Smeets, D.; De Muynck, D.; Nollet, T.; Martins, J. C.; Vanhaecke, F.; Vantomme, A.; Delerue, C.; Allan, G.; Hens, Z., Size-Dependent Optical Properties of Colloidal PbS Quantum Dots. ACS Nano 2009, 3 (10), 3023-3030.
93. Kovalenko, M. V.; Schaller, R. D.; Jarzab, D.; Loi, M. A.; Talapin, D. V., Inorganically Functionalized PbS—CdS Colloidal Nanocrystals: Integration into Amorphous Chalcogenide Glass and Luminescent Properties. Journal of the American Chemical Society 2012, 134 (5), 2457-2460.
94. Bressler, I.; Kohlbrecher, J.; Thunemann, A. F., SASfit: a tool for small-angle scattering data analysis using a library of analytical expressions. Journal of Applied Crystallography 2015, 48 (5), 1587-1598.

### Porous Superparticles

Porous superstructures have attracted the growing interest of the scientific community. A porous material is characterized by a large surface area and extended molecular transport, qualities that benefit catalytic, electrochemical, sensing, and cargo-delivery applications. So far, the use of multi-functional nanocrystals as building blocks for porous superstructures has been overlooked in the literature. Although few existing methods allow the generation of porous superstructures from nanocrystals, either the use of these routes is limited to single-component nanocrystal dispersions, or the resulting product is not well controlled in terms of size, shape, and porosity of the superstructure. In this disclosure, we provide a pathway to generate porous superparticles (which can be magneto-fluorescent nanocrystals in nature) that are well controlled in size and shape. We synthesize these composite superparticles by confining semiconductor and superparamagnetic nanocrystals to oil-in-water droplets generated using microfluidics. The rapid densification of these droplets yields spherical, monodisperse, and porous superparticles of nanocrystals. Molecular dynamics simulations reveal that the formation of pores throughout the superparticles is linked to the colloidal repulsion between nanocrystals of different compositions, leading to nanocrystal phase separation during self-assembly. We confirm the presence of nanocrystal phase separation at the single superparticle level by analyzing the change in optical and photonic properties of the superstructures as a function of nanocrystal composition. This excellent agreement between experiment and simulations allows us to develop a theory that predicts superparticle porosity from experimentally tunable physical parameters such as nanocrystal size ratio, stoichiometry, and droplet densification rate.

Here, we expand upon a recently developed emulsion-based strategy to generate in a single step porous, multicomponent, monodisperse superparticles from self-assembled NCs. We confine a dispersion comprising two distinct NC types—Fe₃O₄ and CdSe/CdS—within the same droplet to drive their co-assembly upon emulsion densification. It should be understood, however, that other nanoparticles can be used; the Fe₃O₄ and CdSe/CdS NCs used in these illustrative embodiments are exemplary only and do not limit the scope of the present disclosure.

The formation of multicomponent superparticles is accompanied by the emergence of structural voids previously unobserved in such emulsion-based approaches. These microscale voids bridge the length scales of NCs (˜10 nm) and superparticles (˜10 μm), and represent an interesting feature to engineer the hierarchical properties of these artificial solids towards cargo delivery and catalytic applications. We exploit a combination of theory and simulation to elucidate the thermodynamic mechanism driving the formation of these porous morphologies, obtaining excellent agreements with experiment. Our results reveal a novel approach to program porosity and hierarchical ordering into superparticles in a controlled fashion, highlighting the versatility of emulsion templating in generating multicomponent assemblies.

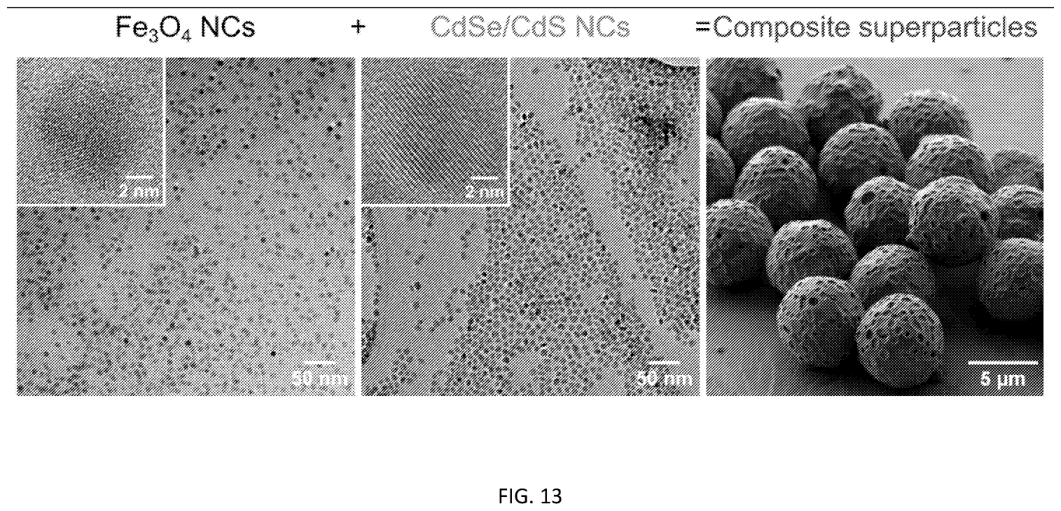

We synthesize Fe₃O₄ core and CdSe/CdS core/shell NCs stabilized by oleate ligands. The transmission electron micrographs of the NCs dispersed on a carbon substrate are shown in the left and center panels of FIG. 13, respectively. The Fe₃O₄ NCs appear spherical, with a diameter of 9.2 nm±10% as extracted through image analysis. Instead, the CdSe/CdS NCs appear more faceted, likely because of the slow, epitaxial growth of the CdS shell on the CdSe core. The Feret diameter, a generalization of the concept of diameter for non-spherical shapes, amounts to 13.1 nm±22%, although this apparent larger polydispersity is likely due to the different orientations of the faceted NCs in respect to the electron beam.

We combine these two types of NCs into superparticles by using the recently-developed source-sink emulsion templated assembly. Specifically, we use droplet microfluidics to prepare a monodisperse emulsion of toluene-in-water, or source emulsion, containing the binary dispersion of NCs at a total volume fraction of 0.01% and with a stochiometric ratio of the two NC types of 1:1, or ϕ_{CdSe/CdS}=0.5. The source emulsion is then mixed with a 55 nm hexadecane-in-water emulsion, or sink emulsion, that is prepared separately by extended tip sonication. The difference in aqueous solubility and internal pressure between source and sink droplets causes the spontaneous, unidirectional mass transfer of toluene from the source to the sink emulsion. This results in the densification of the monodisperse source droplets to yield monodisperse NC superparticles with a diameter of 6.6 μm±4%, as shown in the scanning electron micrographs in the right panel of FIG. 13.

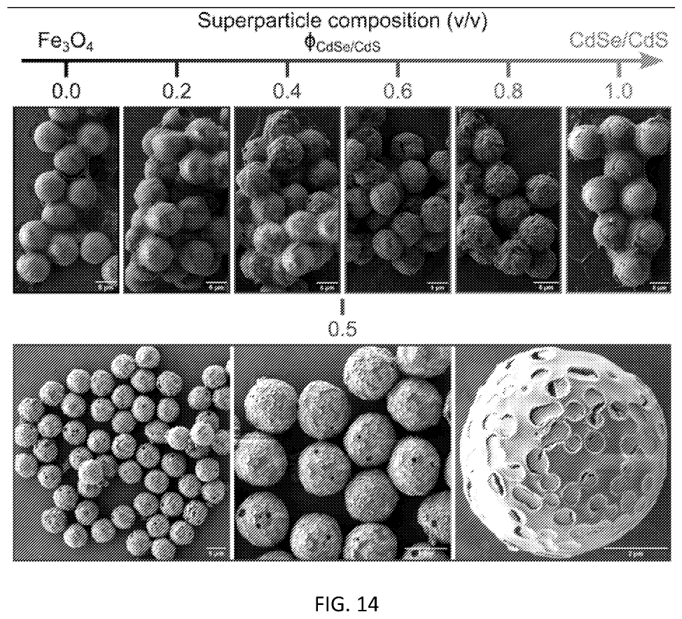

The NC superparticles show interesting surface depressions with circular cross-sections, on average 0.48 μm in radius. Some of these features seem to have merged to form elongated shapes, while others are larger and lead to an empty volume within the superparticle. We explore the appearance of these surface characteristics by preparing NC superparticles with different compositions ranging from ϕ_{CdSe/CdS}=0, indicating superparticles containing solely Fe₃O₄ NCs, to ϕ_{CdSe/CdS}=1, or superparticles containing exclusively CdSe/CdS NCs. The results are shown in the top panel of FIG. 14. Superparticles comprising a single NC species, ϕ_{CdSe/CdS}=0 or 1, resemble homogeneous spheres with smooth surfaces and minimal surface features. However, upon the incorporation of a secondary NC species, 0.2≤ϕ_{CdSe/CdS}≤0.8, the surface of the superparticles begins to deviate from smooth to show depressions, voids, and asperities. These features become most visible at ϕ_{CdSe/CdS}=0.5, as shown in the bottom panel of FIG. 14. A closer inspection of the scanning electron micrographs reveals cracks in the superparticle structure that are visible through the surface depressions, suggesting the presence of voids below the surface.

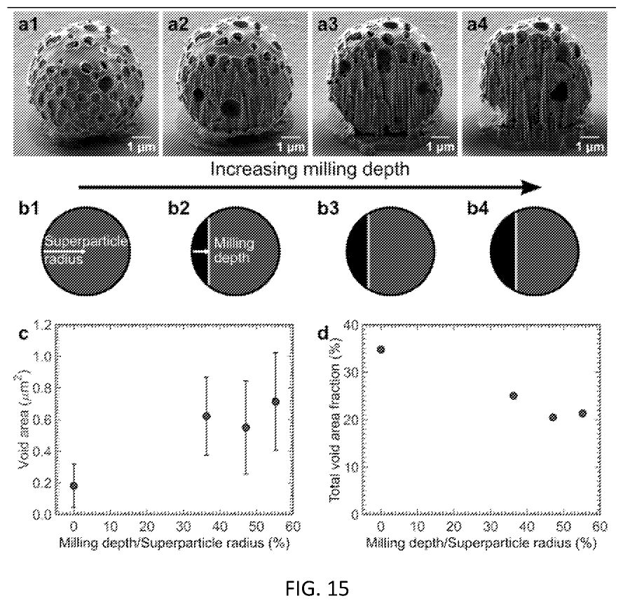

We investigate this hypothesis by milling a single NC superparticle with ϕ_{CdSe/CdS}=0.5 using a focused-ion beam. The results are shown in FIG. 15. Scanning electron micrographs taken after milling at different depths reveal the presence of spherical voids distributed throughout the volume of the spherical superparticle, see FIGS. 15a1-a4 and 15b1-b4 for images and schematics, respectively. Analyzing these images allows us to quantify the size of the voids as well as their distribution within the superparticle. The area of the voids as projected on the milling plane is shown as a function of milling depth in FIG. 15c. The area of the voids increases with milling depth by almost 4-fold from 0.18 μm² at the surface of the superparticle to 0.71 μm² at 55% of the superparticle radius, corresponding to a 2-fold increase in void radius from 0.24 μm to 0.48 μm. While the size of the individual voids increases with milling depth, the total void area fraction decreases from 35% to 21% when moving away from the surface of the superparticle. Without being bound to any particular theory, these measurements indicate the formation of larger yet less numerous voids when further away from the surface of the superparticle.

We implement a lattice Monte Carlo (MC) simulation to gain a deeper understanding of the driving forces governing the formation of voids inside the superparticles. Here, we extend a lattice MC simulation protocol to capture the source-sink emulsion templated assembly. Each system is initialized as a random dispersion of NC sites confined inside a spherical region that represents the densifying droplet. Our MC simulation implements different move types. To equilibrate the system, we first perform only translation and rotation moves for NC and solvent particles under athermal conditions for 1E6 MC steps. Afterwards, we turn on all relevant interactions between NCs and solvent particle and perform all MC move types for 1E7 MC steps.

Our simulation captures the unit cells of clusters of NCs as these grow and merge while the emulsion densifies, ultimately driving the formation of the superparticles. To compute the relevant interaction energies, we assume that each lattice site containing a NC represents a unit cell of the self-assembled structure that is known for the experimental system of interest. This assumption builds on the numerous studies highlighting the propensity of NCs to self-assemble into crystalline morphologies when using the emulsion template. The interaction energies between NCs are then extracted as the per-unit cell lattice energy of formation computed using previously developed thermodynamic perturbation theory (TPT).

We implement two types of cluster moves: 1) reorganization of NCs within a cluster and 2) translation of a NC cluster as a whole. Evaporation moves are performed such that the solvent particle closest to the receding spherical wall is converted from a “solvent” type to a “wall” type. The converted site cannot be occupied by another NC or solvent particle. All MC moves are accepted/rejected using the standard Metropolis algorithm. For rapid detection of clusters formation/break-up, we employ the freud analysis package

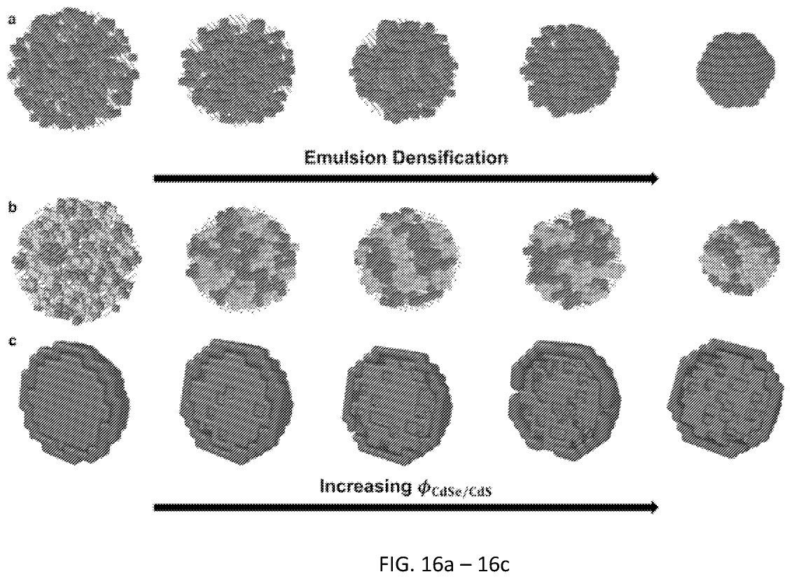

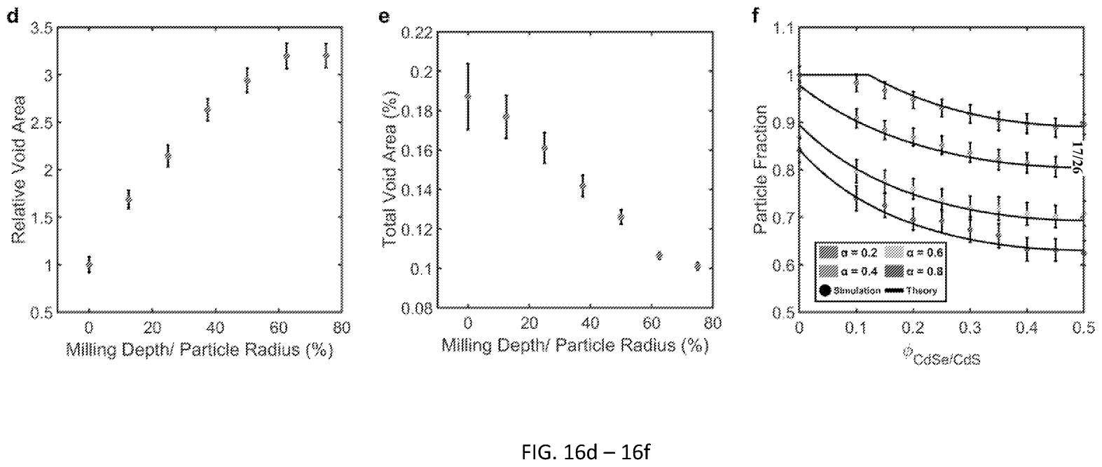

The results of our simulations for unary, ϕ_{CdSe/CdS}=0 or 1, and binary, ϕ_{CdSe/CdS}=0.5, dispersions of NCs as a function of emulsion densification are shown in FIG. 16a-b respectively. The simulations show that NCs with different compositions have a strong tendency to phase separate during assembly, FIG. 16b. A visual inspection of the cross section of the fully formed superparticles reveals the emergence of voids with increasing ϕ_{CdSe/CdS} values, as shown in FIG. 16c. This observation is in qualitative agreement with experimental observations shown in FIGS. 13-15. To obtain more quantitative comparisons with experiments, we perform a measurement the void area as a function of distance from the superparticle surface. We measure a ˜3-fold increase of the void area going from the surface to the center of the superparticle, FIG. 16d. Additionally, the void area fraction shows a 1.8-fold decrease in total void area when moving from the surface to the center of the superparticle, FIG. 16e. Both measurements are in excellent agreement with the experimental observations shown in FIG. 15.

The ability of our simulation protocol to reproduce the experimental results points to a good understanding of the relevant NC interactions driving void formation. Here, we leverage the insights provided by simulation to develop an analytical theory that takes as inputs experimental handles such as the NC stoichiometric ratio ϕ_{CdSe/CdS}, NC size ratio R, and emulsion densification rate α. One can posit that there are four major interactions contributing to the observed void formation: 1) lattice formation energy from NC crystallization, 2) repulsion between different NC types, 3) confinement energy from the evaporating emulsion, and 4) surface tension cost of NC contacts with the emulsion boundary and solvent. We aim to capture the following physical picture: Growing crystalline NC clusters are pushed together by the decrease in volume due to emulsion densification. NC clusters with the same composition can reorganize and merge, whereas those with different composition disfavor merging and attempt to phase separate. In the dilute limit, clusters can move past each other without interacting. However, at higher densities NC clusters are larger and less mobile, hindering rearrangement. The presence of repulsive clusters of two different types further undermines reorganization and drives void formation through phase separation.

We balance this interplay between attractive and repulsive interactions along with the surface tension cost of NCs in contact with the solvent and the driving force from the shrinking emulsion to predict the void fraction in the assembled system. We obtain the following quadratic equation:

$$0 ∼ {ϕ}_{V}^{2} [ {D}_{1} - ( 5 / 9 ) {D}_{2} ] + {ϕ}_{V} [ - 2 {D}_{1} + ( 5 / 3 ) {D}_{2} ] + [ {D}_{1} - {D}_{2} + Δ {G}_{solvent} ] \qquad ( 1 )$$

where D₁=X₁−ΔGₛₒₗᵥₑₙₜ and D₂=⅔n_{P}^{-1/3}X₂(αC+γ) and X₁ and X₂ are defined as:

$${χ}_{1} = Δ {G}_{c r y s} [ {ϕ}_{C d S e / C d S}^{2} + {( 1 - {ϕ}_{C d S e / C d S} )}^{2} ] - Δ {G}_{r e p} {ϕ}_{C d S e / C d S} ( 1 - {ϕ}_{C d S e / C d S} ) + Δ {G}_{N C} \qquad ( 2 )$$

$${χ}_{2} = {{σ}_{B}^{2} [ ( 1 - {ϕ}_{C d S e / C d S} + {ϕ}_{C d S e / C d S}^{2} ) ( x {R}^{3} + y ) ]}^{2 / 3}$$

Each ΔG term is computed using TPT, where ΔG_{crys} is the free energy of unit cell formation for a given lattice, ΔG_{NC} is the energy computed from Boltzmann weighted averaging of amorphous NC clusters, ΔGᵣₑₚ is the energy difference between a unit cell with heterogeneous versus homogeneous NC compositions, and ΔGₛₒₗᵥₑₙₜ is the Boltzmann weighted average energy of solvent clusters. Equation 1 can be easily solved using the quadratic formula and provides excellent agreement when compared to results measured from simulation (FIG. 16f). These results predict that higher emulsion densification rates should lead to more porous superparticles. This might explain why previous synthetic procedures based on densification rates lower than those afforded by the source-sink emulsion approach did not produce porous superparticles even when using a very similar combination of NC species.

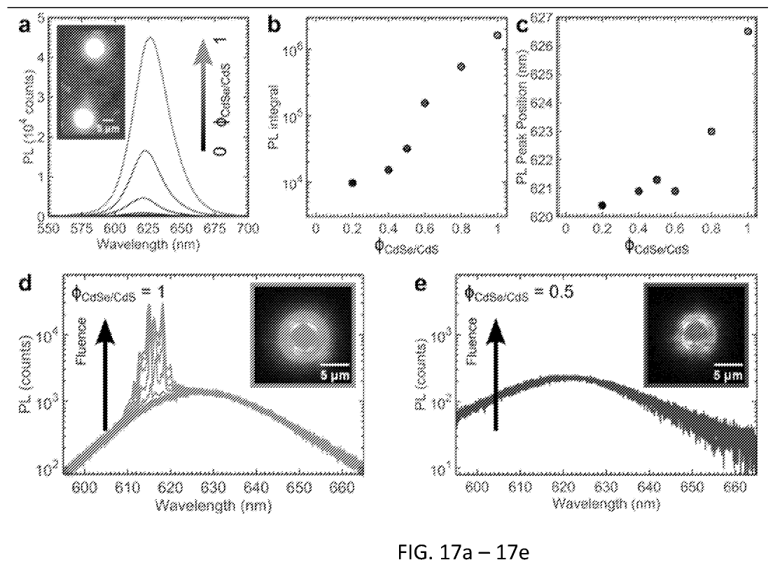

Mixing Fe₃O₄ and CdSe/CdS NCs has important effects on the physical properties of the resulting superparticles. FIG. 17a shows the photoluminescence (PL) spectra of individual magneto-fluorescent superparticles of different compositions, 0≤ϕ_{CdSe/CdS}≤1, when excited with 420 nm light. The PL peak centered around 625 nm is due to the emission from CdSe/CdS NCs, while the Fe₃O₄ are non-emissive. As the fraction of CdSe/CdS that composes a superparticles increases from ϕ_{CdSe/CdS}=0.2 to 1, the integral of the PL spectra increases by more than 2 orders of magnitude, as shown in FIG. 17b. Additionally, the PL peak undergoes a ˜6 nm red-shift with ϕ_{CdSe/CdS} from 620.4 to nm 626.5 nm, FIG. 17c. Both the PL integral and the shift in PL peak change non-linearly with ϕ_{CdSe/CdS} and show the greatest increase for ϕ_{CdSe/CdS}>0.5.

We investigate the role of the two NC species on the photonic properties of the composite superparticles. Spherical NC superparticles can trap light near their surface through photonic whispering-gallery modes. Under these conditions, the superparticle acts as a resonant cavity, and the trapped photons can induce lasing action for sufficiently high excitation fluences that overcome the optical losses of the cavity. When ϕ_{CdSe/CdS}=1, increasing the fluence of a 488 nm pulsed laser source results in multi-mode lasing assisted by the tightly-spaced whispering-gallery modes, as shown in FIG. 17d. However, as shown in FIG. 17e, exciting a single superparticle with ϕ_{CdSe/CdS}=0.5 does not result in lasing, indicating higher optical losses of the cavity. Additionally, the PL spectrum does not increase in intensity with excitation fluence, indicating optical saturation. These observations suggest that the Fe₃O₄ NCs are responsible for the increased optical losses of the cavity, quenching the excited charge carriers in CdSe/CdS NCs, therefore preventing population inversion and competing with radiative recombination. The non-linear change in PL integral with superparticle composition shown in FIG. 17b is a strong indication of the onset of phase separation of the two NC species at intermediate compositions. The non-linear change in the position of the PL peak further corroborates this hypothesis, as this quantity is sensitive to the local dielectric environment of the emitting NCs.

We show a direct pathway leading to the synthesis of porous magneto-fluorescent superparticles by exploiting the repulsive colloidal interactions between NCs with different compositions, namely super-paramagnetic Fe₃O₄ and semiconductor CdSe/CdS NCs. The confinement of colloidal NCs to toluene droplets undergoing rapid densification through the source-sink emulsion approach leads to monodisperse, spherical superparticles.

While superparticles consisting of a single NC species show smooth surfaces, superparticles with intermediate compositions show the presence of circular depressions. These circular depressions are not limited to the surface of the superparticles but extend to their inner volume as spherical voids.

Molecular dynamics simulations show that the repulsion between NCs with different compositions drives the formation of these voids as a result of NC phase separation. The characteristics, occurrence, and spatial distribution of these voids in simulations matches well the experimental results, confirming that using a composition characterized by equal volumes of the two NC species maximizes the porosity of the superparticle. Analyzing the significant composition-dependent changes in the optical and photonic properties of the superparticles, namely the occurrence or inhibition of the lasing action and PL saturation, provides an independent method to confirm that the phase separation between emissive CdSe/CdS and non-emissive Fe₃O₄ NCs takes place at intermediate compositions. Based on this match between experiments and simulations, we develop a theory that predicts the porosity of the final superparticles from the initial physical parameters controlled in experiment such as the NC stoichiometry, size ratio, and the rate of densification of the emulsion droplets. These results provide a clear roadmap to design confined, high surface area, porous, multifunctional superparticles. These superparticles can be used in catalytic or delivery applications, where the stimuli responsive NCs can be used as a trigger to release cargo at will. Cargo can be present within the superparticle (e.g, within a void of the superparticle), and the superparticle can be disrupted by contact with a hydrophobic solvent, e.g., when the superparticle is present at a location where cargo delivery is desired.

### Whispering-Gallery Microresonators

Whispering-gallery microresonators can be used as building blocks for optical circuits. However, encoding information in an optical signal requires on-demand tuning of optical resonances. Tuning is achieved by modifying the cavity length or the refractive index of the microresonator. Due to their solid, non-deformable structure, conventional microresonators based on bulk materials are inherently difficult to tune. In this work, we fabricate irreversibly tunable optical microresonators by using semiconductor nanocrystals. These nanocrystals are first assembled into colloidal spherical superparticles featuring whispering-gallery modes. Exposing the superparticles to shorter ligands changes the nanocrystal surface chemistry, decreasing the cavity length of the microresonator by 20% and increasing the refractive index by 8.2%. Illuminating the superparticles with ultraviolet light initiates nanocrystal photo-oxidation, providing an orthogonal channel to decrease the refractive index of the microresonator in a continuous fashion. Through these approaches, we demonstrate optical microresonators tunable by several times their free spectral range.

Controlling optical signals can lead to superior computation speeds in future computer systems. To function, these systems require devices able to manage information flowing at the speed of light. Optical microresonators are good candidates for this task, having demonstrated their function as filters, amplifiers, buffers, switches, and modulators for light. Whispering-gallery microresonators achieve these functions by trapping light through total internal reflection near the surface of a symmetric dielectric structure. A glass microsphere can confine light very efficiently, with quality factors approaching 10¹⁰ for resonant wavelengths. More complex morphologies of whispering-gallery microresonators, such as microdiscs and microtoroids, have been fabricated using microfabrication techniques, providing design options suitable for integration on optical circuits.

While microfabrication techniques allow precise morphological design, they are conceived for well-established bulk materials. The resulting optical microresonators are non-deformable, leading to optical resonances that are difficult to tune on-demand. Tuning the positions of the optical resonances is desirable, allowing information to be encoded in an optical signal. However, the positions of the optical resonances depend on physical parameters that cannot be easily changed post-fabrication, such as the cavity length and refractive index of the microresonator. Tuning the cavity length represents a major challenge that prompted the introduction of softer, more deformable materials. Meanwhile, various strategies have proven successful in tuning the refractive index. The refractive index of a microresonator can be thermally modulated by exploiting the thermo-optic coefficient of the constituent material through thermal conduction or Joule heating. More creative approaches have also been put forward, such as coating or doping the microresonator with a photoswitchable molecule to achieve reversible optical tuning. An effective approach for optical tuning yields a spectral shift comparable to the distance between two consecutive resonances, a quantity known as the free spectral range of the resonator.

The use of nanomaterials can enhance the optical tunability of microresonators. In the last 30 years, scientists have assembled a vast library of nanomaterials with properties tunable by size, shape, and composition. Using nanomaterials as building blocks for optical microresonators would considerably expand the design space for integrated optical circuits while benefiting from low-temperature solution processability. For instance, microring resonators fabricated using semiconductor nanocrystals (NCs) allow active color control of lasing modes across the visible range. Coupling NCs to microstructures also benefits sensing: silica microspheres coated with plasmonic NCs function as strain and pH sensors, with an optical response tunable by varying NC composition.³⁴

Recently, the observation that NCs can spontaneously assemble to form photonic structures has encouraged their use as building blocks for photonics. When confined to the spherical templates of densifying emulsion droplets, NCs assemble to form colloidal microspheres, known as superparticles, supraparticles, or supercrystals, which include densely-packed NCs. When comprising dielectric NCs, these superparticles act as optical microresonators, trapping light near the surface through Mie and whispering-gallery modes (WGMs).

Here, we exploit the flexible surface chemistry of NCs to demonstrate superparticles with sharp photonic resonances that are tunable through chemical and optical triggers. We fabricate monodisperse, spherical NC superparticles by using a recently-developed technique that relies on a source-sink emulsion system. These superparticles feature sharp WGM resonances, which provide the opportunity to extract the refractive index of individual superparticles. By combining spectroscopic measurements of individual superparticles with electron microscopy studies, we show that adjusting the length of the surface ligands for the NCs represents a reliable strategy to tailor the cavity length and refractive index of the microresonator. Additionally, exposing the superparticles to ultraviolet excitation triggers NC photo-oxidation and decreases the refractive index, providing an orthogonal channel to engineer the optical properties of these self-assembled optical microresonators. Taken together, these two approaches allow for both step-wise and continuous irreversible tuning of the optical resonances by up to ˜10 times the free spectral range of the resonator.

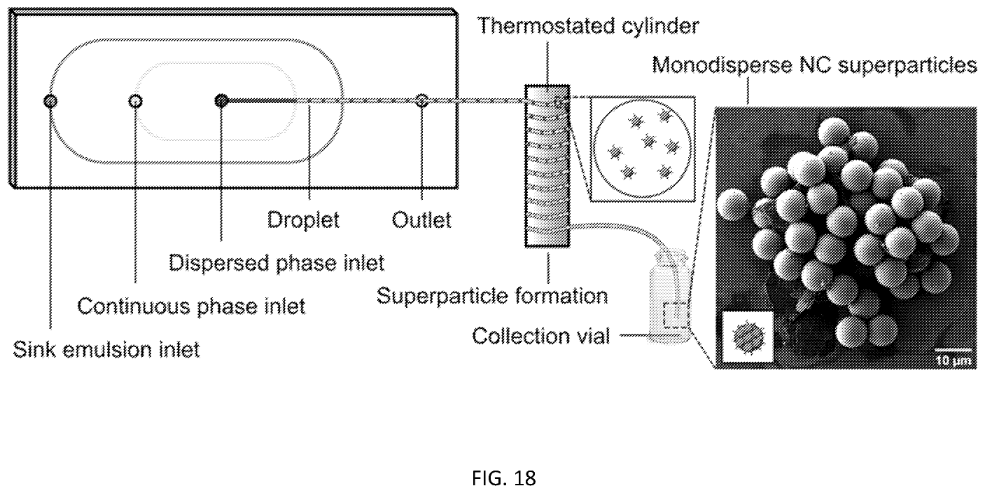

We assemble oleate-capped CdSe NCs, 5.7 nm in diameter, into monodisperse superparticles using a recently-developed source-sink emulsion approach described in FIG. 18. The source emulsion is prepared using a microfluidic cross-junction and consists of monodisperse 120 μm toluene-in-water droplets containing 0.01% v/v of NCs. This source emulsion is then placed in contact with the sink emulsion, consisting of 55 nm hexadecane-in-water droplets. Mixing the two emulsions results in the transfer of toluene from the source to the sink emulsion, with a transfer rate controlled by the temperature of the mixture.⁴⁷ The complete removal of toluene from the source emulsion takes place within a few minutes, leading to the formation of spherical, monodisperse NC superparticles with a diameter of D=8.6 μm±2%.

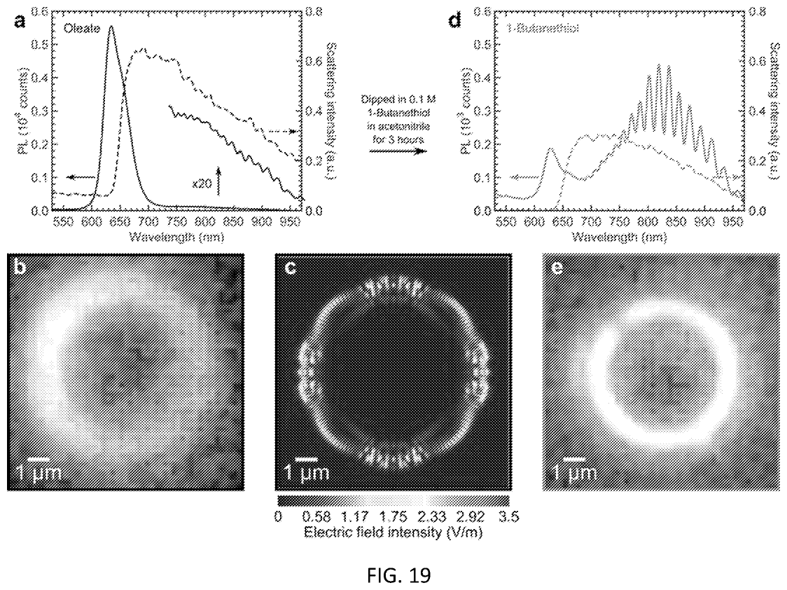

We investigate the interaction of light with a single superparticle in FIG. 19a, showing an optical micrograph of the same superparticle in FIG. 19b. After photoexcitation with 420 nm light, the photoluminescence (PL) spectrum of the superparticle, indicated by a solid line, reveals a brighter peak centered at 634 nm and a 40-fold dimmer peak around 800 nm. The brighter peak originates from the band-edge emission of constituent CdSe NCs, with a spectral asymmetry that results from energy transfer or photon recycling from smaller to larger NCs within the ensemble. The dimmer peak is attributed to emission from the surface of the NCs, a common characteristic of unshelled CdSe NCs. A careful inspection of the spectrum reveals that finer features modulate the surface-emission. These features are also present in the scattering spectrum of the same superparticle, indicated by a dashed line in FIG. 19a. Finite-difference time-domain (FDTD) simulations in FIG. 19c show the confinement of the electric field intensity near the surface of the superparticle. We conclude that the finer features observed in PL and scattering spectra indicate the presence of photonic resonances within the superparticle that lead to an increase in intensity at resonant wavelengths. In particular, these resonances are consistent with WGMs of the spherical superparticle.

WGMs are a family of photonic modes that describe the trapping of light near the surface of a dielectric structure with at least one axis of symmetry. Such a structure behaves as a resonant cavity and can be characterized in terms of optical parameters like the effective refractive index of the cavity, n_{eff}, the quality factor, Q, describing the efficiency of light trapping, and the free spectral range, FSR, the distance between two consecutive resonances. For these superparticles of oleate-capped CdSe NCs, we measure Q=λ/Δλ=109 and FSR=15.7 nm at λ=841.2 nm, where λ is the resonant wavelength, and Δλ is the full-width at half-maximum of the resonance.

Since the density of optical modes depends on the square of the effective refractive index of the cavity, increasing nep should prove beneficial to light trapping.⁵⁵ For a superparticle, the value of n_{eff} can be approximated as the volumetric average of organic and inorganic components, respectively identified by the ligands and core of the NCs:

$${n}_{e f f} = {ϕ}_{ligand} {n}_{ligand} + {ϕ}_{core} {n}_{core ,} \qquad ( Equation l )$$

where 0<ϕ<1 indicates the volume fraction with ϕ_{ligand}+ϕ_{core}=1, and ligand and n_{core} are the refractive indices of the ligand and core of the NCs, respectively. Usually, n_{ligand}<n_{core}, therefore, decreasing the organic content of the superparticle should increase n_{eff}.

We implement this strategy by exposing the superparticle to a solution of 1-butanethiol, a more compact ligand than the native oleate. The ligand-exchange has a dramatic effect on the optical properties of the superparticle, as shown in FIG. 19d. The spectrum reveals quenching of the band-edge PL and enhancement of the surface emission, consistent with the generation of traps on the surface of CdSe NCs by the binding of thiols. The wavelength of the band-edge PL blue-shifts by 4.3 nm after ligand-exchange, suggesting oxidation of the surface of the NCs, effectively decreasing the size of the CdSe core by an estimated 0.2 nm. WGM resonances, more intense than before ligand-exchange, modulate the surface emission. After ligand-exchange, we measure the quality factor and the free spectral range of the cavity to be Q=100 and FSR=17.7 nm at λ=838.4 nm. As the value of the free spectral range is inversely proportional to the cavity length, πD, an increase in FSR suggests a decrease in the diameter of the microresonator. A direct comparison of the optical micrographs of the superparticle before and after ligand-exchange confirms this decrease in size, as shown in FIG. 19b,e. However, the concomitant decrease in Q after ligand-exchange hints at the deterioration of the surface of the microresonator.

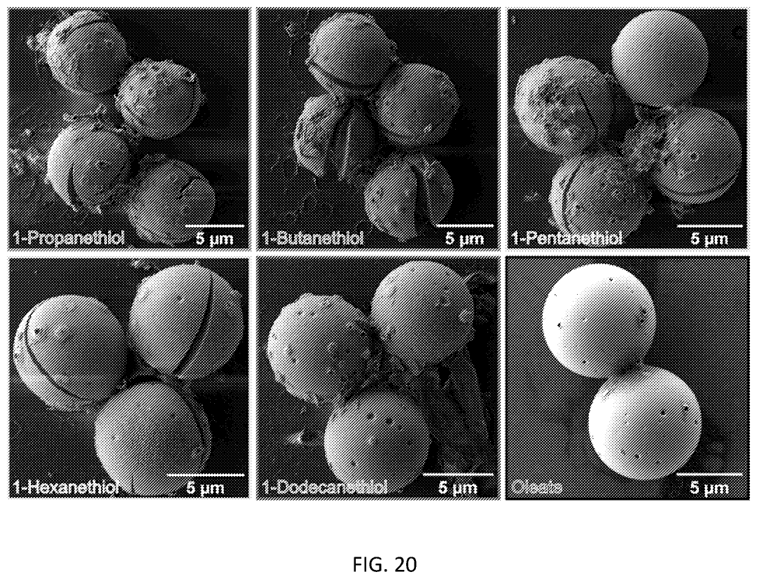

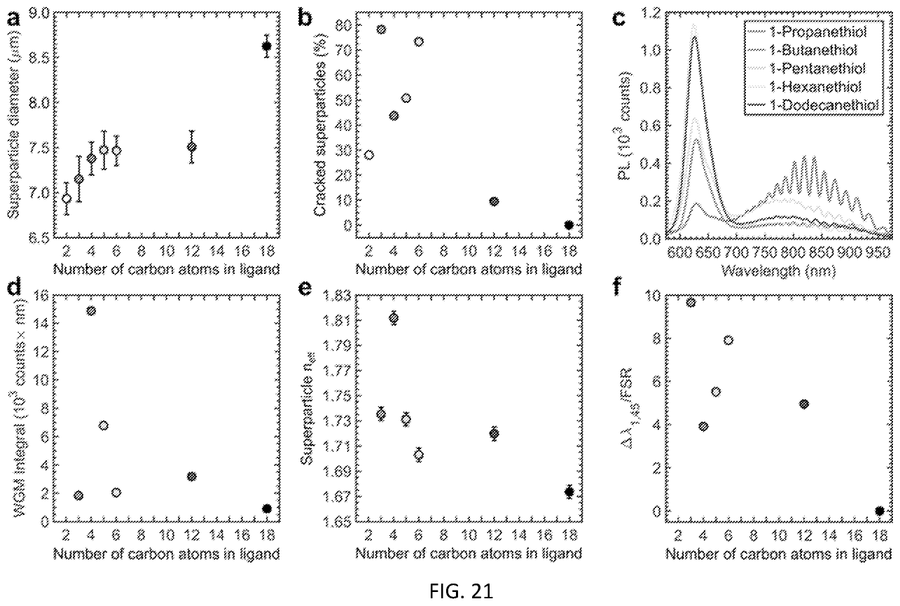

Imaging the microresonators by scanning electron microscopy (SEM) confirms these hypotheses, revealing that ligand-exchange causes the NC superparticles not only to shrink, but also to crack as shown in FIG. 20. The superparticles show a single, pronounced crack that splits the spherical structure in two roughly symmetric halves. Likely, the superparticles crack to release the stress accumulated in the shrinking 3D structure. This process appears general, as demonstrated by using alkanethiol ligands with different aliphatic chain lengths. Image analysis reveals that the length of the aliphatic chain is crucial in determining the final morphology of the superparticles, as shown in FIG. 21a. The average diameter of the superparticles decreases monotonically with decreasing number of carbon atoms composing the aliphatic chain of the ligand, from D=8.6 μm for 18 carbon atoms to D=6.9 μm for 2 carbon atoms, leading to a 20% decrease in superparticle diameter and a 50% decrease in superparticle volume. This decrease in volume correlates with the increased occurrence of cracked superparticles, reaching 80% when using 1-propanethiol, as shown in FIG. 21b. These morphological changes are consistent with the displacement of the native oleates by shorter ligands, therefore decreasing the fraction of volume occupied by organic ligands according to Equation 1. Decreasing the concentration of the ligand solution, increasing the duration of the exchange, and performing multiple exchanges may help limit the formation of cracks.⁶²

The morphological changes induced by ligand-exchange directly affect the optical properties of the superparticles. As shown in FIG. 21c, performing the ligand-exchange with shorter ligands is more effective in quenching the band-edge PL. Additionally, superparticles that have been ligand-exchanged with shorter ligands show more intense WGM resonances, with a maximum 15-fold increase when using 1-butanethiol, as shown in FIG. 21d.

We combine the results of SEM imaging and single superparticle spectroscopy to extract the value of n_{eff} for single NC superparticles. When considering a spherical optical resonator characterized by a diameter D and refractive index n_{eff}, the expected spectral positions of the WGM resonances with mode numbers n and/are well-approximated by:^{53, 63, 64}

$${λ}_{n , 1}^{t heory} = {πDn}_{e f f} [ v + \frac{{α}_{n}}{{2}^{1 / 3}} {v}^{1 / 3} - \frac{P}{\sqrt{{N}^{2} - 1}} + \frac{3}{10} \frac{{α}_{n}^{2}}{{2}^{2 / 3}} {v}^{- 1 / 3} - { \frac{P ( {N}^{2} - 2 {P}^{2} / 3 )}{{( {N}^{2} - 1 )}^{3 / 2}} \frac{{α}_{n}}{{2}^{1 / 3}} {v}^{- 2 / 3} ]}^{- 1} , \qquad ( Equation 2 )$$

where v+l+½, αₙ is the n-th root of the Airy function, N=n_{eff}/nₑₙᵥ is the ratio between the refractive indices of the resonator and the environment, and P=1/N for transverse magnetic (TM) or P=N for transverse electric (TE) mode polarization. By using SEM images to obtain values for D, and analyzing the results of single superparticle PL studies to obtain the observed values for λ_{n,1}^{experiment}, we estimate the value of n_{eff} for a single superparticle by minimizing the sum of the squares of the residuals, Σ_{n,1}[λ_{n,1}^{experiment}−λ_{n,1}^{theory}(n_{eff})]². The results are shown in FIG. 21e. Displacing the native oleate ligands with shorter alkanethiols leads to a systematic increase of n_{eff} for a single NC superparticle. Interestingly, the maximum value of n_{eff} corresponds to the NC superparticles exchanged with 1-butanethiol, which is not the shortest ligand in the series. This observation suggests the occurrence of a more complete ligand-exchange when using a ligand with intermediate chain length, leading to a larger increase in n_{eff}. While more compact ligands benefit from faster diffusion, shorter aliphatic chains make the ligand overall less hydrophobic, decreasing the affinity of the ligand for the hydrophobic superparticles and the efficiency of ligand-exchange. We note that since these values for n_{eff} are derived from the analysis of photonic resonances confined near the surface of the superparticles, they describe the optical properties of the material near the surface. A detailed study of the influence of ligand-exchange on thin films of semiconductor NCs can be found elsewhere.

We now quantify the optical tuning achieved through ligand-exchange. For the ligand-exchange from oleate to 1-butanethiol, we observe an increase in the refractive index of the superparticles of 8.24%, from n_{eff}=1.674 to 1.812. Taking into account this increase in n_{eff} and the measured 14.44% decrease in superparticle diameter D), and using Equation 2 we expect a 7.38% blue-shift of all WGM resonances λ_{n,1} by Δλ_{n,1}. We compare this expectation with the experimental results by taking as a reference the most intense resonance of the superparticles, which we identify as λ_{1.45}. For this resonance, we expect a blue-shift from 907.7 nm to 840.7 nm. Indeed, after ligand-exchange with 1-butanethiol we find that the resonance has shifted to 838.4 nm, resulting in a blue-shift of Δλ_{1.45}=69.3 nm or 3.9 times the free spectral range of the superparticle. We generalize this procedure to the other alkanethiol ligands, measuring an increasing blue-shift with decreasing ligand length, with a maximum of almost 10 FSR for 1-propanethiol as shown in FIG. 21f. Currently, the optical tuning achieved through ligand-exchange is irreversible, while the large body of work from the photonic community has already proposed several techniques for reversible optical tuning of microresonators. Nevertheless, the magnitude of this irreversible optical tuning achieved through ligand-exchange compares very favorably with the literature. Thermo-optic tuning of a microresonator consisting of a capillary filled with liquid crystal would require a temperature change of almost 200° C. to achieve an optical tuning of 3.9 FSR. Strain tuning a bottle resonator would likely reach the damage threshold of the material before achieving spectral tuning of comparable magnitude. Electrical thermo-optic tuning of a microtoroid resonator would require the application of a voltage of 0.7 V to reach an optical tuning of 3.9 FSR.

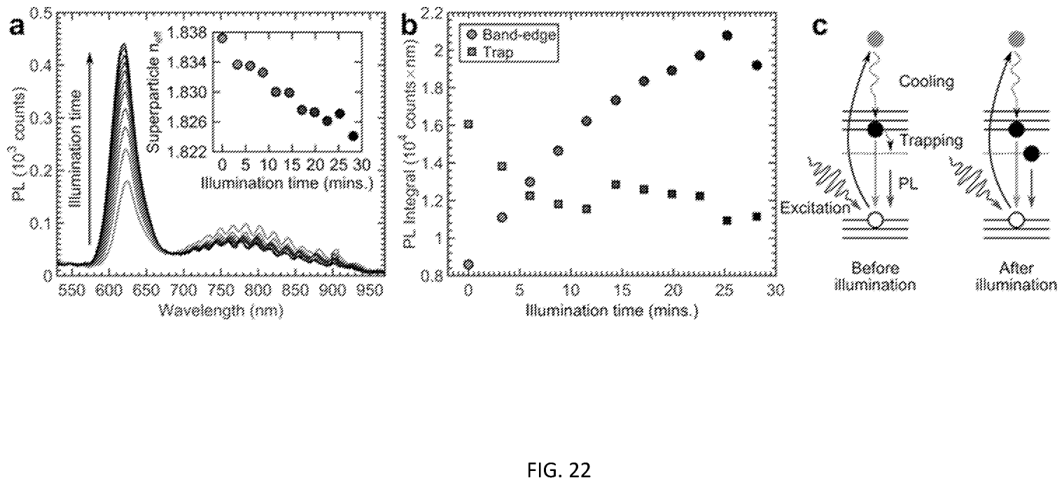

After investigating the use of a chemical trigger to tune the WGMs of the superparticles, we explore the use of an optical trigger. Interestingly, exciting the superparticles with 420 nm light for several minutes results in a clear evolution of the PL spectrum, shown in FIG. 22a. Notably, the positions of the band-edge peak and WGM resonances blue-shift with illumination time. This blue-shift is irreversible, as demonstrated by leaving the sample in the dark for up to 6 days. Additionally, we notice that while the band-edge emission progressively increases in intensity as a function of illumination time, the surface emission decreases in intensity.

The irreversibility of the blue-shift points to photo-oxidation as the responsible mechanism, rather than reversible photo-doping. Oxidation from CdSe to CdO (bulk values of the refractive indices at 2=826.6 nm: n_{CdSe}=2.535 and n_{CdO}=2.299) should lead to a decrease in refractive index, explaining the blue-shift of the band-edge peak and WGM resonances. We note that a temperature increase would lead to a red-shift rather than a blue-shift. The spectral positions of the resonances are time-dependent with a measured blue-shift of 0.28 nm/min. ≈0.016 FSR/min. We compare the efficiency of this method of optical tuning with the literature. Exposing these superparticles to 420 nm light with a power density 3.6 W/cm² for 0.7 hours would lead to an optical tuning of 0.67 FSR; the same magnitude of optical tuning has been achieved by coating a microtoroid resonator with photoresponsive azobenzene moieties and exposing to 450 nm laser light with power density 1.6 W/cm² for 33 hours. Therefore, we estimate that optical tuning of CdSe NC superparticles by exposure to ultraviolet illumination is ˜21 times more energy efficient. However, the tuning achieved using this method is irreversible.

Using Equation 2, we can follow the monotonic decrease of n_{eff} of a single superparticle as a function of illumination time at a constant rate of 0.42×10⁻³/min., as shown in the inset of FIG. 22a. The presence of an isosbestic point around λ=680 nm points to the interconversion of surface emission into band-edge emission with illumination time. We quantify the change in integrated intensity of band-edge and surface emission of a single NC superparticle with illumination time in FIG. 22b, showing that the band-edge PL increases by 230% while the surface PL decreases by 30%.

The diagrams in FIG. 22c rationalize these experimental observations. A 420 nm photon excites a hot exciton in the NCs, which cools down to the first excited state on ultrafast timescales. The cold electron can then either recombine radiatively with the hole by emitting a band-edge photon or undergo surface trapping followed by the emission of a lower-energy photon. After illumination for an extended time, the surface states are likely filled, blocking the trapping transition of the electron. This effective passivation of surface states removes the competitive non-radiative relaxation to the surface state, explaining the increase in intensity of band-edge emission after extended illumination with ultraviolet light.

We have demonstrated the use of chemical and optical triggers to tailor the optical properties of whispering-gallery microresonators that include CdSe NCs assembled into dense, spherical superparticles. We monitor these changes in detail by combining SEM imaging and single superparticle spectroscopy. Exposing the superparticles to short alkanethiols leads to the replacement of the native oleate ligands bound to the surface of the NCs. This ligand-exchange simultaneously causes a decrease in the cavity length, πD, and an increase in the effective refractive index, n_{eff}, of the microresonator, leading to an irreversible optical tuning of almost 10 times the free spectral range. Exposing these ligand-exchanged superparticles to ultraviolet light provides an additional knob to fine-tune their optical properties. The photo-oxidation of NCs in air causes a continuous and irreversible blue-shift of the optical resonances resulting from the decrease of the effective refractive index of the superparticle as a function of illumination time.

For three decades, scientists have tried to rid NCs of surface traps. In this work, we show that surface traps may still play unexpected roles in nanoscience. The sharp WGM resonances of the superparticles modulate the surface PL of CdSe NCs, allowing the direct determination of the effective refractive index of the microresonator. Yet, the photonic resonances can no longer be distinguished when approaching and crossing the band-edge of the NCs. This suggests that re-absorption and non-radiative recombination represent the main loss mechanisms limiting light trapping in NC superparticles. Consequently, we expect that superparticles based on NCs featuring low re-absorption losses may benefit from intense WGMs over a broad spectral range. Notable nanomaterial examples may include NCs characterized by a large surface-to-volume ratio, such as magic-sized clusters and nanoplatelets, NCs passivated by a thick shell of a wider-bandgap material such as CdSe/CdS NCs, and NCs of indirect bandgap materials such as Si. Additionally, the use of optically-active dopants, such as Ag⁺, Cu⁺, or Mn²⁺-ions, may help decrease non-radiative losses due to non-emissive surface states. Optimizing the synergistic roles of NC photophysics and superparticle photonics to improve the quality factor of the microresonators by one order of magnitude could lead to lasing action in the near-infrared through NC surface emission. Finally, the deployment of photonically-resonant systems based on NCs may complement existing technologies as microscale optical sensors for temperature, pollution agents, and ionizing radiation, responsive labels for anti-counterfeiting, and monolithic white-light pixels for displays.

### Frequency Stabilization and Optically Tunable Lasing

Self-assembled superparticles composed of colloidal quantum dots establish microsphere cavities that support optically-pumped lasing from whispering gallery modes. Here, we report on the time- and excitation fluence-dependent lasing properties of CdSe/CdS quantum dot superparticles. Spectra collected under constant photoexcitation reveal that the lasing modes are not temporally stable but instead blue-shift by more than 30 meV over 15 min. To counter this effect, we establish a high-fluence light-soaking protocol that reduces this blue-shift by more than an order of magnitude to 1.7±0.5 meV, with champion superparticles displaying mode blue-shifts of less than 0.5 meV. Increasing the pump fluence allows for optically-controlled, reversible, color-tunable red-to-green lasing. Combining these two paradigms demonstrates that quantum dot superparticles can serve in applications as low-cost, robust, solution-processable, tunable microlasers.

Nanocrystal Superparticles with Whispering-Gallery Modes Tunable Through Chemical and Optical Triggers

Whispering-gallery microresonators have the potential to become the building blocks for optical circuits. However, encoding information in an optical signal requires on-demand tuning of optical resonances. Tuning is achieved by modifying the cavity length or the refractive index of the microresonator. Due to their solid, non-deformable structure, conventional microresonators based on bulk materials are inherently difficult to tune. In this work, we fabricate irreversibly tunable optical microresonators by using semiconductor nanocrystals. These nanocrystals are first assembled into colloidal spherical superparticles featuring whispering-gallery modes. Exposing the superparticles to shorter ligands changes the nanocrystal surface chemistry, decreasing the cavity length of the microresonator by 20% and increasing the refractive index by 8.2%. Illuminating the superparticles with ultraviolet light initiates nanocrystal photo-oxidation, providing an orthogonal channel to decrease the refractive index of the microresonator in a continuous fashion. Through these approaches, we demonstrate optical microresonators tunable by several times their free spectral range.

In this work, we exploit the flexible surface chemistry of NCs to demonstrate superparticles with sharp photonic resonances that are tunable through chemical and optical triggers. We fabricate monodisperse, spherical NC superparticles by using a recently-developed technique that relies on a source-sink emulsion system.47 These superparticles feature sharp WGM resonances, which provide the opportunity to extract the refractive index of individual superparticles. By combining spectroscopic measurements of individual superparticles with electron microscopy studies, we show that adjusting the length of the surface ligands for the NCs represents a reliable strategy to tailor the cavity length and refractive index of the microresonator. Additionally, exposing the superparticles to ultraviolet excitation triggers NC photo-oxidation and decreases the refractive index, providing an orthogonal channel to engineer the optical properties of these self-assembled optical microresonators. Taken together, these two approaches allow for both step-wise and continuous irreversible tuning of the optical resonances by up to ≈10 times the free spectral range of the resonator.

We assemble oleate-capped CdSe NCs, 5.7 nm in diameter, into monodisperse superparticles using a recently-developed source-sink emulsion approach described in FIG. 18.⁴⁷ The source emulsion is prepared using a microfluidic cross-junction and consists of monodisperse 120 μm toluene-in-water droplets containing 0.01% v/v of NCs. This source emulsion is then placed in contact with the sink emulsion, consisting of 55 nm hexadecane-in-water droplets. Mixing the two emulsions results in the transfer of toluene from the source to the sink emulsion, with a transfer rate controlled by the temperature of the mixture.⁴⁷ The complete removal of toluene from the source emulsion takes place within a few minutes, leading to the formation of spherical, monodisperse NC superparticles with a diameter of D=8.6 μm±2%. The reader can refer to a recent report⁴⁷ and the Supporting Information for additional details.

We investigate the interaction of light with a single superparticle in FIG. 19a, showing an optical micrograph of the same superparticle in FIG. 19b. After photoexcitation with 420 nm light, the photoluminescence (PL) spectrum of the superparticle, indicated by a solid line, reveals a brighter peak centered at 634 nm and a 40-fold dimmer peak around 800 nm. The brighter peak originates from the band-edge emission of constituent CdSe NCs, with a spectral asymmetry that results from energy transfer⁴⁸ or photon recycling⁴⁹ from smaller to larger NCs within the ensemble. The dimmer peak is attributed to emission from the surface of the NCs, a common characteristic of unshelled CdSe NCs.^{50, 51} A careful inspection of the spectrum reveals that finer features modulate the surface-emission. These features are also present in the scattering spectrum of the same superparticle, indicated by a dashed line in FIG. 19a. Finite-difference time-domain (FDTD) simulations in FIG. 19c show the confinement of the electric field intensity near the surface of the superparticle. We conclude that the finer features observed in PL and scattering spectra indicate the presence of photonic resonances within the superparticle that lead to an increase in intensity at resonant wavelengths.^{35, 52} In particular, these resonances are consistent with WGMs of the spherical superparticle.⁵³

WGMs are a family of photonic modes that describe the trapping of light near the surface of a dielectric structure with at least one axis of symmetry.^{53, 54} Such a structure behaves as a resonant cavity and can be characterized in terms of optical parameters like the effective refractive index of the cavity, n_{eff}, the quality factor, Q, describing the efficiency of light trapping, and the free spectral range, FSR, the distance between two consecutive resonances. For these superparticles of oleate-capped CdSe NCs, we measure Q=λ/Δλ=109 and FSR=15.7 nm at λ=841.2 nm, where λ is the resonant wavelength, and Δλ is the full-width at half-maximum of the resonance.

Since the density of optical modes depends on the square of the effective refractive index of the cavity, increasing n_{eff} should prove beneficial to light trapping.⁵⁵ For a superparticle, the value of n_{eff} can be approximated as the volumetric average of organic and inorganic components, respectively identified by the ligands and core of the NCs:

$${n}_{e f f} = {ϕ}_{ligand} {n}_{ligand} + {ϕ}_{core} {n}_{core ,} \qquad Equation l$$

decreasing the organic content of the superparticle should increase n_{eff}.⁵⁶

We implement this strategy by exposing the superparticle to a solution of 1-butanethiol, a more compact ligand than the native oleate. The ligand-exchange has a dramatic effect on the optical properties of the superparticle, as shown in FIG. 19d. The spectrum reveals quenching of the band-edge PL and enhancement of the surface emission, consistent with the generation of traps on the surface of CdSe NCs by the binding of thiols.^{51, 57} The wavelength of the band-edge PL blue-shifts by 4.3 nm after ligand-exchange, suggesting oxidation of the surface of the NCs,⁵⁸⁻⁶⁰ effectively decreasing the size of the CdSe core by an estimated 0.2 nm.⁶¹ WGM resonances, more intense than before ligand-exchange, modulate the surface emission. After ligand-exchange, we measure the quality factor and the free spectral range of the cavity to be Q=100 and FSR=17.7 nm at λ=838.4 nm. As the value of the free spectral range is inversely proportional to the cavity length,^{36, 53} πD, an increase in FSR suggests a decrease in the diameter of the microresonator. A direct comparison of the optical micrographs of the superparticle before and after ligand-exchange confirms this decrease in size, as shown in FIG. 19b,e. However, the concomitant decrease in (after ligand-exchange hints at the deterioration of the surface of the microresonator.

Imaging the microresonators by scanning electron microscopy (SEM) confirms these hypotheses, revealing that ligand-exchange causes the NC superparticles not only to shrink, but also to crack as shown in FIG. 20. The superparticles show a single, pronounced crack that splits the spherical structure in two roughly symmetric halves. Likely, the superparticles crack to release the stress accumulated in the shrinking 3D structure. This process appears general, as demonstrated by using alkanethiol ligands with different aliphatic chain lengths. Image analysis reveals that the length of the aliphatic chain is crucial in determining the final morphology of the superparticles, as shown in FIG. 21a. The average diameter of the superparticles decreases monotonically with decreasing number of carbon atoms composing the aliphatic chain of the ligand, from D=8.6 μm for 18 carbon atoms to D=6.9 μm for 2 carbon atoms, leading to a 20% decrease in superparticle diameter and a 50% decrease in superparticle volume. This decrease in volume correlates with the increased occurrence of cracked superparticles, reaching 80% when using 1-propanethiol, as shown in FIG. 21b. These morphological changes are consistent with the displacement of the native oleates by shorter ligands, therefore decreasing the fraction of volume occupied by organic ligands according to Equation 1. Decreasing the concentration of the ligand solution, increasing the duration of the exchange, and performing multiple exchanges may help limit the formation of cracks. 62

The morphological changes induced by ligand-exchange directly affect the optical properties of the superparticles. As shown in FIG. 21c, performing the ligand-exchange with shorter ligands is more effective in quenching the band-edge PL. Additionally, superparticles that have been ligand-exchanged with shorter ligands show more intense WGM resonances, with a maximum 15-fold increase when using 1-butanethiol, as shown in FIG. 21d.

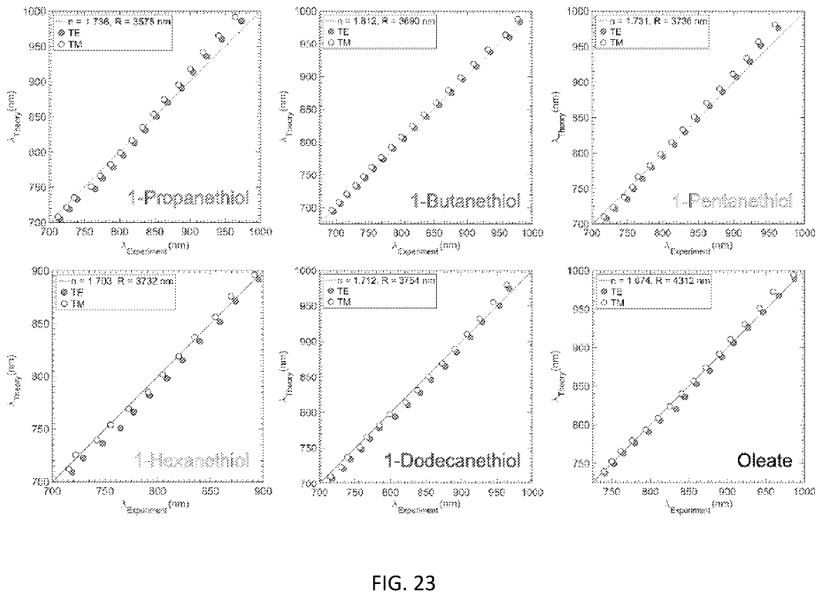

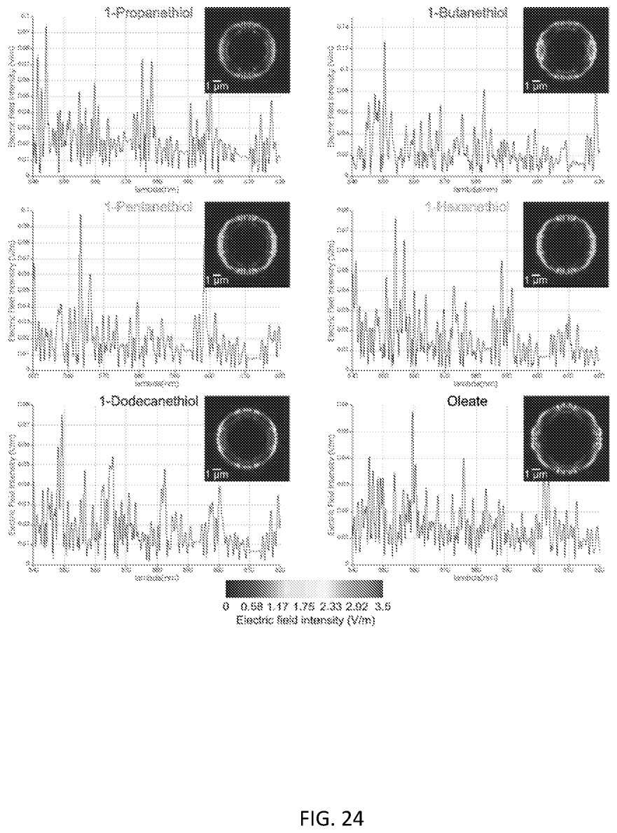

We combine the results of SEM imaging and single superparticle spectroscopy to extract the value of n_{eff} for single NC superparticles. When considering a spherical optical resonator characterized by a diameter D and refractive index n_{eff}, the expected spectral positions of the WGM resonances with mode numbers n and l are well-approximated by:^{53, 63, 64}

$${λ}_{n , 1}^{t heory} = {πDn}_{e f f} [ v + \frac{{α}_{n}}{{2}^{1 / 3}} {v}^{1 / 3} - \frac{P}{\sqrt{{N}^{2} - 1}} + \frac{3}{10} \frac{{α}_{n}^{2}}{{2}^{2 / 3}} {v}^{- 1 / 3} - { \frac{P ( {N}^{2} - 2 {P}^{2} / 3 )}{{( {N}^{2} - 1 )}^{3 / 2}} \frac{{α}_{n}}{{2}^{1 / 3}} {v}^{- 2 / 3} ]}^{- 1} , \qquad ( Equation 2 )$$

where v=l+½, an is the n-th root of the Airy function, N=n_{eff}/nₑₙᵥ is the ratio between the refractive indices of the resonator and the environment, and P=1/N for transverse magnetic (TM) or P=N for transverse electric (TE) mode polarization. By using SEM images to obtain values for D, and analyzing the results of single superparticle PL studies to obtain the observed values for λ_{n,1}^{experiment}, we estimate the value of n_{eff} for a single superparticle by minimizing the sum of the squares of the residuals, Σ_{n,1} [λ_{n,1}^{experiment}−λ_{n,1}^{theory}(n_{eff})]², as shown in FIG. 23. The results are shown in FIG. 21e. Displacing the native oleate ligands with shorter alkanethiols leads to a systematic increase of n_{eff} for a single NC superparticle. Interestingly, the maximum value of n_{eff} corresponds to the NC superparticles exchanged with 1-butanethiol, which is not the shortest ligand in the series. This observation suggests the occurrence of a more complete ligand-exchange when using a ligand with intermediate chain length, leading to a larger increase in n_{eff}. While more compact ligands benefit from faster diffusion, shorter aliphatic chains make the ligand overall less hydrophobic, decreasing the affinity of the ligand for the hydrophobic superparticles and the efficiency of ligand-exchange. The competition between these two effects leads to the intermediate optimum of 1-butanethiol. FDTD simulations that use these values of n_{eff} for the ligand-exchanged superparticles are shown in FIG. 24. We note that since these values for Neff are derived from the analysis of photonic resonances confined near the surface of the superparticles, they describe the optical properties of the material near the surface. A detailed study of the influence of ligand-exchange on thin films of semiconductor NCs can be found in the literature.⁵⁶

We now quantify the optical tuning achieved through ligand-exchange. For the ligand-exchange from oleate to 1-butanethiol, we observe an increase in the refractive index of the superparticles of 8.24%, from n_{eff}=1.674 to 1.812. Taking into account this increase in n_{eff} and the measured 14.44% decrease in superparticle diameter D), and using Equation 2 we expect a 7.38% blue-shift of all WGM resonances λ_{n,1} by λ_{n,1}. We compare this expectation with the experimental results by taking as a reference the most intense resonance of the superparticles, which we identify as λ_{1.45}. For this resonance, we expect a blue-shift from 907.7 nm to 840.7 nm. Indeed, after ligand-exchange with 1-butanethiol we find that the resonance has shifted to 838.4 nm, resulting in a blue-shift of Δλ_{1.45}=69.3 nm or 3.9 times the free spectral range of the superparticle. We generalize this procedure to the other alkanethiol ligands, measuring an increasing blue-shift with decreasing ligand length, with a maximum of almost 10 FSR for 1-propanethiol as shown in FIG. 21f. Currently, the optical tuning achieved through ligand-exchange is irreversible, while the large body of work from the photonic community has already proposed several techniques for reversible optical tuning of microresonators. Nevertheless, the magnitude of this irreversible optical tuning achieved through ligand-exchange compares very favorably with the literature. Thermo-optic tuning of a microresonator consisting of a capillary filled with liquid crystal would require a temperature change of almost 200° C. to achieve an optical tuning of 3.9 FSR.²⁶ Strain tuning a bottle resonator would likely reach the damage threshold of the material before achieving spectral tuning of comparable magnitude.²⁵ Electrical thermo-optic tuning of a microtoroid resonator would require the application of a voltage of 0.7 V to reach an optical tuning of 3.9 FSR.²⁷

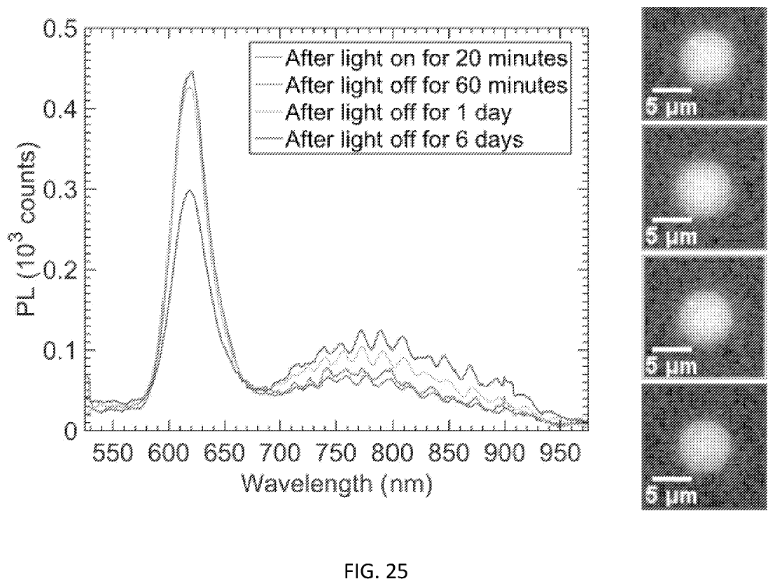

After investigating the use of a chemical trigger to tune the WGMs of the superparticles, we explore the use of an optical trigger. Interestingly, exciting the superparticles with 420 nm light for several minutes results in a clear evolution of the PL spectrum, shown in FIG. 22a. Notably, the positions of the band-edge peak and WGM resonances blue-shift with illumination time. This blue-shift is irreversible, as demonstrated by leaving the sample in the dark for up to 6 days, as shown in FIG. 25. Additionally, we notice that while the band-edge emission progressively increases in intensity as a function of illumination time, the surface emission decreases in intensity.

The irreversibility of the blue-shift points to photo-oxidation as the responsible mechanism,⁶⁵⁻⁶⁷ rather than reversible photo-doping.^{68, 69} Oxidation from CdSe to CdO (bulk values of the refractive indices at λ=826.6 nm: n_{CdSe}=2.535 and n_{CdO}=2.299)^{70, 71} should lead to a decrease in refractive index, explaining the blue-shift of the band-edge peak and WGM resonances. We note that a temperature increase would lead to a red-shift rather than a blue-shift.^{45, 72} The spectral positions of the resonances are time-dependent with a measured blue-shift of 0.28 nm/min. ≈0.016 FSR/min. We compare the efficiency of this method of optical tuning with the literature. Exposing these superparticles to 420 nm light with a power density 3.6 W/cm² for 0.7 hours would lead to an optical tuning of 0.67 FSR; the same magnitude of optical tuning has been achieved by coating a microtoroid resonator with photoresponsive azobenzene moieties and exposing to 450 nm laser light with power density 1.6 W/cm² for 33 hours.²⁹ Therefore, we estimate that optical tuning of CdSe NC superparticles by exposure to ultraviolet illumination is ˜21 times more energy efficient. However, the tuning achieved using this method is irreversible.

Using Equation 2, we can follow the monotonic decrease of n_{eff} of a single superparticle as a function of illumination time at a constant rate of 0.42×10⁻³/min., as shown in the inset of FIG. 22a. The presence of an isosbestic point around λ=680 nm points to the interconversion of surface emission into band-edge emission with illumination time. We quantify the change in integrated intensity of band-edge and surface emission of a single NC superparticle with illumination time in FIG. 22b, showing that the band-edge PL increases by 230% while the surface PL decreases by 30%.

The diagrams in FIG. 22c rationalize these experimental observations. A 420 nm photon excites a hot exciton in the NCs, which cools down to the first excited state on ultrafast timescales. The cold electron can then either recombine radiatively with the hole by emitting a band-edge photon or undergo surface trapping followed by the emission of a lower-energy photon. After illumination for an extended time, the surface states are likely filled, blocking the trapping transition of the electron. This effective passivation of surface states removes the competitive non-radiative relaxation to the surface state, explaining the increase in intensity of band-edge emission after extended illumination with ultraviolet light.

We have demonstrated the use of chemical and optical triggers to tailor the optical properties of whispering-gallery microresonators consisting of CdSe NCs assembled into dense, spherical superparticles. We monitor these changes in detail by combining SEM imaging and single superparticle spectroscopy. Exposing the superparticles to short alkanethiols leads to the replacement of the native oleate ligands bound to the surface of the NCs. This ligand-exchange simultaneously causes a decrease in the cavity length, πD, and an increase in the effective refractive index, n_{eff}, of the microresonator, leading to an irreversible optical tuning of almost 10 times the free spectral range. Exposing these ligand-exchanged superparticles to ultraviolet light provides an additional knob to fine-tune their optical properties. The photo-oxidation of NCs in air causes a continuous and irreversible blue-shift of the optical resonances resulting from the decrease of the effective refractive index of the superparticle as a function of illumination time.

For three decades, scientists have tried to rid NCs of surface traps. In this work, we show that surface traps may still play unexpected roles in nanoscience. The sharp WGM resonances of the superparticles modulate the surface PL of CdSe NCs, allowing the direct determination of the effective refractive index of the microresonator. Yet, the photonic resonances can no longer be distinguished when approaching and crossing the band-edge of the NCs. This suggests that re-absorption and non-radiative recombination represent the main loss mechanisms limiting light trapping in NC superparticles. Consequently, we expect that superparticles based on NCs featuring low re-absorption losses may benefit from intense WGMs over a broad spectral range. Notable nanomaterial examples may include NCs characterized by a large surface-to-volume ratio, such as magic-sized clusters⁷³ and nanoplatelets,⁵¹ NCs passivated by a thick shell of a wider-bandgap material such as CdSe/CdS NCs,⁷⁴ and NCs of indirect bandgap materials such as Si.^{75, 76} Additionally, the use of optically-active dopants, such as Ag⁺,⁷⁷ Cu⁺,⁷⁸ or Mn²⁺-ions,⁷⁹ may help decrease non-radiative losses due to non-emissive surface states.⁸⁰ Optimizing the synergistic roles of NC photophysics and superparticle photonics to improve the quality factor of the microresonators by one order of magnitude could lead to lasing action in the near-infrared through NC surface emission. Finally, the deployment of photonically-resonant systems based on NCs may complement existing technologies as microscale optical sensors for temperature,⁸¹⁻⁸³ pollution agents,⁸⁴⁻⁸⁹ and ionizing radiation,^{90, 91} responsive labels for anti-counterfeiting,^{92, 93} and monolithic white-light pixels for displays.

### Materials and Methods

### Synthesis of CdSe NCs.

Oleate-capped CdSe NCs are synthesized according to the literature, 1 implementing modifications outlined in detail in previous work.2, 3

Materials: All reagents are purchased from Sigma-Aldrich and used as received. 1-Octadecene (ODE, technical grade, Acros Organics), oleic acid (OA, technical grade), CdO (≥99.99% trace metals basis), selenium (powder ˜100 mesh, 99.99% trace metals basis), trioctylphosphine (TOP, 97%), hexane (reagent grade), and ethanol (200 proof, reagent grade).

Synthesis: A 1 M TOP: Se solution is prepared by stirring 0.790 g (10 mmol) of Se powder in 10 mL of TOP in a nitrogen-filled glovebox overnight. All the Se powder should be dissolved to form a transparent, yellow-tinted solution before synthesis. Before synthesis, 3 mL of the 1 M TOP: Se is mixed with 7 mL of ODE and loaded into a syringe placed in a syringe pump set for a rate of 10 mL/h.

The cadmium oleate precursor solution is prepared by mixing 0.512 g of CdO, 6.28 g of OA (7 mL), and 25 g of ODE (32 mL) in a 100 mL three-neck round-bottom flask. The flask is connected to the Schlenk line through the central neck, one of the side-necks is equipped with a thermocouple adapter and thermocouple, and the other side-neck is fitted with a rubber septum. While stirring, the reagents are degassed at 100° C. for one hour. Afterward, the flask atmosphere is switched to nitrogen, and the temperature is raised to 260° C. The temperature is held constant until the color of the mixture changes from dark red to colorless, indicating the formation of cadmium oleate.

Subsequently, the temperature is decreased to 100° C. by forced-air cooling, and the flask is placed under vacuum for 30 min. This is done to remove the water produced during the reaction. After switching the atmosphere again to nitrogen, the temperature is raised to 260° C.

Meanwhile, 0.063 g (0.8 mmol) of Se powder is added to 5 mL of ODE and sonicated for 20 min. The Se/ODE mixture is injected at 260° C. through the free side-neck using a 22 mL plastic syringe equipped with a 16 G needle. Immediately after that, and the temperature controller is set to 240° C. After 60 s from the injection, the TOP: Se/ODE solution is added dropwise at a rate of 10 mL/h. After 60 min, the reaction is rapidly quenched by removing the heating mantle and lowering the flask in a container full of water at room temperature. Note: the 60 min reaction time yields the nanocrystals with the lowest polydispersity.3

The reaction mixture is split into enough 50 mL centrifuge tubes to have 5 mL of the mixture in each tube. Approximately 20 mL of hexane are added to each tube, which is then capped and vortexed. 25 mL of ethanol is added to each tube, and the tubes are centrifuged at 8000 g for 5 min. Often, this first precipitation results in a slightly colored supernatant, which is discarded while keeping the precipitated NCs. The NCs are washed twice more by dispersing each the pellet in 10 mL of hexane and then precipitating with an equal volume of ethanol. After the final wash, the NCs are dispersed in toluene (10 mL) and filtered using a 0.22 μm PTFE or PVDF syringe filter. Note: in the absence of 200 proof ethanol, we suggest using a mixture of 3 to 1 isopropanol to ethanol by volume. The NC concentration can be obtained by using the published sizing curves.4

### Synthesis of CdSe NC Superparticles.

CdSe NC superparticles are synthesized by using a recently developed source-sink emulsion system.5 The method relies on two emulsions, a “source” and a “sink.” The source emulsion consists of monodisperse 120 μm droplets containing a 0.01% v/v of CdSe NCs in toluene. These droplets are generated by droplet microfluidics using the device shown in FIG. 18 (Darwin Microfluidics, T-26). The device inlets are pressurized to 1000 mbar using a multi-channel pressure regulator (Elveflow, OB1 MK3+). The dispersed phase consists of a 0.01% v/v dispersion of CdSe NCs in toluene, while the continuous phase consists of a 20 mM aqueous solution of sodium dodecyl sulfate.

The sink emulsion consists of 55 nm hexadecane droplets in a 20 mM aqueous solution of sodium dodecyl sulfate. These droplets are generated by mixing 90% w/w 200 mM sodium dodecyl sulfate in water and 10% w/w of hexadecane, followed by 1.5 h ultra-sonication and 2 h tip-sonication (peak power 84 W, 50% duty cycle) until the emulsion looks mostly clear with a blue hue. The emulsion is then diluted 10-fold with Milli-Q water.

The source emulsion is then mixed with the sink emulsion by using the second junction of the device, as shown in FIG. 18. The inlet of the sink emulsion is pressurized to 2000 mbar. The source and sink emulsion flow together for 4 min along an 11.5 m PTFE tubing that is tightly wound around a temperature-regulated copper rod, as shown in FIG. 18, with the temperature of the rod set at 70° C. During this time, the spontaneous mass transfer of toluene from the source to the sink emulsion occurs, leading to monodisperse NC superparticles.

The dispersion of NC superparticles is collected in a scintillation vial, as shown in FIG. 18, and placed on a hot plate set at 50° C. for overnight. The NC superparticles are washed three times in an aqueous solution of 20 mM sodium dodecyl sulfate using a centrifuge set at 100 g for 5 min. The dispersion of NC superparticles is then drop cast on the desired substrate, silicon for SEM imaging and glass for spectroscopy, and dried under vacuum. The substrate is then dipped three times in a mixture of isopropanol and water, 2 to 1 by volume, to remove excess surfactant and dried under vacuum.

### Ligand-Exchange of CdSe NC Superparticles.

Ligand-exchange is performed by submerging the substrate where the superparticles are drop cast in a solution of 0.1 M alkanethiol in acetonitrile for 3 h at room temperature. The substrate is then retrieved and dipped three times in neat acetonitrile to remove excess alkanethiol ligands and dried under vacuum.

### SEM Imaging and Analysis.

SEM imaging is carried out on a Tescan S8252X operated at 2 kV and 100 pA. Image analysis was performed by using ImageJ.

### Single-Superparticle Spectroscopy and Analysis.

Transmission dark-field scattering spectra are collected by a CRAIC 308 PV microspectrophotometer integrated on an Olympus BX51. White light from a 100 W tungsten halogen lamp is focused onto the sample using a substage dark-field condenser (Olympus U-DCD), and scattering from the sample is collected by a 20× objective (Olympus PLN, NA 0.40). At 20× magnification, the collection aperture of the microspectrophotometer corresponds to a sample region of 13.4 μm×13.4 μm which is sufficient to measure a single superparticle. The measured scattering intensity spectra is normalized by the lamp spectrum measured by using a diffuse scattering reference (Labsphere) and the expression:

$${I}_{\text{?}} = ( {I}_{sample} - {I}_{sample , background} ) ( {I}_{ref} - {I}_{ref , background} ) .$$

$$\text{?} \text{indicates text missing or illegible when filed}$$

PL spectra are also collected by a CRAIC 308 PV microspectrophotometer integrated on an Olympus BX51 but using a 120 W mercury vapor arc lamp as the excitation source instead. The excitation light was filtered by a 400 nm-440 nm band-pass filter, and the emission is collected through a 475 nm long-pass filter (Olympus U-MWBV2). At the focal plane, we measure a power of 0.022 W and a spot diameter of 0.088 cm, leading to a power density of 3.6 W/cm². For both scattering and PL, the integration time is set to 1 s, and the number of averaged spectra is set to 30. When comparing superparticles ligand-exchanged with alkanethiols of different length, we keep the lamp shutter always closed except while measuring to limit the influence of photo-oxidation.

The PL spectra are analyzed using a self-developed Matlab script. The script first fits the surface-emission envelope to a gaussian curve by interpolating through the minima of the WGM resonances. After subtracting the fitted curve from the spectrum, the WGM resonances are individually fitted by either one or two gaussians when accounting for TM and TE polarizations to generate the values of λn,1experiment. Using the values for the diameter of the superparticles derived from SEM and the first guess for neff, we generate the matrix of values of λn,1theory using Equation 2. For the spectral range investigated here, we find it sufficient limiting the values to n=1, with the values of l ranging between 30 and 60. We then decrease the value of neff in steps of 0.0001 until the quantity Σn,1 (λn,1experiment-λn,1theory (neff))2 is minimized.6-8 We set a conservative estimate for the error bars for neff to Δneff=0.001.

### FDTD Simulations.

The simulation is performed using Lumerical Nanophotonic FDTD Simulation software. First, a sphere, with diameter extracted from SEM images and refractive index extracted as described above, is simulated on a 1 μm-thick Si layer. A dipole source with a wavelength range between 540 nm to 620 nm is placed near the sphere's edge to excite all supporting modes. To locate the whispery-gallery mode, we insert a power monitor inside the sphere. By locating the peaks in the electric field intensity spectrum, we find the resonant frequencies of the structure. After finding the frequencies, we use a profile monitor to map out the electric field intensity across the sphere.
1. Zhong, H.-S.; Wang, H.; Deng, Y.-H.; Chen, M.-C.; Peng, L.-C.; Luo, Y.-H.; Qin, J.; Wu, D.; Ding, X.; Hu, Y.; Hu, P.; Yang, X.-Y.; Zhang, W.-J.; Li, H.; Li, Y.; Jiang, X.; Gan, L.; Yang, G.; You, L.; Wang, Z.; Li, L.; Liu, N.-L.; Lu, C.-Y.; Pan, J.-W., Quantum computational advantage using photons. Science 2020, 370 (6523), 1460-1463.
2. Vahala, K. J., Optical microcavities. Nature 2003, 424 (6950), 839-846.
3. Little, B. E.; Foresi, J. S.; Steinmeyer, G.; Thoen, E. R.; Chu, S. T.; Haus, H. A.; Ippen, E. P.; Kimerling, L. C.; Greene, W., Ultra-compact Si—SiO2 microring resonator optical channel dropping filters. IEEE Photonics Technology Letters 1998, 10 (4), 549-551.
4. Harris, N. C.; Grassani, D.; Simbula, A.; Pant, M.; Galli, M.; Baehr-Jones, T.; Hochberg, M.; Englund, D.; Bajoni, D.; Galland, C., Integrated Source of Spectrally Filtered Correlated Photons for Large-Scale Quantum Photonic Systems. Physical Review X 2014, 4 (4), 041047.
5. Zheng, J. Y.; Yan, Y.; Wang, X.; Zhao, Y. S.; Huang, J.; Yao, J., Wire-on-Wire Growth of Fluorescent Organic Heterojunctions. Journal of the American Chemical Society 2012, 134 (6), 2880-2883.
6. Xing, P.; Chen, G. F. R.; Zhao, X.; Ng, D. K. T.; Tan, M. C.; Tan, D. T. H., Silicon rich nitride ring resonators for rare-earth doped telecommunications-band amplifiers pumped at the O-band. Scientific Reports 2017, 7 (1), 9101.
7. le Feber, B.; Prins, F.; De Leo, E.; Rabouw, F. T.; Norris, D. J., Colloidal-Quantum-Dot Ring Lasers with Active Color Control. Nano Letters 2018, 18 (2), 1028-1034.
8. Shen, Z.; Zhang, Y.-L.; Chen, Y.; Sun, F.-W.; Zou, X.-B.; Guo, G.-C.; Zou, C.-L.; Dong, C.-H., Reconfigurable optomechanical circulator and directional amplifier. Nature Communications 2018, 9 (1), 1797.
9. Zhang, C.; Dong, H.; Zhang, C.; Fan, Y.; Yao, J.; Zhao Yong, S., Photonic skins based on flexible organic microlaser arrays. Science Advances 7 (31), eabh3530.
10. Qiao, X.; Midya, B.; Gao, Z.; Zhang, Z.; Zhao, H.; Wu, T.; Yim, J.; Agarwal, R.; Litchinitser Natalia, M.; Feng, L., Higher-dimensional supersymmetric microlaser arrays. Science 2021, 372 (6540), 403-408.
11. Fujita, M.; Baba, T., Microgear laser. Applied Physics Letters 2002, 80 (12), 2051-2053.
12. Zhang, Z.; Yang, L.; Liu, V.; Hong, T.; Vahala, K.; Scherer, A., Visible submicron microdisk lasers. Applied Physics Letters 2007, 90 (11), 111119.
13. Xia, F.; Sekaric, L.; Vlasov, Y., Ultracompact optical buffers on a silicon chip. Nature Photonics 2007, 1 (1), 65-71.
14. Melloni, A.; Morichetti, F.; Ferrari, C.; Martinelli, M., Continuously tunable 1 byte delay in coupled-resonator optical waveguides. Opt. Lett. 2008, 33 (20), 2389-2391.
15. Sumetsky, M., Delay of Light in an Optical Bottle Resonator with Nanoscale Radius Variation: Dispersionless, Broadband, and Low Loss. Physical Review Letters 2013, 111 (16), 163901.
16. Djordjev, K.; Seung-June, C.; Sang-Jun, C.; Dapkus, R. D., Microdisk tunable resonant filters and switches. IEEE Photonics Technology Letters 2002, 14 (6), 828-830.
17. Yang, A. H. J.; Erickson, D., Optofluidic ring resonator switch for optical particle transport. Lab on a Chip 2010, 10 (6), 769-774.
18. Qiao, C.; Zhang, C.; Zhou, Z.; Yao, J.; Zhao, Y. S., An Optically Reconfigurable Förster Resonance Energy Transfer Process for Broadband Switchable Organic Single-Mode Microlasers. CCS Chemistry 2022, 4 (1), 250-258.
19. Zhang, W.; Yan, Y.; Gu, J.; Yao, J.; Zhao, Y. S., Low-Threshold Wavelength-Switchable Organic Nanowire Lasers Based on Excited-State Intramolecular Proton Transfer. Angewandte Chemie International Edition 2015, 54 (24), 7125-7129.
20. Rabiei, P.; Steier, W. H.; Zhang, C.; Dalton, L. R., Polymer Micro-Ring Filters and Modulators. J. Lightwave Technol. 2002, 20 (11), 1968.
21. Flatae, A. M.; Burresi, M.; Zeng, H.; Nocentini, S.; Wiegele, S.; Parmeggiani, C.; Kalt, H.; Wiersma, D., Optically controlled elastic microcavities. Light: Science & Applications 2015, 4 (4), e282, 1-5.
22. Vernooy, D. W.; Ilchenko, V. S.; Mabuchi, H.; Streed, E. W.; Kimble, H. J., High-Q measurements of fused-silica microspheres in the near infrared. Opt. Lett. 1998, 23 (4), 247-249.
23. Gayral, B.; Gerard, J. M.; Lemaître, A.; Dupuis, C.; Manin, L.; Pelouard, J. L., High-Q wet-etched GaAs microdisks containing InAs quantum boxes. Applied Physics Letters 1999, 75 (13), 1908-1910.
24. Armani, D. K.; Kippenberg, T. J.; Spillane, S. M.; Vahala, K. J., Ultra-high-Q toroid microcavity on a chip. Nature 2003, 421 (6926), 925-928.
25. Pollinger, M.; O'Shea, D.; Warken, F.; Rauschenbeutel, A., Ultrahigh-Q Tunable Whispering-Gallery-Mode Microresonator. Physical Review Letters 2009, 103 (5), 053901.
26. Kavungal, V.; Farrell, G.; Wu, Q.; Mallik, A. K.; Semenova, Y., Thermo-optic tuning of a packaged whispering gallery mode resonator filled with nematic liquid crystal. Opt. Express 2018, 26 (7), 8431-8442.
27. Armani, D.; Min, B.; Martin, A.; Vahala, K. J., Electrical thermo-optic tuning of ultrahigh-Q microtoroid resonators. Applied Physics Letters 2004, 85 (22), 5439-5441.
28. Guarino, A.; Poberaj, G.; Rezzonico, D.; Degl′Innocenti, R.; Günter, P., Electro-optically tunable microring resonators in lithium niobate. Nature Photonics 2007, 1 (7), 407-410.
29. Kovach, A.; He, J.; Saris, P. J. G.; Chen, D.; Armani, A. M., Optically tunable microresonator using an azobenzene monolayer. AIP Advances 2020, 10 (4), 045117.
30. Qiao, C.; Zhang, C.; Zhou, Z.; Dong, H.; Du, Y.; Yao, J.; Zhao, Y. S., A Photoisomerization-Activated Intramolecular Charge-Transfer Process for Broadband-Tunable Single-Mode Microlasers. Angewandte Chemie International Edition 2020, 59 (37), 15992-15996.
31. Capretti, A.; Lesage, A.; Gregorkiewicz, T., Integrating Quantum Dots and Dielectric Mie Resonators: A Hierarchical Metamaterial Inheriting the Best of Both. ACS Photonics 2017, 4 (9), 2187-2196.
32. Burel, C. A. S.; Alsayed, A.; Malassis, L.; Murray, C. B.; Donnio, B.; Dreyfus, R., Plasmonic-Based Mechanochromic Microcapsules as Strain Sensors. Small 2017, 13 (39), 1701925.
33. Burel, C.; Teolis, A.; Alsayed, A.; Murray, C. B.; Donnio, B.; Dreyfus, R., Plasmonic Elastic Capsules as Colorimetric Reversible pH-Microsensors. Small 2020, 16 (6), 1903897.
34. Burel, C.; Ibrahim, O.; Marino, E.; Bharti, H.; Murray, C. B.; Donnio, B.; Fakhraai, Z.; Dreyfus, R., Tunable Plasmonic Microcapsules with Embedded Noble Metal Nanoparticles for Optical Microsensing. ACS Applied Nano Materials 2022, 5 (2), 2828-2838.
35. Marino, E.; Sciortino, A.; Berkhout, A.; MacArthur, K. E.; Heggen, M.; Gregorkiewicz, T.; Kodger, T. E.; Capretti, A.; Murray, C. B.; Koenderink, A. F.; Messina, F.; Schall, P., Simultaneous Photonic and Excitonic Coupling in Spherical Quantum Dot Supercrystals. ACS Nano 2020, 14 (10), 13806-13815.
36. Montanarella, F.; Urbonas, D.; Chadwick, L.; Moerman, P. G.; Baesjou, P. J.; Mahrt, R. F.; van Blaaderen, A.; Stöferle, T.; Vanmaekelbergh, D., Lasing Supraparticles Self-Assembled from Nanocrystals. ACS Nano 2018, 12 (12), 12788-12794.
37. Vanmaekelbergh, D.; van Vugt, L. K.; Bakker, H. E.; Rabouw, F. T.; de Nijs, B.; van Dijk-Moes, R. J. A.; van Huis, M. A.; Baesjou, P. J.; van Blaaderen, A., Shape-Dependent Multiexciton Emission and Whispering Gallery Modes in Supraparticles of CdSe/Multishell Quantum Dots. ACS Nano 2015, 9 (4), 3942-3950.
38. Yang, Y.; Wang, B.; Shen, X.; Yao, L.; Wang, L.; Chen, X.; Xie, S.; Li, T.; Hu, J.; Yang, D.; Dong, A., Scalable Assembly of Crystalline Binary Nanocrystal Superparticles and Their Enhanced Magnetic and Electrochemical Properties. Journal of the American Chemical Society 2018, 140 (44), 15038-15047.
39. Marino, E.; Kodger, T. E.; Wegdam, G. H.; Schall, P., Revealing Driving Forces in Quantum Dot Supercrystal Assembly. Advanced Materials 2018, 30 (43), 1803433.
40. Marino, E.; Keller, A. W.; An, D.; van Dongen, S.; Kodger, T. E.; MacArthur, K. E.; Heggen, M.; Kagan, C. R.; Murray, C. B.; Schall, P., Favoring the Growth of High-Quality, Three-Dimensional Supercrystals of Nanocrystals. The Journal of Physical Chemistry C 2020, 124 (20), 11256-11264.
41. Montanarella, F.; Geuchies, J. J.; Dasgupta, T.; Prins, P. T.; van Overbeek, C.; Dattani, R.; Baesjou, P.; Dijkstra, M.; Petukhov, A. V.; van Blaaderen, A.; Vanmaekelbergh, D., Crystallization of Nanocrystals in Spherical Confinement Probed by in Situ X-ray Scattering. Nano Letters 2018, 18 (6), 3675-3681.
42. Tang, Y.; Gomez, L.; Lesage, A.; Marino, E.; Kodger, T. E.; Meijer, J.-M.; Kolpakov, P.; Meng, J.; Zheng, K.; Gregorkiewicz, T.; Schall, P., Highly Stable Perovskite Supercrystals via Oil-in-Oil Templating. Nano Letters 2020, 20 (8), 5997-6004.
43. Montanarella, F.; Altantzis, T.; Zanaga, D.; Rabouw, F. T.; Bals, S.; Baesjou, P.; Vanmaekelbergh, D.; van Blaaderen, A., Composite Supraparticles with Tunable Light Emission. ACS Nano 2017, 11 (9), 9136-9142.
44. Savo, R.; Morandi, A.; Müller, J. S.; Kaufmann, F.; Timpu, F.; Reig Escalé, M.; Zanini, M.; Isa, L.; Grange, R., Broadband Mie driven random quasi-phase-matching. Nature Photonics 2020, 14 (12), 740-747.
45. Chang, H.; Zhong, Y.; Dong, H.; Wang, Z.; Xie, W.; Pan, A.; Zhang, L., Ultrastable low-cost colloidal quantum dot microlasers of operative temperature up to 450 K. Light: Science & Applications 2021, 10 (1), 60.
46. Wang, D.; Dasgupta, T.; van der Wee, E. B.; Zanaga, D.; Altantzis, T.; Wu, Y.; Coli, G. M.; Murray, C. B.; Bals, S.; Dijkstra, M.; van Blaaderen, A., Binary icosahedral clusters of hard spheres in spherical confinement. Nature Physics 2021, 17 (1), 128-134.
47. Marino, E.; van Dongen, S. W.; Neuhaus, S. J.; Li, W.; Keller, A. W.; Kagan, C. R.; Kodger, T. E.; Murray, C. B., Monodisperse Nanocrystal Superparticles through a Source-Sink Emulsion System. Chemistry of Materials 2022, 34 (6), 2779-2789.
48. Kagan, C. R.; Murray, C. B.; Bawendi, M. G., Long-range resonance transfer of electronic excitations in close-packed CdSe quantum-dot solids. Physical Review B 1996, 54 (12), 8633-8643.
49. van der Laan, M.; de Weerd, C.; Poirier, L.; van de Water, O.; Poonia, D.; Gomez, L.; Kinge, S.; Siebbeles, L. D. A.; Koenderink, A. F.; Gregorkiewicz, T.; Schall, P., Photon Recycling in CsPbBr3 All-Inorganic Perovskite Nanocrystals. ACS Photonics 2021, 8 (11), 3201-3208.
50. Mooney, J.; Krause, M. M.; Saari, J. I.; Kambhampati, P., Challenge to the deep-trap model of the surface in semiconductor nanocrystals. Physical Review B 2013, 87 (8), 081201.
51. Marino, E.; Kodger, T. E.; Crisp, R. W.; Timmerman, D.; MacArthur, K. E.; Heggen, M.; Schall, P., Repairing Nanoparticle Surface Defects. Angewandte Chemie International Edition 2017, 56 (44), 13795-13799.
52. Bohren, C. F.; Huffman, D. R., Chapter 4: Absorption and Scattering by a Sphere. In Absorption and Scattering of Light by Small Particles, John Wiley & Sons: 1998; pp 82-129.
53. Vollmer, F.; Yu, D., Whispering Gallery Modes in Optical Microcavities. In Optical Whispering Gallery Modes for Biosensing: From Physical Principles to Applications, Vollmer, F.; Yu, D., Eds. Springer International Publishing: Cham, 2020; pp 117-170.
54. Reynolds, T.; Riesen, N.; Meldrum, A.; Fan, X.; Hall, J. M. M.; Monro, T. M.; François, A., Fluorescent and lasing whispering gallery mode microresonators for sensing applications. Laser & Photonics Reviews 2017, 11 (2), 1600265.
55. Barnes, W. L.; Horsley, S. A. R.; Vos, W. L., Classical antennas, quantum emitters, and densities of optical states. Journal of Optics 2020, 22 (7), 073501.
56. Diroll, B. T.; Gaulding, E. A.; Kagan, C. R.; Murray, C. B., Spectrally-Resolved Dielectric Functions of Solution-Cast Quantum Dot Thin Films. Chemistry of Materials 2015, 27 (18), 6463-6469.
57. Baker, D. R.; Kamat, P. V., Tuning the Emission of CdSe Quantum Dots by Controlled Trap Enhancement. Langmuir 2010, 26 (13), 11272-11276.
58. Luo, X.; Liu, P.; Truong, N. T. N.; Farva, U.; Park, C., Photoluminescence Blue-Shift of CdSe Nanoparticles Caused by Exchange of Surface Capping Layer. The Journal of Physical Chemistry C 2011, 115 (43), 20817-20823.
59. Liu, L.; Peng, Q.; Li, Y., An Effective Oxidation Route to Blue Emission CdSe Quantum Dots. Inorganic Chemistry 2008, 47 (8), 3182-3187.
60. van Sark, W. G. J. H. M.; Frederix, P. L. T. M.; Bol, A. A.; Gerritsen, H. C.; Meijerink, A., Blueing, Bleaching, and Blinking of Single CdSe/ZnS Quantum Dots. ChemPhysChem 2002, 3 (10), 871-879.
61. Jasieniak, J.; Smith, L.; van Embden, J.; Mulvaney, P.; Califano, M., Re-examination of the Size-Dependent Absorption Properties of CdSe Quantum Dots. The Journal of Physical Chemistry C 2009, 113 (45), 19468-19474.
62. Weidman, M. C.; Yager, K. G.; Tisdale, W. A., Interparticle Spacing and Structural Ordering in Superlattice PbS Nanocrystal Solids Undergoing Ligand Exchange. Chemistry of Materials 2015, 27 (2), 474-482.
63. Jana, S.; Xu, X.; Klymchenko, A.; Reisch, A.; Pons, T., Microcavity-Enhanced Fluorescence Energy Transfer from Quantum Dot Excited Whispering Gallery Modes to Acceptor Dye Nanoparticles. ACS Nano 2021, 15 (1), 1445-1453.
64. Lam, C. C.; Leung, P. T.; Young, K., Explicit asymptotic formulas for the positions, widths, and strengths of resonances in Mie scattering. J. Opt. Soc. Am. B 1992, 9 (9), 1585-1592.
65. Wang, X.; Qu, L.; Zhang, J.; Peng, X.; Xiao, M., Surface-Related Emission in Highly Luminescent CdSe Quantum Dots. Nano Letters 2003, 3 (8), 1103-1106.
66. Spanhel, L.; Haase, M.; Weller, H.; Henglein, A., Photochemistry of colloidal semiconductors. 20. Surface modification and stability of strong luminescing CdS particles. Journal of the American Chemical Society 1987, 109 (19), 5649-5655.
67. Brennan, M. C.; Toso, S.; Pavlovetc, I. M.; Zhukovskyi, M.; Marras, S.; Kuno, M.; Manna, L.; Baranov, D., Superlattices are Greener on the Other Side: How Light Transforms Self-Assembled Mixed Halide Perovskite Nanocrystals. ACS Energy Letters 2020, 5 (5), 1465-1473.
68. Whitham, P. J.; Knowles, K. E.; Reid, P. J.; Gamelin, D. R., Photoluminescence Blinking and Reversible Electron Trapping in Copper-Doped CdSe Nanocrystals. Nano Letters 2015, 15 (6), 4045-4051.
69. Rinehart, J. D.; Schimpf, A. M.; Weaver, A. L.; Cohn, A. W.; Gamelin, D. R., Photochemical Electronic Doping of Colloidal CdSe Nanocrystals. Journal of the American Chemical Society 2013, 135 (50), 18782-18785.
70. Ninomiya, S.; Adachi, S., Optical properties of cubic and hexagonal CdSe. Journal of Applied Physics 1995, 78 (7), 4681-4689.
71. Choi, S. G.; Zúñiga-Pérez, J.; Muñoz-Sanjosé, V.; Norman, A. G.; Perkins, C. L.; Levi, D. H., Complex dielectric function and refractive index spectra of epitaxial CdO thin film grown on r-plane sapphire from 0.74 to 6.45 eV. Journal of Vacuum Science & Technology B 2010, 28 (6), 1120-1124.
72. Diroll, B. T.; Murray, C. B., High-Temperature Photoluminescence of CdSe/CdS Core/Shell Nanoheterostructures. ACS Nano 2014, 8 (6), 6466-6474.
73. Bowers, M. J.; McBride, J. R.; Rosenthal, S. J., White-Light Emission from Magic-Sized Cadmium Selenide Nanocrystals. Journal of the American Chemical Society 2005, 127 (44), 15378-15379.
74. Meinardi, F.; Colombo, A.; Velizhanin, K. A.; Simonutti, R.; Lorenzon, M.; Beverina, L.; Viswanatha, R.; Klimov, V. I.; Brovelli, S., Large-area luminescent solar concentrators based on ‘Stokes-shift-engineered’ nanocrystals in a mass-polymerized PMMA matrix. Nature Photonics 2014, 8 (5), 392-399.
75. Meinardi, F.; Ehrenberg, S.; Dhamo, L.; Carulli, F.; Mauri, M.; Bruni, F.; Simonutti, R.; Kortshagen, U.; Brovelli, S., Highly efficient luminescent solar concentrators based on earth-abundant indirect-bandgap silicon quantum dots. Nature Photonics 2017, 11 (3), 177-185.
76. Sugimoto, H.; Fujii, M., Colloidal Mie Resonators for All-Dielectric Metaoptics. Advanced Photonics Research 2021, 2 (4), 2000111.
77. Sahu, A.; Kang, M. S.; Kompch, A.; Notthoff, C.; Wills, A. W.; Deng, D.; Winterer, M.; Frisbie, C. D.; Norris, D. J., Electronic Impurity Doping in CdSe Nanocrystals. Nano Letters 2012, 12 (5), 2587-2594.
78. Yang, L.; Knowles, K. E.; Gopalan, A.; Hughes, K. E.; James, M. C.; Gamelin, D. R., One-Pot Synthesis of Monodisperse Colloidal Copper-Doped CdSe Nanocrystals Mediated by Ligand-Copper Interactions. Chemistry of Materials 2016, 28 (20), 7375-7384.
79. Beaulac, R.; Archer, P. I.; Liu, X.; Lee, S.; Salley, G. M.; Dobrowolska, M.; Furdyna, J. K.; Gamelin, D. R., Spin-Polarizable Excitonic Luminescence in Colloidal Mn2+-Doped CdSe Quantum Dots. Nano Letters 2008, 8 (4), 1197-1201.
80. Sharma, M.; Gungor, K.; Yeltik, A.; Olutas, M.; Guzelturk, B.; Kelestemur, Y.; Erdem, T.; Delikanli, S.; McBride, J. R.; Demir, H. V., Near-Unity Emitting Copper-Doped Colloidal Semiconductor Quantum Wells for Luminescent Solar Concentrators. Advanced Materials 2017, 29 (30), 1700821.
81. Rosen, D. J.; Yang, S.; Marino, E.; Jiang, Z.; Murray, C. B., In Situ EXAFS-Based Nanothermometry of Heterodimer Nanocrystals under Induction Heating. The Journal of Physical Chemistry C 2022, 126 (7), 3623-3634.
82. Yakunin, S.; Benin, B. M.; Shynkarenko, Y.; Nazarenko, O.; Bodnarchuk, M. I.; Dirin, D. N.; Hofer, C.; Cattaneo, S.; Kovalenko, M. V., High-resolution remote thermometry and thermography using luminescent low-dimensional tin-halide perovskites. Nature Materials 2019, 18 (8), 846-852.
83. McGrory, M. R.; King, M. D.; Ward, A. D., Using Mie Scattering to Determine the Wavelength-Dependent Refractive Index of Polystyrene Beads with Changing Temperature. The Journal of Physical Chemistry A 2020, 124 (46), 9617-9625.
84. Zhu, J.; Ozdemir, S. K.; Xiao, Y.-F.; Li, L.; He, L.; Chen, D.-R.; Yang, L., On-chip single nanoparticle detection and sizing by mode splitting in an ultrahigh-Q microresonator. Nature Photonics 2010, 4 (1), 46-49.
85. Nam, J.-M.; Thaxton, C. S.; Mirkin Chad, A., Nanoparticle-Based Bio-Bar Codes for the Ultrasensitive Detection of Proteins. Science 2003, 301 (5641), 1884-1886.
86. Zijlstra, P.; Paulo, P. M. R.; Orrit, M., Optical detection of single non-absorbing molecules using the surface plasmon resonance of a gold nanorod. Nature Nanotechnology 2012, 7 (6), 379-382.
87. Baaske, M. D.; Foreman, M. R.; Vollmer, F., Single-molecule nucleic acid interactions monitored on a label-free microcavity biosensor platform. Nature Nanotechnology 2014, 9 (11), 933-939.
88. Dantham, V. R.; Holler, S.; Kolchenko, V.; Wan, Z.; Arnold, S., Taking whispering gallery-mode single virus detection and sizing to the limit. Applied Physics Letters 2012, 101 (4), 043704.
89. Ament, I.; Prasad, J.; Henkel, A.; Schmachtel, S.; Sönnichsen, C., Single Unlabeled Protein Detection on Individual Plasmonic Nanoparticles. Nano Letters 2012, 12 (2), 1092-1095.
90. Pevere, F.; von Treskow, C.; Marino, E.; Anwar, M.; Bruhn, B.; Sychugov, I.; Linnros, J., X-ray radiation hardness and influence on blinking in Si and CdSe quantum dots. Applied Physics Letters 2018, 113 (25), 253103.
91. Montanarella, F.; McCall, K. M.; Sakhatskyi, K.; Yakunin, S.; Trtik, P.; Bernasconi, C.; Cherniukh, I.; Mannes, D.; Bodnarchuk, M. I.; Strobl, M.; Walfort, B.; Kovalenko, M. V., Highly Concentrated, Zwitterionic Ligand-Capped Mn2+:CsPb (BrxCl1-x)3 Nanocrystals as Bright Scintillators for Fast Neutron Imaging. ACS Energy Letters 2021, 6 (12), 4365-4373.
92. Yakunin, S.; Chaaban, J.; Benin, B. M.; Cherniukh, I.; Bernasconi, C.; Landuyt, A.; Shynkarenko, Y.; Bolat, S.; Hofer, C.; Romanyuk, Y. E.; Cattaneo, S.; Pokutnyi, S. I.; Schaller, R. D.; Bodnarchuk, M. I.; Poulikakos, D.; Kovalenko, M. V., Radiative lifetime-encoded unicolour security tags using perovskite nanocrystals. Nature Communications 2021, 12 (1), 981.
93. Gao, Z.; Wang, K.; Yan, Y.; Yao, J.; Zhao, Y. S., Smart responsive organic microlasers with multiple emission states for high-security optical encryption. National Science Review 2021, 8 (2), nwaa162, 1-7.

### Aspects

The following Aspects are illustrative only and do not limit the scope of the present disclosure or the appended claims.

Aspect 1. A method for forming superparticles, comprising:
contacting a source dispersed phase, a sink dispersed phase, and a continuous phase,
the source dispersed phase comprising a solvent and a plurality of particles dispersed within the solvent,
the sink dispersed phase comprising a solvent,
the solvent of the sink dispersed phase having a solubility in the continuous phase at a given temperature that is less than a solubility of the solvent of the source dispersed phase in the continuous phase at that given temperature, and
the contacting being performed such that at least some solvent of the source dispersed phase migrates to the sink dispersed phase so as to give rise to a plurality of superparticles that comprise assembled particles of the source dispersed phase.

A superparticle is an assembly of other particles, e.g., an assembly of nanoparticles. Superparticles are also known in some instances as supraparticles, superballs, and/or supercrystals. A superparticle can, as described herein, comprise multiple types of nanoparticles (which nanoparticles can be nanocrystals, core-shell structures, and the like). A superparticle can also comprise voids therein. A superparticle can have a void fraction of, e.g., 0.05-0.9, 0.1-0.8, 0.2-0.7, 0.3-0.6, or even 0.4-0.5, and all intermediate values and subranges. A superparticle can have a void fraction that varies with radial distance from the center of the superparticle.

The solvent of the sink dispersed phase can have a solubility in the continuous phase at a given temperature that is less than a solubility of the solvent of the source dispersed phase in the continuous phase at that given temperature, e.g., a solubility that is 90%, 80%, 70%, 60%, 50%, 40%, 30%, 20%, 10%, 5%, 2%, 1%, 0.1%, 0.01%, 0.001%, 0.0001%, 0.00001%, 0.000001% of the source dispersed phase in the continuous phase at that given temperature, or even lower. In some embodiments, the solvent of the sink dispersed phase is insoluble in the continuous phase at the given temperature.

Aspect 2. The method of Aspect 1, wherein the continuous phase comprises an aqueous solution. An aqueous solution can include, e.g., surfactants, saline mixtures, and the like. The continuous phase can also comprise water or even be pure water.

Aspect 3. The method of any one of Aspects 1-2, wherein the continuous phase comprises an alcohol, a glycol, a fluorocarbon oil, or any combination thereof. Example continuous phase materials include, e.g., one or more of ethylene glycol, propylene glycol, or polyols such as diethylene glycol, triethylene glycol, tetra ethylene glycol, glycerol; binary or ternary mixtures of water, polyols, and alcohols; and/or fluorocarbon oils, e.g., FC-40. One can also use a silicone oil.

Aspect 4. The method of any one of Aspects 1-3, wherein the source dispersed phase comprises an aromatic compound, an oil, a polymer, or any combination thereof.

Chlorinated solvents can also act as the source dispersed phase. Some non-limiting examples and their solubilities in water are: chloroform (8 g/L), trichloroethylene (1.1 g/L), tetrachloroethylene (0.15 g/L)

Aspect 5. The method of Aspect 4, wherein the source dispersed phase comprises an aromatic compound.

Aspect 6. The method of Aspect 5, wherein the aromatic compound comprises toluene and/or benzene. Other aromatic compounds can be used.

Aspect 7. The method of Aspect 1, wherein the continuous phase comprises a hydrocarbon. One can also use a fluorocarbon oil, e.g., FC-40. One can also use a silicone oil.

Aspect 8. The method of Aspect 7, wherein the source dispersed phase comprises water, a hydrophilic species, or both.

Aspect 9. The method of any one of Aspects 1-8, wherein the source dispersed phase has a solubility in the continuous phase of from about 0.1 g/L to about 8 g/L (and all intermediate values, e.g., from 0.1 g/L to about 1 g/L) at 20° C.

Aspect 10. The method of Aspect 1, wherein the continuous phase comprises a surfactant.

Aspect 11. The method of Aspect 10, wherein the surfactant is an anionic surfactant, a cationic surfactant, a zwitterionic surfactant, a non-ionic surfactant, or any combination thereof.

Aspect 12. The method of Aspect 11, wherein the surfactant is sodium dodecyl sulfate. Other surfactants with a similar critical micelle concentration (CMC) can also be used, e.g., CTAB, sodium laureth sulfate, and the like.

Aspect 13. The method of any one of Aspects 1-12, wherein at least one of the source dispersed phase and the sink dispersed phase forms a Pickering emulsion with the continuous phase.

Aspect 14. The method of any one of Aspects 1-13, wherein the source dispersed phase is liquid.

Aspect 15. The method of any one of Aspects 1-14, wherein the sink dispersed phase is liquid.

Aspect 16. The method of Aspect 15, wherein the sink dispersed phase comprises an oil.

Aspect 17. The method of Aspect 15, wherein the sink dispersed phase comprises surfactant micelles. Example surfactant micelles include, e.g., sodium dodecyl sulfate, Brij L23™, Synperonic F108™, and the like.

Aspect 18. The method of any one of Aspects 1-14, wherein the sink dispersed phase is solid.

Aspect 19. The method of Aspect 18, wherein the sink dispersed phase comprises polymer particles.

Aspect 20. The method of any one of Aspects 1-19, wherein the plurality of particles comprises inorganic nanoparticles, organic nanoparticles, polymer nanoparticles, inorganic microparticles, organic microparticles, polymer microparticles or any combination thereof. As explained herein, it should be understood that the plurality of particles can include a single type of particles or a plurality of particle types. As an example, the plurality of particles can include a first type of nanoparticles (e.g., core-shell nanoparticles) and a second type of nanoparticles (e.g., core-shell nanoparticles). The first type of particles can differ from the second type of particles in terms of any one or more of size, shape, and composition. As an example, the first type of nanoparticles can be Fe₃O₄ nanocrystals, and the second type of nanoparticles can be CdSe/CdS nanocrystals. The plurality of nanoparticles can include, e.g., a superparamagnetic nanoparticle (which can be a nanocrystal) and a semiconductor nanoparticle (which can be a nanocrystal). The source dispersed phase can comprise, e.g., first droplets of the solvent having a first population of nanoparticles therein and second droplets of the solvent having a second plurality of nanoparticles therein. The first population of nanoparticles can include nanoparticles of one or more types (e.g., nanoparticles of a first size and nanoparticles of a second size), and the second population of nanoparticles can include nanoparticles of one or more types (e.g., nanoparticles of a third size and nanoparticles of a fourth size).

Aspect 21. The method of Aspect 20, wherein the plurality of particles comprises inorganic nanoparticles.

Aspect 22. The method of Aspect 20, wherein the plurality of particles comprises polymer nanoparticles.

Aspect 23. The method of Aspect 20, wherein the plurality of particles comprises organic nanoparticles.

Aspect 24. The method of Aspect 21, wherein an inorganic nanoparticle comprises a selenide, a sulfide, a telluride, an oxide, a fluoride, or any combination thereof. Some non-limiting examples include, e.g., selenides (such as ZnSe, CdSe, HgSe, PbSe); sulfides (such as ZnS, CdS, HgS, PbS); tellurides (such as ZnTe, CdTe, HgTe, PbTe); oxides (such as ZnO, CdO, SnO₂, FezO₃, Fe₃O₄); fluorides (such as NaYF₄, NaGdF₄, GdF₃), and the like. Gd, F, Ag, and Au are also suitable for inclusion in nanoparticles. Nanoparticles can also be of pure metal (e.g., Au, Ag, Cu, Pt, Pd, and the like). Nanoparticles can also comprise intermetallics (e.g., PtCo, PtFe, AuCu, NiCu, and the like). Nanoparticles can also comprise perovskite nanoparticles (e.g., CsPbX₃, wherein X═Cl, Br, and I).

Aspect 25 The method of any one of Aspects 1-24, wherein the plurality of superparticles is characterized as monodisperse. By “monodisperse” is meant that the ratio of standard deviation to average diameter is less than or equal to about 0.2 (or 20%).

Aspect 26. The method of any one of Aspects 1-25, wherein a superparticle is characterized as spherical.

Aspect 27. The method of any one of Aspects 1-26, wherein a superparticle has an interior with at least one void (e.g., a plurality of voids) therein.

Aspect 28. The method of any one of Aspects 1-27, wherein a superparticle has a surface with a void therein.

The disclosed methods can also include placing one or more ligands on a superparticle. Such ligands can include, e.g., alkanethiols. Such ligand placement can be effected by, e.g., ligand exchange. The ligand exchange can be performed to exchange an existing ligand for a longer ligand. The ligand exchange can also be performed to exchange an existing ligand for a shorter ligand. The ligand exchange can be performed so as to effect a blue-shift of a resonance of the superparticle. The disclosed methods can also include exposing the superparticles to illumination (e.g., ultraviolet illumination) sufficient to effect a blue-shift (which blue-shift can be irreversible) of the superparticle. Without being bound to any particular theory or embodiment,

Aspect 29. A population of superparticles, the population of superparticles being formed according to the method of any one of Aspects 1-28.

Aspect 30. An optical resonator, the optical resonator comprising a substrate having one or more of superparticles disposed thereon, the one or more superparticles optionally being characterized as monodisperse.

An optical resonator can thus include a single superparticle, but can also include a plurality of superparticles. Such superparticles can be according to (and/or made according to) the present disclosure. As described elsewhere herein, the superparticles can be monodisperse.

Aspect 31. A sensor, comprising:
at least one superparticle; and
at least one receiver configured to collect a signal related to contact between the at least one superparticle and an analyte.

Aspect 32. The sensor of Aspect 31, wherein the at least one superparticle is configured for whispering-gallery mode resonance. As but one example, a superparticle can be incorporated into a whispering-gallery microresonator, e.g., such a microresonator that includes CdSe NCs assembled into dense, spherical superparticles. A superparticle can be incorporated into, e.g., a microscale optical sensor for temperature, pollution agents, and ionizing radiation, a responsive labels for anti-counterfeiting, or even a monolithic white-light pixel for displays.

Aspect 33. The sensor of any one of Aspects 31-32, wherein the at least one superparticle comprises a monodisperse population of superparticles.

Aspect 34. A system, comprising:
a first inlet for introducing a source emulsion having a source dispersed phase that comprises a solvent;
a second inlet for introducing a sink emulsion having a second dispersed phase that comprises a solvent; and
a mixing area configured to contact the first emulsion and the second emulsion to give rise to a combined continuous phase,
the solvent of the second dispersed phase having a solubility in the combined continuous phase at a given temperature that is less than a solubility of the solvent of the source dispersed phase in the continuous phase at that given temperature.

In some instances, the terms “second emulsion” and “sink emulsion” can be used interchangeably.

Aspect 35. The system of Aspect 34, wherein the mixing area comprises at least one mixing feature. A mixing feature can include, e.g., a herringbone structure, a ridge, a weir, a funnel, and the like.

Aspect 36. The system of any one of Aspects 34-35, further comprising a droplet generator configured to give rise to droplets of the source dispersed phase.

Aspect 37. A method, comprising: with a superparticle comprising a first ligand thereon, exchanging the first ligand for a second ligand smaller than the first ligand, the exchange effecting (a) a change in the cavity length, (b) a change in the refractive index of the superparticle, or both (a) and (b).

In some instances, one can exchange ligands so as to decrease the cavity length but the refractive index remains unaffected. Without being bound to any particular theory or embodiment, exchanging a longer ligand for a shorter ligand at the same time causes a shrinkage in the structure (i.e., a smaller cavity length) and a densification (i.e., a refractive index). It should be understood, however, that one can exchange an existing ligand for a new ligand of the same length, and that one can also exchange an existing ligand for a longer ligand. As a non-limiting example, one can enlarge the structure (i.e., giving rise to a higher cavity length) and decrease the superparticle density (i.e., a lower refractive index) when transitioning from a shorter to a longer ligand. One can also perform multiple ligand exchanges so as to modulate the properties of a superparticle or even a population of superparticles.

Example second ligands include, without limitation:
Alkanethiols
Carboxylic acids, e.g., acetic acid, propionic acid, butanoic acid, pentanoic acid, hexanoic acid, heptanoic acid, octanoic acid, nonanoic acid, decanoic acid, undecanoic acid, dodecanoic acid, tetradecanoic acid, hexadecanoic acid, heptadecanoic acid, octadecanoic acid, icosanoic acid, and the like. It should be understood that essentially any carboxylic acid can, in principle, be used.
Alkyl amines of various lengths, and also alkyl diamines. Without being bound to any particular theory or embodiment, the latter can be used to cross link superparticles.
Thiocyanate salts, e.g., ammonium or sodium thiocyanate (NH₄SCN or NaSCN).
Inorganic ligands, e.g., Na₄SnS₄, Na₄Sn₂S₆, (NH₄)₄Sn₂S₆, K₄SnTe₄, (NH₄)₃AsS₃, and Na₃AsS₃. Other ligands include, e.g., azobenzene-containing ligands.

Aspect 38. The method of claim 37, wherein the second ligand comprises from 2 to 18 carbon atoms.

Aspect 39. The method of claim 38, wherein the second ligand comprises an alkanethiol. Example alkanethiols include, e.g., -n-alkane thiols and dithiols (ethane-, methane-, propane-, butane-, pentane-, hexane-, heptane-, octane-, nonane-, decane-, undecane-, dodecane-, tetradecane-, hexadecane-, octadecane-thiols and dithiols, and the like.

Aspect 40. The method of claim 39, wherein the alkanethiol comprises 1-butanethiol or 1-propanethiol.

Aspect 41. The method of any one of claims 37-40, wherein the first ligand comprises an oleate.

Aspect 42. A method, comprising: illuminating a superparticle with an illumination so as to reduce the refractive index of the superparticle and effect a persistent blue-shift in the superparticle's spectrum.

Aspect 43. The method of claim 42, wherein the illumination is in the range of from about 400 to about 500 nm.

Aspect 44. The method of claim 42, wherein the illumination is ultraviolet. Such illumination can be, e.g., from about 100 to about 400 nm in wavelength.

Aspect 45. The method of any one of claims 42-43, wherein the illumination effects photo-oxidation of the superparticle.

Aspect 46. The method of any one of claims 42-44, wherein the illumination is, e.g., in the range of from about 3 to about 5 W/cm².

1. A method for forming superparticles, comprising:
contacting a source dispersed phase, a sink dispersed phase, and a continuous phase,
the source dispersed phase comprising a solvent and a plurality of particles dispersed within the solvent,
the sink dispersed phase comprising a solvent,
the solvent of the sink dispersed phase having a solubility in the continuous phase at a given temperature that is less than a solubility of the solvent of the source dispersed phase in the continuous phase at that given temperature, and
the contacting being performed such that at least some solvent of the source dispersed phase migrates to the sink dispersed phase so as to give rise to a plurality of superparticles that comprise assembled particles of the source dispersed phase.

2. The method of claim 1, wherein the continuous phase comprises an aqueous solution.

3. The method of claim 1, wherein the continuous phase comprises an alcohol, a glycol, a fluorocarbon oil, or any combination thereof.

4. The method of claim 1, wherein the source dispersed phase comprises an aromatic compound, an oil, a polymer, or any combination thereof.

5. (canceled)

6. The method of claim 4, wherein the aromatic compound comprises toluene.

7. The method of claim 1, wherein the continuous phase comprises a hydrocarbon.

8. The method of claim 7, wherein the source dispersed phase comprises water, a hydrophilic species, or both.

9. The method of claim 1, wherein the source dispersed phase has a solubility in the continuous phase of from about 0.1 g/L to about 0.9 g/L at 20° C.

10. The method of claim 1, wherein the continuous phase comprises a surfactant.

11. (canceled)

12. (canceled)

13. The method of claim 1, wherein at least one of the source dispersed phase and the sink dispersed phase forms a Pickering emulsion with the continuous phase.

14. (canceled)

15. (canceled)

16. The method of claim 1, wherein the sink dispersed phase comprises an oil.

17. The method of claim 1, wherein the sink dispersed phase comprises surfactant micelles.

18. The method of claim 1, wherein the sink dispersed phase is solid.

19. (canceled)

20. The method of claim 1, wherein the plurality of particles comprises inorganic nanoparticles, organic nanoparticles, polymer nanoparticles, inorganic microparticles, organic microparticles, polymer microparticles, or any combination thereof.

21. The method of claim 20, wherein the plurality of particles comprises inorganic nanoparticles.

22. (canceled)

23. (canceled)

24. The method of claim 21, wherein an inorganic nanoparticle comprises a selenide, a sulfide, a telluride, an oxide, a fluoride, or any combination thereof.

25. The method of claim 1, wherein the plurality of superparticles is characterized as monodisperse.

26. (canceled)

27. The method of claim 1, wherein a superparticle has an interior with a void therein.

28. The method of claim 1, wherein a superparticle has a surface with a void therein.

29. (canceled)

30. (canceled)

31. A sensor, comprising:
at least one superparticle; and
at least one receiver configured to collect a signal related to contact between the at least one superparticle and an analyte.

32. The sensor of claim 31, wherein the at least one superparticle is configured for whispering-gallery mode resonance.

33. The sensor of claim 31, wherein the at least one superparticle comprises a monodisperse population of superparticles.

34. A system, comprising:
a first inlet for introducing a source emulsion having a source dispersed phase that comprises a solvent;
a second inlet for introducing a sink emulsion having a second dispersed phase that comprises a solvent; and
a mixing area configured to contact the first emulsion and the second emulsion to give rise to a combined continuous phase,
the solvent of the second dispersed phase having a solubility in the combined continuous phase at a given temperature that is less than a solubility of the solvent of the source dispersed phase in the continuous phase at that given temperature.

35. The system of claim 34, wherein the mixing area comprises at least one mixing feature.

36. The system of claim 34, further comprising a droplet generator configured to give rise to droplets of the source dispersed phase.

37. A method, comprising:
with a superparticle comprising a first ligand thereon, exchanging the first ligand for a second ligand smaller than the first ligand,
the exchange effecting (a) a change in the cavity length, (b) a change in the refractive index of the superparticle, or both (a) and (b).

38. The method of claim 37, wherein the second ligand comprises from 2 to 18 carbon atoms.

39. (canceled)

40. (canceled)

41. The method of claim 37, wherein the first ligand comprises an oleate.

42. A method, comprising
illuminating a superparticle with an illumination so as to reduce the refractive index of the superparticle and effect a persistent blue-shift in the superparticle's spectrum.

43. The method of claim 42, wherein the illumination is in the range of from about 400 to about 500 nm.

44. The method of claim 42, wherein the illumination is ultraviolet.

45. The method of claim 42, wherein the illumination effects photo-oxidation of the superparticle.

46. The method of claim 42, wherein the illumination is in the range of from about 3 to about 5 W/cm².
